(19) United States
(12) Patent Application Publication
(10) Pub. No.: US 2025/0209740 A1
(43) Pub. Date: Jun. 26, 2025

(54) METHODS AND SYSTEMS FOR GENERATING 3D REPRESENTATIONS OF SCENES FROM A PLURALITY OF IMAGES USING POINTMAPS

(71) Applicant: NAVER CORPORATION, Gyeonggi-do (KR)

(72) Inventors: Jérome REVAUD, Meylan (FR); Vincent LEROY, Laval (FR); Yohann CABON, Montbonnot-Saint-Martin (FR); Boris CHIDLOVSKI, Meylan (FR); Shuzhe WANG, Espoo (FI); Philippe WEINZAEPFEL, Montbonnot-Saint-Martin (FR); Lojze ZUST, Rovte (SI); Bardienus Pieter DUISTERHOF, Pittsburgh, PA (US)

(73) Assignee: NAVER CORPORATION, Gyeonggi-do (KR)

(21) Appl. No.: 18/976,981

(22) Filed: Dec. 11, 2024

Related U.S. Application Data
(60) Provisional application No. 63/559,062, filed on Feb. 28, 2024.
(60) Provisional application No. 63/633,125, filed on Apr. 12, 2024.
(60) Provisional application No. 63/658,294, filed on Jun. 10, 2024.
(60) Provisional application No. 63/700,101, filed on Sep. 27, 2024.

(30) Foreign Application Priority Data
Dec. 20, 2023 (FR) 2314650
Jun. 17, 2024 (EP) 24305954

(51) Int. Cl. G06T 17/00; G06T 3/14; G06T 7/50; G06T 15/00

(52) U.S. Cl. CPC G06T 17/00; G06T 3/14; G06T 7/50; G06T 15/00; G06T 2207/20084

(57) ABSTRACT

A computer-implemented method for reconstructing a scene in three dimensions from a plurality of images of one or more viewpoints of the scene acquired using an imaging device includes: receiving the plurality of images without receiving extrinsic or intrinsic properties of the imaging device; and processing the plurality of images using a neural network to produce a plurality of pointmaps of the scene that correspond to the plurality of images and that are aligned in a common coordinate frame, where each pointmap is a one-to-one mapping between pixels of one of the plurality of images and three-dimensional points of the scene.

### CROSS-REFERENCE TO RELATED APPLICATIONS

This application claims the benefit of U.S. Provisional Application No. 63/559,062, filed on Feb. 28, 2024, U.S. Provisional Application No. 63/633,125 filed on Apr. 12, 2024, U.S. Provisional Application No. 63/658,294 filed on Jun. 10, 2024, and U.S. Provisional Application No. 63/700,101 filed on Sep. 27, 2024. This application claims the benefit of French Application No. 2314650 filed on Dec. 20, 2023, and European Application No. 24305954 filed on Jun. 17, 2024. The entire disclosures of the applications referenced above are incorporated herein by reference.

### FIELD

The present application relates to neural networks for processing images. More particularly, the present application relates to systems and methods for generating a three-dimensional (3D) representation of a scene from a plurality of images of one or more viewpoints of the scene acquired using an imaging device.

### COMPUTER PROGRAM LISTING APPENDIX

The entire contents of 1 (one) computer program listing appendix electronically submitted with this application—mast3r_dust3r.txt, 941,771 bytes, the submitted file created 11 Oct. 2024—are hereby incorporated by reference.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Image-based 3D reconstruction from one or multiple views is a 3D image reconstruction task that aims at estimating the 3D geometry and camera parameters of a particular scene, given a set of images of the scene. Methods for solving such a 3D reconstruction task have numerous applications including: mapping, navigation, archaeology, cultural heritage preservation, robotics, and 3D vision. 3D reconstruction may involve assembling a pipeline of different methods including: keypoint detection and matching, robust estimation, Structure-from-Motion (SfM), Bundle Adjustment (BA), and dense Multi-View Stereo (MVS). SfM and MVS pipelines equate to solving a series of sub-problems including: matching points, finding essential matrices, triangulating points, and densely re-constructing the scene. One disadvantage of the above is that each sub-problem may not be solved faultlessly, possibly introducing noise to subsequent steps in the pipeline. Another disadvantage of the above is the inability to solve the monocular case (e.g., when a single image of a scene is available).

There is consequently a need for an improved systems and methods for image-based 3D reconstruction.

### SUMMARY

In a feature, a computer-implemented method for reconstructing a scene in three dimensions from a plurality of images of one or more viewpoints of the scene acquired using an imaging device includes: receiving the plurality of images without receiving extrinsic or intrinsic properties of the imaging device; and processing the plurality of images using a neural network to produce a plurality of pointmaps of the scene that correspond to the plurality of images and that are aligned in a common coordinate frame, where each pointmap is a one-to-one mapping between pixels of one of the plurality of images and three-dimensional points of the scene.

In further features, the processing the plurality of images using the neural network further includes: processing the plurality of images using the neural network to produce a plurality of local feature maps that correspond to each of the plurality of images.

In further features, the method further includes performing one of the following applications using the plurality of pointmaps of the scene: (i) rendering a pointcloud of the scene for a given camera pose; (ii) recovering camera parameters of the scene; (iii) recovering depth maps of the scene for a given camera pose; and (iv) recovering three dimensional meshes of the scene.

In further features, the method further includes performing visual localization in the scene using the recovered camera parameters.

In further features, the processing the plurality of images using the neural network further includes: processing a plurality of image subsets of the plurality of images using the neural network, where each image subset of the plurality of image subsets includes different ones of the plurality of images; and aligning pointmaps from the plurality of image subsets into the plurality of pointmaps that are aligned in the common coordinate frame using a global aligner that performs regression based alignment.

In further features, the processing the plurality of images using the neural network further includes: processing a plurality of image subsets of the plurality of images using the neural network, where each image subset of the plurality of image subsets includes different ones of the plurality of images; and aligning pointmaps from the plurality of image subsets into the plurality of pointmaps that are aligned in the common coordinate frame using an alignment module that performs pixel correspondence based alignment using the plurality of local feature maps.

In further features, the processing the plurality of images using the neural network further includes: (a) for each of the plurality of images: (i) generating patches with a pre-encoder; (ii) encoding the generated patches with a transformer encoder to define token encodings that represent the generated patches; and (iii) decoding the token encodings with a transformer decoder to generate token decodings; (b1) for one of the token decodings, generating a pointmap corresponding to one of the plurality of images with a first regression head that produces pointmaps in a coordinate frame of the one of the plurality of images; and (c1) for each of other of the token decodings, generating a pointmap corresponding to each of the other of the plurality of images with a second regression head that produces pointmaps in the coordinate frame of the one of the plurality of images.

In further features, the processing the plurality of images using the neural network further includes: (b2) for the one of the token decodings, generating with a first descriptor head a local feature map of the one of the plurality of images; and (c2) for each of the other of the token decodings, generating with a second descriptor head local feature maps of the other of the plurality of images, respectively; where the first and second descriptor heads match features between image pixels of the plurality of images.

In further features, the processing the plurality of images using the neural network further includes: (a) initializing the plurality of pointmaps; (b) for each of the plurality of images: (i) generating image patches with a pre-encoder; and (ii) encoding the generated image patches with a transformer encoder to define image token encodings that represent the generated image patches; (c) for each of the plurality of pointmaps: (i) generating pointmap patches with a pre-encoder; and (ii) encoding the generated pointmap patches with a transformer encoder to define pointmap token encodings that represent the pointmap generated patches; (d) for each of the plurality of image token encodings and corresponding of the plurality of pointmap token encodings, aggregating each pair with a mixer to generate mixed token encodings; (e) for each of the generated mixed token encodings, decoding the mixed token encodings with a transformer decoder to generate mixed token decodings; (f) for each of the mixed token decodings, replacing the plurality of pointmaps corresponding to the plurality of images with pointmaps generated by a regression head that produces pointmaps in a coordinate frame that is common to the plurality of images; and (g) repeating (c)-(f) for a predetermined number of iterations.

In further features, each pointmap represents a two-dimensional field of three-dimensional points of the scene, and the processing the plurality of images using the neural network further includes generating a confidence score map for each pointmap.

In further features, processing the plurality of images further includes expressing the plurality of images using a co-visibility graph and processing the co-visibility graph using the neural network to produce the plurality of pointmaps of the scene that correspond to the plurality of images and that are aligned in the common coordinate frame.

In further features, the method further includes, based on the plurality of pointmaps of the scene, determining extrinsic or intrinsic parameters of the imaging device.

In further features, at least one of: the extrinsic parameters of the imaging device include rotation and translation of the imaging device; and the intrinsic parameters of the imaging device include skew and focal length.

In further features, the neural network performs cross attention between views of the scene.

In further features, computer program product includes code instructions which, when the program is executed by a computer, cause the computer to carry out the method.

In further features, the processing includes: encoding the images into features corresponding to the images, respectively; determining similarities between pairs of the images based on the features, the similarity of each pair being determined based on the features of the images of that pair; generating a graph of the scene based on ones of the pairs; and determining the pointmaps of the scene that correspond to ones of the images of ones of the pairs and that are aligned in a common coordinate frame.

In further features, the processing includes: filtering out some ones of the pairs of the images based on the similarities, where the ones of the pairs include the ones of the pairs not filtered out.

In further features, the encoding the images includes: generating token features based on the images, respectively; applying whitening to the token features; quantizing the whitened token features according to a codebook; and aggregating and binarizing the residuals for each codebook element.

In further features, the codebook is obtained by k-means clustering.

In a feature, a computer-implemented method for reconstructing a scene in three dimensions from a plurality of images of one or more viewpoints of the scene acquired using one or more imaging devices includes: receiving the plurality of images without receiving extrinsic or intrinsic properties of the one or more imaging devices; encoding the images into features corresponding to the images, respectively; determining similarities between pairs of the images based on the features, the similarity of each pair being determined based on the features of the images of that pair; filtering out ones of the pairs of the images based on the similarities; generating a graph of the scene based on the pairs not filtered out; and determining pointmaps of the scene that correspond to ones of the images of the pairs not filtered out and that are aligned in a common coordinate frame, where each of the pointmaps is a one-to-one mapping between pixels of one of the plurality of images and three-dimensional points of the scene.

In further features, vertexes of the graph correspond to one of the images of the pairs not filtered out.

In further features, an edge between each vertex corresponds to an undirected connection between two likely overlapping images.

In further features, the features are tokens output from the encoding with whitening applied.

In further features, the encoding the images includes; generating token features based on the images, respectively; applying whitening to the token features; quantizing the whitened token features according to a codebook; and aggregating and binarizing the residuals for each codebook element.

In further features, the codebook is obtained by k-means clustering.

In further features, the determining the similarities includes determining the similarities based on summing a kernel function on binary representations over the common codebook elements.

In further features, the method further includes filtering out ones of the pairs includes selecting a predetermined number of key ones of the images.

In further features, the selecting a predetermined number of key ones of the images includes selecting the key ones of the images using farthest point sampling (FPS) based on the similarities.

In further features, the generating the graph includes using the key ones of the images as connected nodes and connecting all other not filtered out images to their respective closest keyframe and their k nearest neighbors according to the similarities, where k is an integer greater than or equal to zero.

In further features, k is an integer greater than zero and less than 15.

In further features, the predetermined number of key ones of the images includes less than 25 images.

In further features, the method further includes aggregating the pointmaps into a canonical pointmap.

In further features, the method further includes determining a canonical depthmap based on the canonical pointmap.

In further features, aligning the pointmaps in the common coordinate frame.

In further features, the aligning the pointmaps includes aligning pixels of the pointmaps having matching three dimensional points in the scene.

In further features, the aligning the pointmaps further includes aligning the pointmaps using gradient descent based on minimizing a two dimensional reprojection error of three dimensional points of the imaging devices.

In further features, the aligning the pointmaps in the common coordinate frame includes aligning the pointmaps using a kinematic chain relating orientations of the imaging devices.

In further features, the kinematic chain includes a root node corresponding to one of the imaging devices and a set of directed edges relating the one of the images corresponding to the root node to the other ones of the imaging devices.

In further features, the method further includes rendering a three dimensional construction of the scene using the three dimensional points of the pointmaps.

In further features, the rendering the three dimensional construction of the scene includes constructing the three dimensional points using an inverse reprojection function as a function of the camera intrinsics, camera extrinsics, pixel coordinates, and depthmaps.

In further features, reparameterizing the camera extrinsics based on changing a rotation center of an imaging device from an optical center to a point at intersection of (a) a z vector from the imaging device center and (b) a median depth plane of the three dimensional points.

In further features, reparameterizing the camera extrinsics based on changing a rotation center of an imaging device from an optical center to a point at intersection of (a) a z vector from the imaging device center and (b) a point within a predetermined distance of a median depth plane of the three dimensional points.

In further features, controlling one or more propulsion devices of an mobile robot based on the pointmaps and navigating the scene.

In further features, controlling one or more actuators of a robot based on the pointmaps and interacting with one or more objects in the scene.

In further features, the plurality of images includes at least 500 images.

In further features, using the pointmaps for one or more of camera calibration, depth estimation, pixel correspondences, camera pose estimation and dense 3D reconstruction.

In a feature, a system includes: one or more processors; and memory including code that, when executed by the one or more processors, perform to: receive the plurality of images without receiving extrinsic or intrinsic properties of the one or more imaging devices; encode the images into features corresponding to the images, respectively; determine similarities between pairs of the images based on the features, the similarity of each pair being determined based on the features of the images of that pair; filter out ones of the pairs of the images based on the similarities; generate a graph of the scene based on the pairs not filtered out; and determine pointmaps of the scene for that correspond to ones of the images of the pairs not filtered out and that are aligned in a common coordinate frame, where each of the pointmaps is a one-to-one mapping between pixels of one of the plurality of images and three-dimensional points of the scene.

In a feature, a system for reconstructing a scene in three dimensions from a plurality of images of one or more viewpoints of the scene acquired using an imaging device includes: one or more processors; and memory including code that, when executed by the one or more processors, perform to: receive the plurality of images without receiving extrinsic or intrinsic properties of the imaging device; and process the plurality of images using a neural network to produce a plurality of pointmaps of the scene that correspond to the plurality of images and that are aligned in a common coordinate frame, where each pointmap is a one-to-one mapping between pixels of one of the plurality of images and three-dimensional points of the scene.

In further features, the code, when executed by the one or more processors, further perform to: process the plurality of images using the neural network to produce a plurality of local feature maps that correspond to each of the plurality of images.

In further features, the code, when executed by the one or more processors, further perform one of the following applications using the plurality of pointmaps of the scene to: (i) render a pointcloud of the scene for a given camera pose; (ii) recover camera parameters of the scene; (iii) recover depth maps of the scene for a given camera pose; and (iv) recover three dimensional meshes of the scene.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 illustrates an example system architecture in which the methods according to this disclosure may be performed;

FIG. 2 is a functional block diagram of an example control system of an autonomous machine;

FIG. 3 is a block diagram of elements of a first system embodiment for generating pointmaps aligned in a common coordinate frame for use with three dimensional reconstruction applications;

FIG. 4 is a block diagram of elements of a second system embodiment for generating pointmaps aligned in a common coordinate frame for use with three-dimensional reconstruction applications with elements common to the system embodiment shown in FIG. 3 and a global aligner module;

FIG. 5 is a general flow diagram of the method carried out by the systems shown in FIGS. 3 and 4;

FIG. 6 illustrates the relationship between images and pointmaps produced by the neural network shown in FIGS. 3 and 4;

FIG. 7A is a flow diagram of the method carried out by a first neural network architecture, DUSt3R, for generating pointmaps aligned in a common coordinate frame by the systems shown in FIGS. 3 and 4;

FIG. 7B is a flow diagram of the method carried out by an alternate embodiment of the first neural network architecture, MASt3R, for generating pointmaps aligned in a common coordinate frame and local feature maps by the systems shown in FIGS. 3 and 4;

FIG. 8A is a block diagram of elements of a first neural network architecture, DUSt3R, for generating pointmaps aligned in a common coordinate frame by the systems shown in FIGS. 3 and 4;

FIG. 8B is a block diagram of elements of an alternate embodiment, MASt3R, of the first neural network architecture, DUSt3R, for generating pointmaps aligned in a common coordinate frame and local feature maps by the systems shown in FIGS. 3 and 4;

FIG. 8C is a block diagram of elements of an embodiment of the first neural network architecture for generating pointmaps aligned in a common coordinate frame and local feature maps by the systems shown in FIGS. 3 and 4;

FIG. 8D is a method of recovering camera parameters and 3D reconstruction shown;

FIG. 9 is a flow diagram of the method carried out by a second neural network architecture, C-GAR, for generating pointmaps aligned in a common coordinate frame by the systems shown in FIGS. 3 and 4;

FIG. 10 is a block diagram of elements of a second neural network architecture, C-GAR, for generating pointmaps aligned in a common coordinate frame by the systems shown in FIGS. 3 and 4;

FIG. 11 illustrates examples of reconstruction using the DUSt3R network shown in FIG. 12A;

FIG. 12A illustrates an overview of the DUSt3R network;

FIG. 12B is an example architecture of the DUSt3R network shown in FIG. 12A;

FIGS. 13A and 13B show reconstruction examples on two scenes never seen during training;

FIGS. 14 and 15 are examples of 3D reconstruction of an unseen MegaDepth scene from two images;

FIGS. 16 and 17 are two examples of 3D reconstruction from two images only of unseen scenes;

FIGS. 18A, 18B, 18C and 18D show four examples of 3D reconstructions from nearly opposite viewpoints;

FIG. 19 is a reconstruction example from four random frames of an indoor sequence;

FIG. 20A is a diagram showing the traditional pipeline, which consists in solving several intermediate sub-problems;

FIG. 20B is a diagram showing the C-GAR approach that directly builds a 3D representation from the RGB observations without explicitly solving any sub-problem;

FIG. 21 shows real data captured and reconstructed with a smartphone using the C-GAR approach;

FIG. 22 illustrates how a pointmap can be seen simultaneously as a 3-channel image and a point cloud;

FIG. 23 is a diagram of the architecture of the C-GAR network;

FIGS. 24, 25 and 26 show qualitative results of the C-GAR network;

FIG. 27 is a diagram showing strengths and weaknesses of the C-GAR network;

FIG. 28 shows an example of shaded reconstructions using the C-GAR network;

FIG. 29 shows views demonstrating robustness to focal length variations on real data using the C-GAR network;

FIG. 30 is a diagram of an alternate embodiment of the first neural network architecture, MASt3R, where given two input images to match, the network regresses for each image and each input pixel a 3D point, a confidence value and a local feature;

FIG. 31 shows graphs demonstrating fast reciprocal matching using the MASt3R network;

FIG. 32 shows qualitative examples on the Map-free dataset;

FIG. 33 illustrates a table showing absolute camera pose on the 7Scenes and Cambridge-Landmarks datasets;

FIG. 34 illustrates a table showing monocular depth estimation on multiple benchmarks: D-supervised, SS-Self-supervised, T-transfer (zero-shot), where parenthesis refers to training on the same set;

FIG. 35 illustrates a table showing multi-view pose regression on the CO3Dv2 and RealEst10K datasets with 10 random frames;

FIG. 36 illustrates a table showing MVS results on the DTU dataset, in mm. Traditional handcrafted methods (a) have been overcome by learning-based approaches (b) that train on this specific domain;

FIG. 37 illustrates a table showing a comparison with the state of the art for multi-view pose regression on the CO3Dv2 and RealEstate10K datasets with 3, 5 and 10 random frames, where parentheses indicate results obtained after training on RealEstate10K dataset, except for DUSt3R where results are reported after global alignment without training on RealEstate10K dataset;

FIG. 38 illustrates a table showing a multi-view depth evaluation with different settings: a) classical approaches; b) with poses and depth range, without alignment; c) absolute scale evaluation with poses, without depth range and alignment; d) without poses and depth range, but with alignment, where parentheses denote training on data from the same domain, and the best results for each setting are in bold;

FIG. 39 illustrates a table showing absolute camera pose on 7Scenes (top 1 image) and Cambridge-Landmarks (top 20 images) datasets, where the median translation and rotation errors are reported (cm/°);

FIG. 40 illustrates a table showing detailed hyper-parameters for the training, with first a low-resolution training with a linear head followed by a higher-resolution training still with a linear head and a final step of higher-resolution training with a DPT head, in order to save training time;

FIG. 41 illustrates a table showing results on the validation set of the Map-free dataset, where first best is in bold and second best is underlined;

FIG. 42 illustrates a table showing a comparison with the state of the art on the test set of the Map-free dataset;

FIG. 43 illustrates a table showing multi-view pose regression on the CO3Dv2 and RealEstate10K datasets with 10 random frames, where parenthesis denote methods that do not report results on the 10 views set, and where their best are reported for comparison (8 views) and the (a) multi-view and (b) pairwise methods are distinguished;

FIG. 44 illustrates a table showing dense MVS results on the DTU dataset, in mm, where handcrafted methods (c) perform worse than learning-based approaches (d) that train on this specific domain, and where among the methods that operate in a zero-shot setting (e), MASt3R is the only one attaining reasonable performance;

FIG. 45 illustrates a table showing a visual localization results on Aachen

Day-Night and InLoc datasets with results reported for different number of retrieved database images (topN);

FIGS. 46 and 47 include functional block diagrams of an example implementation of the MASt3R architecture for SFM;

FIG. 48 includes an example illustration of constructing the constrained pointmap; and

FIG. 49 includes an example table illustrating the effectiveness of the reparameterization of the camera.

In the drawings, reference numbers may be reused to identify similar and/or identical elements.

### DETAILED DESCRIPTION

### Section A. 3D Reconstruction Methods

### Section A.1 System Architecture

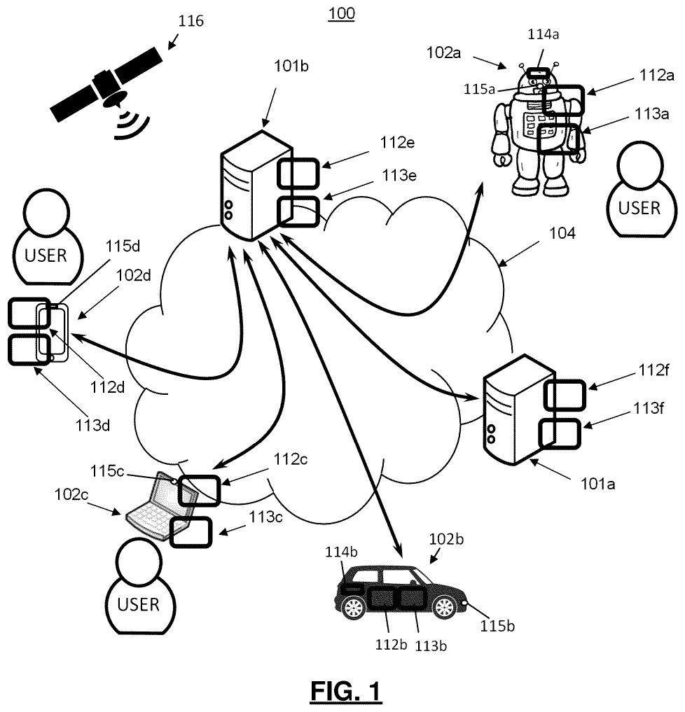

The disclosed methods for generating 3D representations of scenes from a plurality of images may be implemented within a system 100 architected as illustrated in FIG. 1, which includes servers 101 and one or more client devices 102 that communicate over a network 104 (which may be wireless and/or wired) such as the Internet for data exchange. Servers 101 and the client devices 102 include one or more processors 112 and memory 113 such as a hard disk. The client devices 102 may be any device that communicates with servers 101, including autonomous robot 102a, autonomous vehicle 102b, computer 102c, or cell phone 102d, which are equipped with an imaging device 115 for acquiring images of a scene (i.e., a device for acquiring images or video, such as cameras and cell phones). In one example, autonomous robot 102a and autonomous vehicle 102b are located using positioning system 114 communicating with geo-positioning system (GPS) 116, or, alternatively or in combination with, a cellular positioning system, an indoor positioning system (IPS), including beacons, RFID, WiFi and geomagnetic, or a combination thereof.

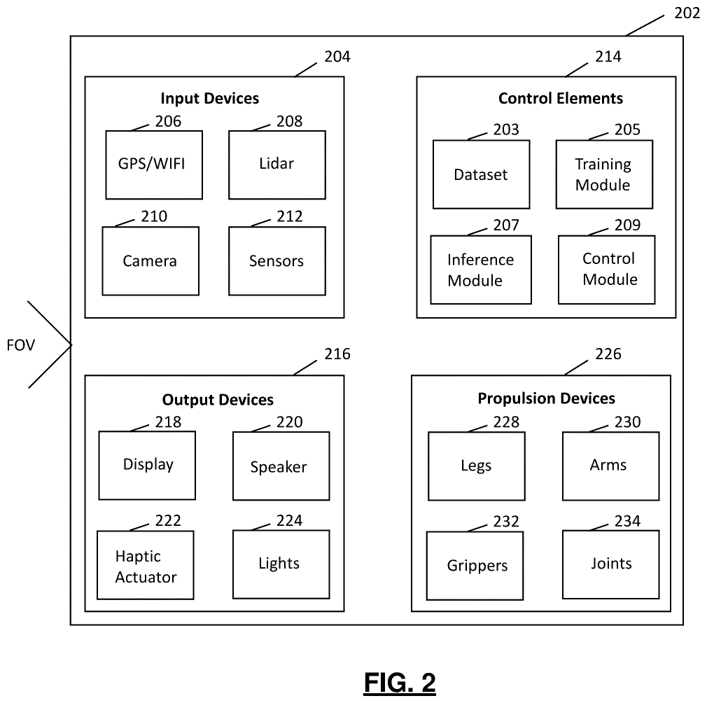

FIG. 2 is a functional block diagram of an example control system of an autonomous machine 202, such as autonomous robot 102a or autonomous vehicle 102b shown in FIG. 1. The autonomous machine 202, which may be mobile or stationary and indoor or outdoor, and may include one or more of the following elements: input devices 204 (e.g., GPS/WIFI 206, Lidar 208, camera 210 (which may include be grayscale, or red, green, blue (RGB) sensors for capturing images within a predetermined field of view (FOV), or which may update (capture images) at a predetermined frequency, such as 60 hertz (Hz), 120 Hz, or another suitable frequency), sensors 212 (e.g., temperature, rain, force, torque), control elements 214, output devices 216 (e.g., display 218, speakers 220, haptic actuator 222, lights 224), and propulsion devices (e.g., legs 228, arms 230, grippers 232, and joints 234).

In one example, the server 101b (with processors 112e and memory 113e) shown in FIG. 1 may include an inference module 207 and a control module 209 in memory 113e containing functionality for controlling autonomous machine 202, and the server 101a may include training module 205 and dataset 203 for training the policies of the inference module 207 (such as the neural networks 304 disclosed herein). In alternate embodiments, the modules 207, 209, 205, and 203 may be implemented in memory 113 of the autonomous machine 202, or a combination thereof (e.g., modules 207 and 209 implemented in memory 113 of the autonomous machine 202 and modules 205 and 203 implemented in memory 113f on server 101a). In another embodiment, it is noted that the two servers 101a and 101b may be merged.

The autonomous machine 202 may be powered, such as via an internal battery and/or via an external power source, such as alternating current (AC) power. AC power may be received via an outlet, a direct connection, etc. In various implementations, the autonomous machine 202 may receive power wirelessly, such as inductively. In alternate embodiments, the autonomous machine 202 may include alternate propulsion devices 226, such as one or more wheels, one or more treads/tracks, one or more propellers, and/or one or more other types of devices configured to propel the autonomous machine 202 forward, backward, right, left, up, and/or down. In operation, the control module 209 actuates the propulsion device(s) 226 to perform tasks issued by the inference module 207. In one example, speaker 220 receives a natural language description of a task that is input after being processed by an audio-to-text converter to inference module 207 that provides input to control module 209 to carry out the task.

### Section A.2 Overview & Nomenclature-Pointmaps, Cameras and Scenes

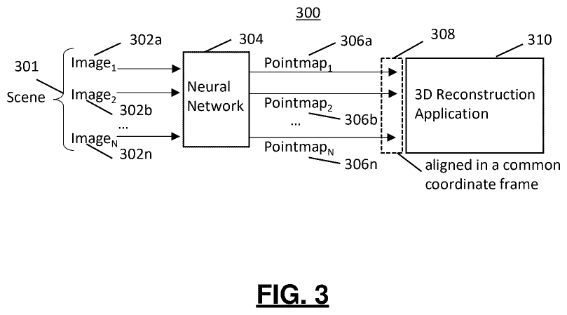

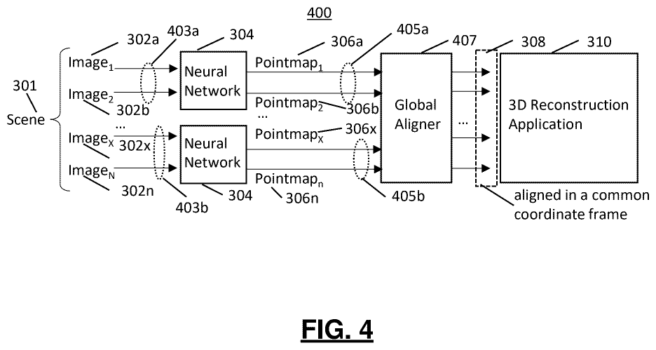

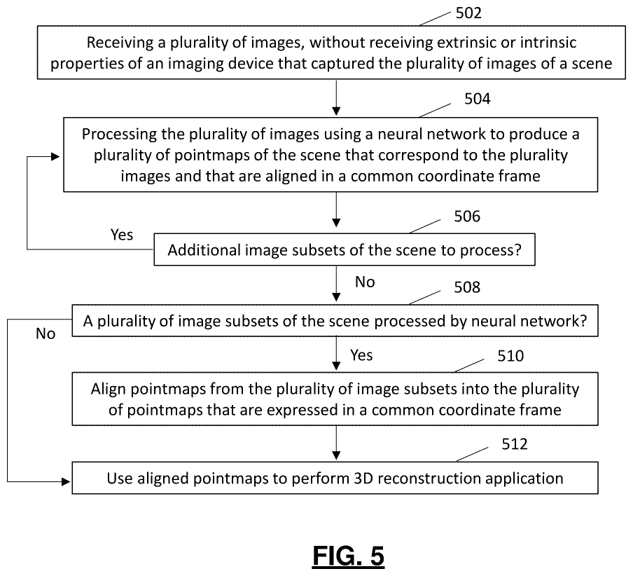

FIG. 3 is a block diagram of elements of a first system example 300 for generating with a neural network 304, from images 302 of a scene 301, pointmaps 306 aligned in a common coordinate frame 308 for use with three-dimensional reconstruction applications 310. The images 302 may be acquired using one or more imaging device (e.g., imaging device 115 shown in FIG. 1) from one or more viewpoints (points of view). FIG. 4 is a block diagram of elements of a second system embodiment 400 for generating with a neural network 304, from images 302 of a scene 301, pointmaps 306 aligned in a common coordinate frame 308 for use with three-dimensional reconstruction applications 310, with elements common to the system example shown in FIG. 3 and with a global aligner module 407. FIG. 5 is a general flow diagram of the method carried out by the systems shown in FIGS. 3 and 4.

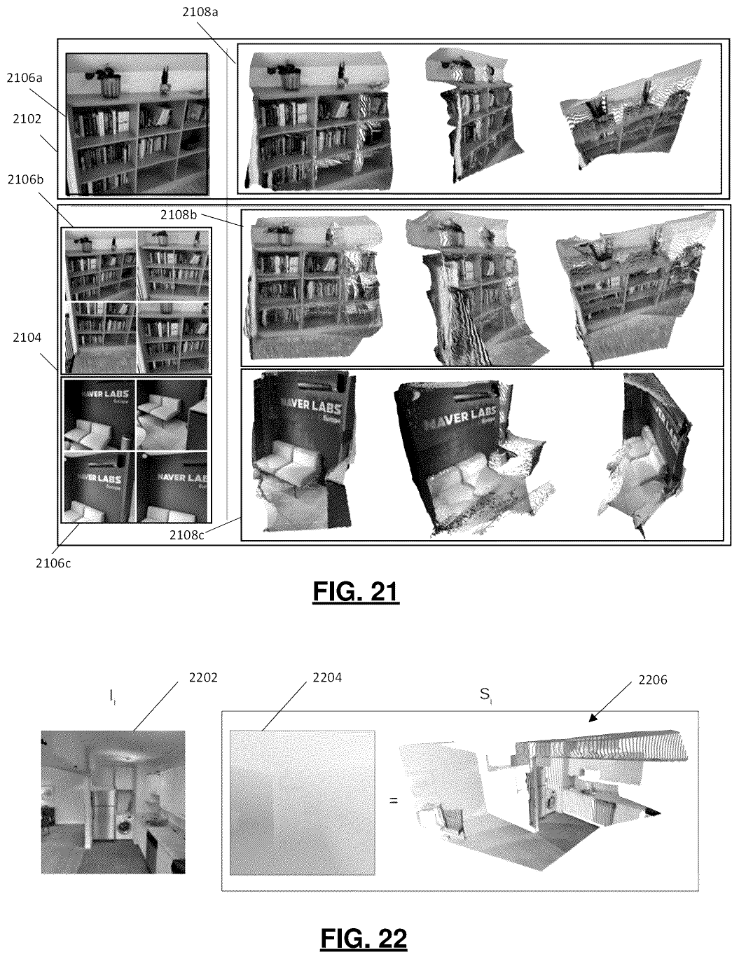

With reference to FIGS. 3, 4 and 5, images 302 of a scene 301 are received (at 502 in FIG. 5) and then processed by a neural network 304 to produce pointmaps 306 (at 504 in FIG. 5). When a single image 302 is available (i.e., the monocular case, e.g., see 2102 in FIG. 21), the single image may be input multiple times to the neural network 304, which is in contrast when multiple images 302 are available (i.e., the multi-view case, e.g., see 2104 in FIG. 21). As will be discussed in more detail below, the pointmaps 306 in the second system example shown in FIG. 4 are also processed by a global aligner 407 (at 510 in FIG. 5) to align the pointmaps 306. Once the pointmaps 306 in FIGS. 3 and 4 are aligned at 308, they may be used to perform a three dimensional (3D) reconstruction application 310 (at 512 in FIG. 5) of the scene, which includes (i) rendering a pointcloud of the scene for a given camera pose; (ii) recovering camera parameters of the scene; (iii) recovering depth maps of the scene for a given camera pose; and (iv) recovering three dimensional (colored, grayscale or monochrome) meshes of the scene. In one example, the inference module 207 embeds one of the systems 300 or 400 shown in FIGS. 3 and 4, respectively, that receives images from camera 210 and performs, using the 3D reconstruction application 310, visual localization in a scene using recovered camera parameters for the autonomous machine 202.

Advantageously, the neural network 304 and the scene generator 308 reconstruct from uncalibrated and unposed imaging devices, without prior information regarding the scene or the imaging devices, including extrinsic parameters (e.g., rotation and translation relative to some coordinate frame: (i) the absolute pose of the imaging device (i.e., the relation between the camera and a scene coordinate frame), (ii) relative pose of the different viewpoints of the scene (i.e., the relation between different camera poses)) and intrinsic parameters (e.g., camera lens focal length and distortion). The resulting scene representation is generated based on pointmaps 306 with properties that encapsulate (a) scene geometry, (b) relations between pixels and scene points and (c) relations between viewpoints. From aligned pointmaps 308 alone, scene parameters (i.e., cameras and scene geometry) may be recovered.

The neural network 304 uses an objective function that minimizes the error between ground-truth and predicted pointmaps 306 (after normalization) using a confidence score function. The neural network 304 in one example is based on or includes large language models (LLMs), which are large neural networks trained on large quantities of unlabeled data. The architecture of such neural networks may be based on the transformer architecture with a transformer encoder and decoder with a self-attention mechanism. Such a transformer architecture as used in an embodiment herein is described in Ashish Vaswani et al., “Attention is all you need”, In I. Guyon et al., editors, Advances in Neural Information Processing Systems 30, pages 5998-6008, Curran Associates, Inc., 2017, which is incorporated herein in its entirety. Additional information regarding the transformer architecture can be found in U.S. Pat. No. 10,452,978, which is incorporated herein in its entirety. Alternative attention-based architectures include recurrent, graph and memory-augmented neural networks. To apply the transformer network to images, the neural network 304 in an example herein is based on the Vision Transformer (ViT) architecture (see Alexey Dosovitskiy et al., entitled “An image is worth 16×16 words: Transformers for image recognition at scale”, in ICLR, 2021, which is incorporated herein in its entirety).

FIG. 6 illustrates the relationship between the pointmaps 306 produced by the neural network 304 from the images 302 shown in FIGS. 3 and 4 (at 504 in FIG. 5). Specifically in FIG. 6, the image 302a and corresponding pointmap 306a are shown. At 602, pointmap X 306a is illustrated generally; in association with its corresponding image I 302a of resolution W×H, pointmap X forms a one-to-one mapping 605 between 2D image pixels (e.g., RGB) 505 and 3D scene points (e.g., x,y,z) 504 (i.e., I_{i,j}↔X_{i,j} for all pixel coordinates i,j∈ [symbol] ^{W×H}). At 606, one implementation of pointmap X is illustrated as a 2D field of 3D scene points 608, where mappings 609 for pointmap 306a are given by the position of the 2D field of 3D scene points 608 (i.e., a 5×5 matrix of 3D scene points) relative to the position of each pixel in the image 607 (i.e., a 5×5 matrix of 2D image pixels).

Further, examples disclosed hereunder assume that each camera ray hits a single 3D point (i.e., the case of translucent surfaces may be ignored). In addition, given camera intrinsics K∈ [symbol] ^{3×3}, the pointmap X of the observed scene can be obtained from the ground-truth depthmap D∈ [symbol] ^{W×H} as X_{i,j}=K⁻¹ [iD_{i,j}, jD_{i,j}, D_{i,j}]^{T}, where i, j∈N^{W×H} denote the x-y pixel coordinates. Here, X is expressed in the camera frame. Herein, X^{n,m} may denote the pointmap Xⁿ from camera n expressed in image m's coordinate frame: X^{n,m}=PₘPₙ⁻¹ h (Xⁿ) with Pₘ, Pₙ∈R^{3×4} the world-to-camera poses for views n and m, and h: (x, y, z)→(x, y, z, 1) the homogeneous mapping.

### Section A.3 DUSt3R: Dense Unconstrained Stereo 3D Reconstruction

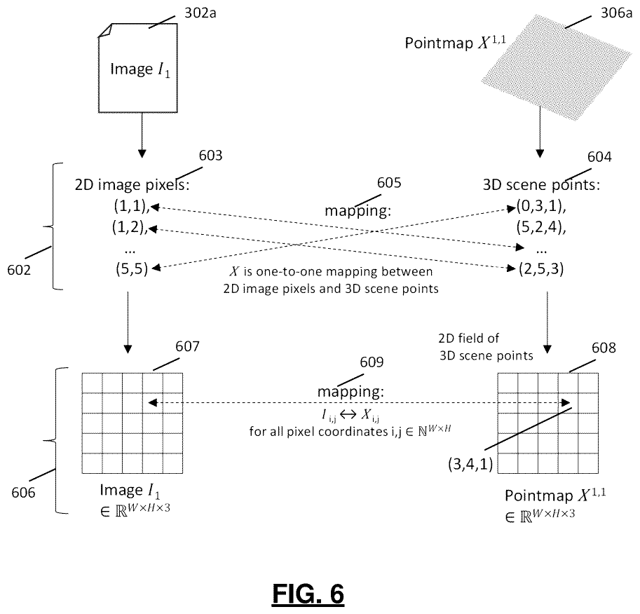

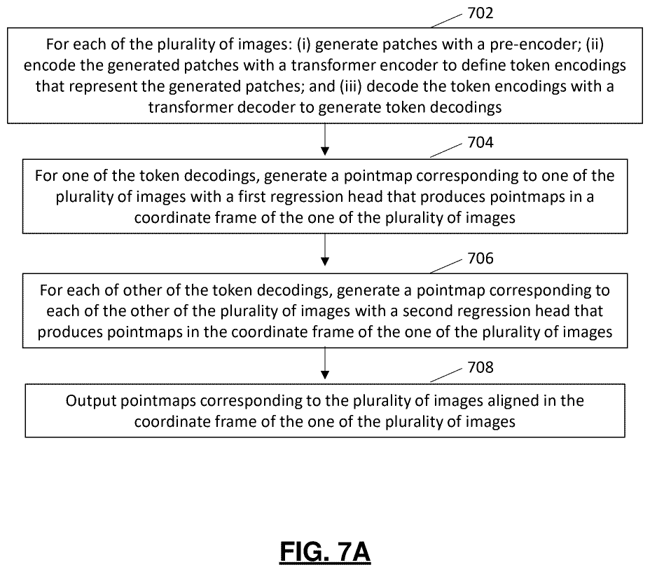

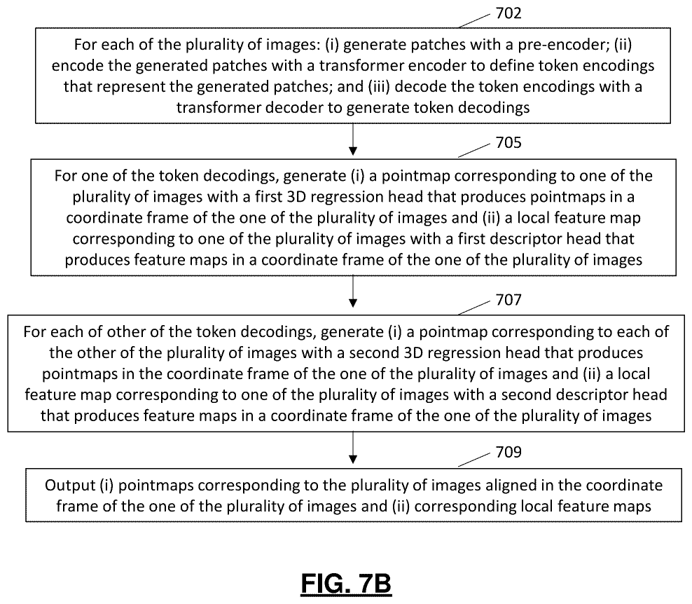

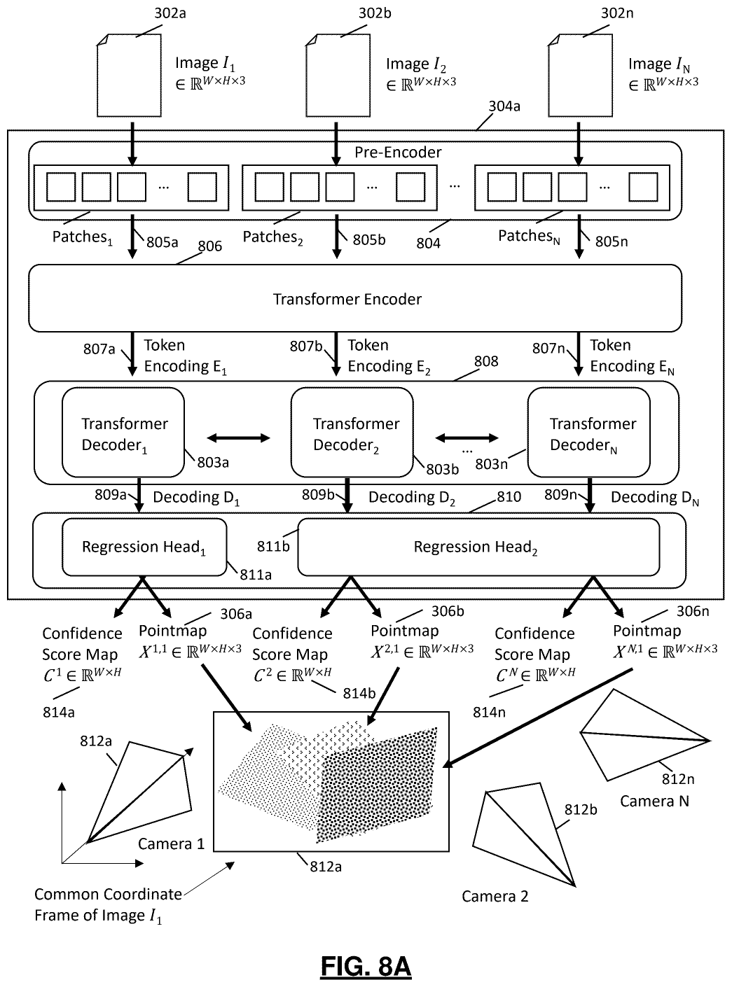

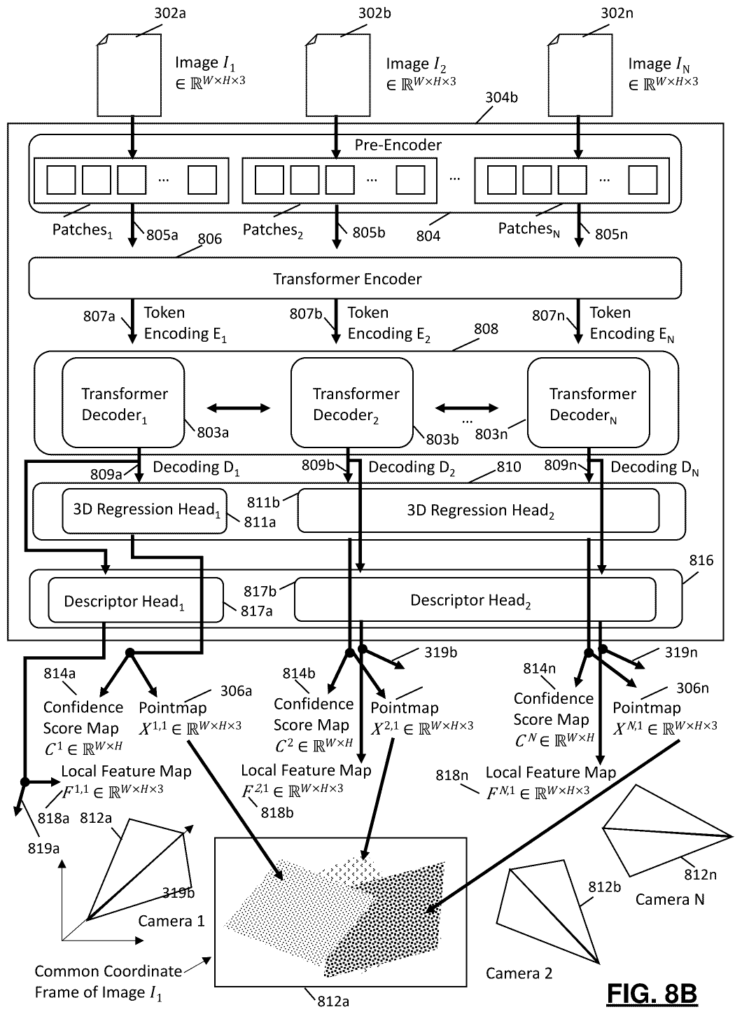

This Section sets forth a first neural network architecture of the neural network 304 shown in FIGS. 3 and 4, which is also referred to herein as the DUSt3R (Dense Unconstrained Stereo 3D Reconstruction) architecture. FIG. 7A is a flow diagram of the method carried out by the example DUSt3R architecture and FIG. 8A is a block diagram of elements of the DUSt3R architecture, for generating pointmaps aligned in a common coordinate frame.

At 702, (i) for each of the plurality of images 302 {I₁, I₂, . . . , I_{N}} a pre-encoder 804 generates patches 805; (ii) a transformer encoder 806 encodes the patches 805 to generate token encodings 807 that represent the generated patches; and (iii) a transformer decoder 808 decodes with decoder blocks 803 the token encodings 805, respectively, to generate token decodings 809 that are fed to regression head 810. In the case of a network 304a adapted to process two input images 302 {I₁, I₂} (or more generally more than one image), after pre-encoder 804 generates patches, the transformer encoder 806 then reasons over both sets of patches jointly (collectively). In one example, the decoder is a transformer network equipped with cross attention. Each decoder block 803 sequentially performs self-attention (each token of a view attends to tokens of the same view), then cross-attention (each token of a view attends to all other tokens of the other view). Information is shared between the branches during the decoder pass in order to output aligned pointmaps. Namely, each decoder block 803 attends to tokens encodings 807 from the other decoder block 803. Continuing with the example of two input images 302 {I₁, I₂} this may be given by:

$${G}_{i}^{1} = {DecoderBlock}_{i}^{1} ( {G}_{i - 1}^{1} , {G}_{i - 1}^{2} ) , \\ {G}_{i}^{2} = {DecoderBlock}_{i}^{2} ( {G}_{i - 1}^{2} , {G}_{i - 1}^{1} ) .$$

At 704, for one of the token decodings 809a, a pointmap 306a that corresponds to image 302a is generated by a first regression head 811a, which produces pointmaps in a coordinate frame 812a of the image 302a that is input to the regression head 811a. At 706, for each of the other token decodings 809b . . . 809n, pointmaps 306b . . . 306n that correspond to each of the other of the plurality of images 302b . . . 302n are generated by a second regression head 811b that produces pointmaps in the coordinate frame 812a (output by the first regression head 811a, not in the coordinate frames corresponding to the coordinate frames 812b . . . 812n, respectively, in which each image 302b . . . 302n was captured). More specifically, each branch is a separate regression head 811a and 811b which takes the set of decoder tokens D 809a and 809b . . . 809n and outputs at 708 pointmaps X 306a . . . 306n (in common reference frame 812a) and associated confidence maps C 814a . . . 814n, respectively. Returning to the example of two input images 302 {I₁, I₂} the regression head 808 may be given by:

$${X}^{1 , 1} , {C}^{1 , 1} = {Head}_{3 D}^{1} ( {G}_{0}^{1} , … , {G}_{B}^{1} ) , \\ {X}^{2 , 1} , {C}^{2 , 1} = {Head}_{3 D}^{2} ( {G}_{0}^{2} , … , {G}_{B}^{2} ) ,$$

where, G¹ and G² are the input tokens from the token decodings D 809 and X^{1,1}, C^{1,1} and X^{2,1}, C^{2,1} are pairs of pointmaps 306 and confidence maps 814, respectively.

The output pointmaps 306 are regressed up to a scale factor. Also, it should be noted that the DUSt3R architecture may not explicitly enforce any geometrical constraints. Hence, pointmaps 306 may not necessarily correspond to any physically plausible camera model. Rather during training, the DUSt3R neural network 304a may learn all relevant priors present from the training set, which only contains geometrically consistent pointmaps. Using a generic architecture leverages such training.

The DUSt3R neural network model may be trained in a fully-supervised manner using a regression loss, leveraging large public datasets for which ground-truth annotations are either synthetically generated, reconstructed from Structure-from-Motion (SfM) software, or captured using sensors. A fully data-driven strategy based on a generic transformer architecture is adopted, not enforcing any geometric constraints at inference, but being able to benefit from powerful pretraining schemes. The DUSt3R neural network model learns strong geometric and shape priors, like shape from texture, shading or contours.

Additional details concerning the DUSt3R architecture described in this Section are set forth in Section B (below), including training and experimentation.

### Section A.4 MASt3R: Matching and Stereo 3D Reconstruction

This Section sets forth an alternate example of the first neural network architecture shown in FIGS. 7A and 8A, which is also referred to herein as the MASt3R (Matching And Stereo 3D Reconstruction) architecture. FIG. 7B is a flow diagram of the method carried out by the MASt3R architecture and FIG. 8B is a block diagram of elements of the MASt3R architecture, for generating (i) pointmaps aligned in a common coordinate frame and (ii) local feature maps (i.e., local descriptors).

The MASt3R architecture shown in FIG. 8B is based on the DUSt3R architecture shown in FIG. 8A and includes the addition in the neural network 304b a second head 816 that outputs local features maps 818 that enable highly accurate and robust matching. The local feature maps 818 are representations of local 3D (three dimensional) space, which may be used to help identify such spaces in two different images that correspond to each other. Similar to pointmaps 306 (with confidence score maps 814), local feature maps 818 may include confidence score maps 819.

Similar to the first embodiment shown in FIG. 7A at 704, 706, and 708, the second embodiment processes the token decodings 809 fed to regression head 810 to generate pointmaps 306 (and corresponding confidence maps 814) at 705(i), 707(i), and 709(i). In addition to the first embodiment shown in FIG. 7A, this second embodiment shown in FIG. 7B processes the token decodings 809 fed to descriptor head 816 to generate local feature maps 818 at 705(ii) and 707(ii), that correspond to the pointmaps 306 generated at 705(i) and 707(i), and, which are output at 709(ii) and 709(i), respectively. Returning to the example of two input images 302 {I₁, I₂} the descriptor head 816 may be given by:

$${D}^{1} = {Head}_{desc}^{1} ( {G}_{0}^{1} , … , {G}_{B}^{1} ) , \\ {D}^{2} = {Head}_{desc}^{2} ( {G}_{0}^{2} , … , {G}_{B}^{2} ) ,$$

where, G¹ and G² are the input tokens from the token decodings 809 and D¹ and D² are local feature maps 818∈ [symbol] ^{H×W×d} of dimensional d.

The MASt3R neural network model is trained using a loss function based on or including a regression loss and a local descriptor matching loss. Similar to the DUSt3R architecture the MASt3r architecture may not explicitly enforce any geometrical constraint, in which case, pointmaps 306 do not necessarily correspond to any physically plausible camera model. However, scale invariance is not always desirable. Scale dependence (e.g., metric scale) may be desirable for some applications/tasks (e.g., visual localization without mapping, and monocular metric-depth estimation).

Additional details concerning the MASt3R architecture described in this Section are set forth in Section C (below), including training and experimentation.

### Section A.5 C-GAR: Camera-Geometry Agnostic 3D Reconstruction

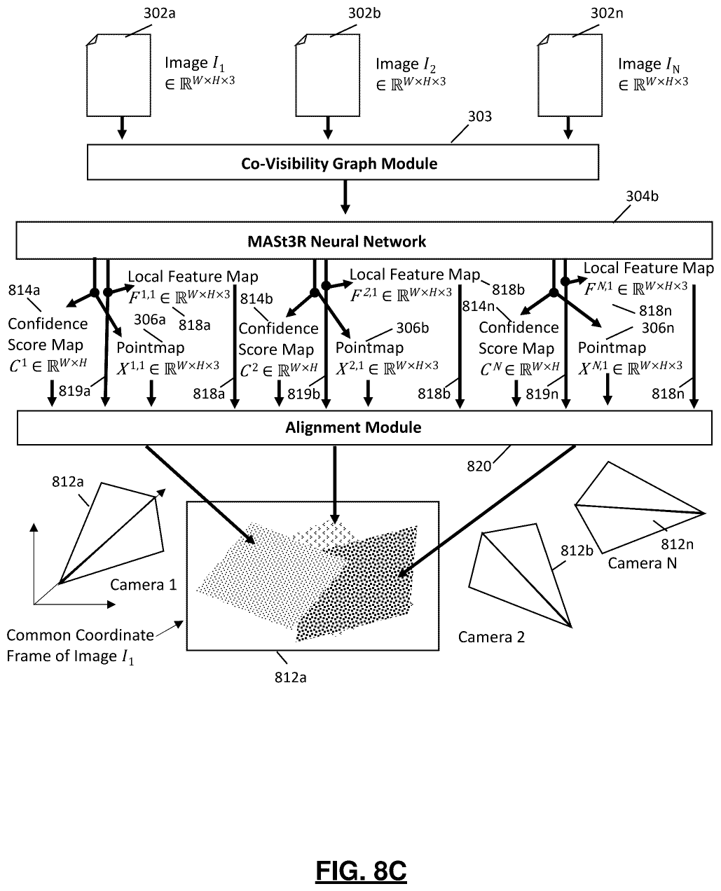

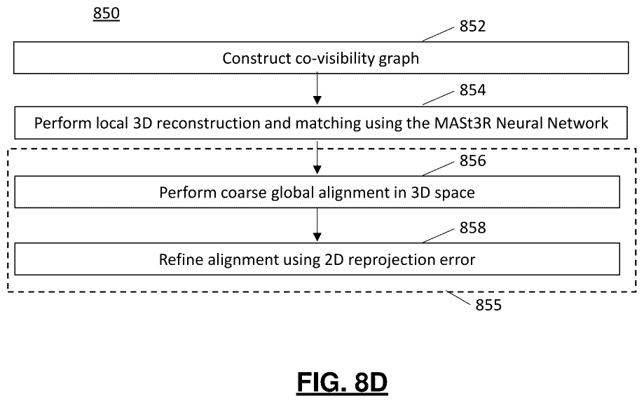

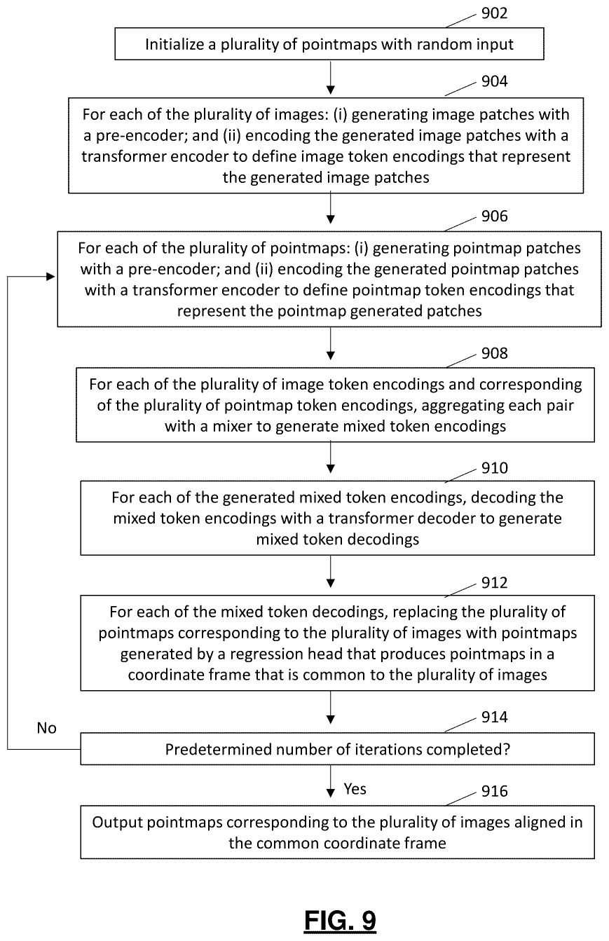

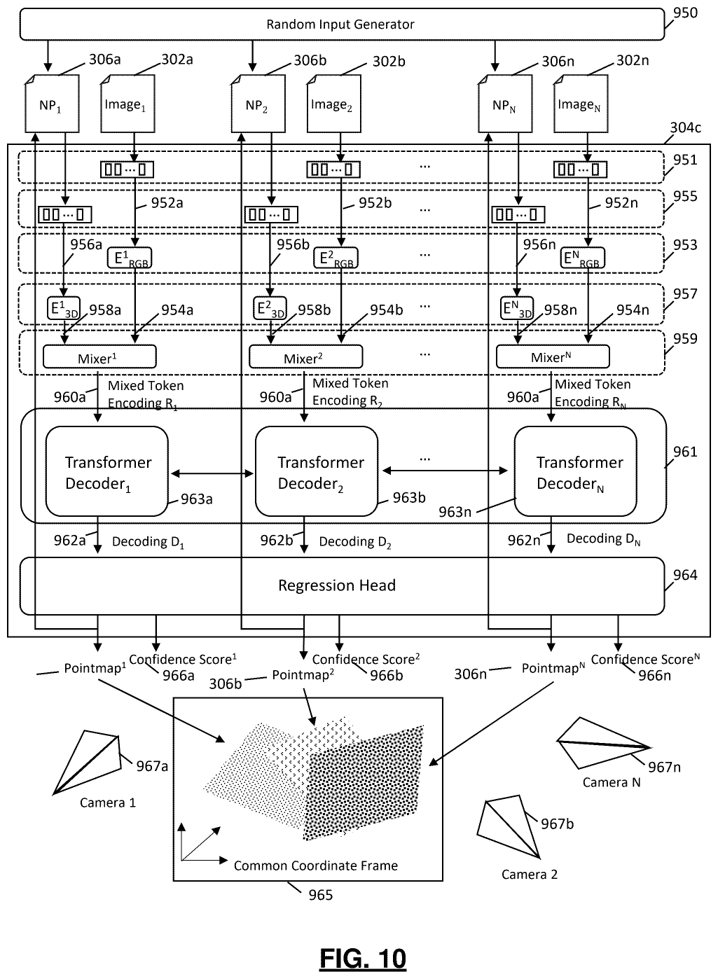

This Section sets forth a second neural network architecture of the neural network 304 shown in FIGS. 3 and 4, which is also referred to herein as the C-GAR (Camera-Geometry Agnostic 3D Reconstruction) architecture. FIG. 9 is a flow diagram of the method carried out by the C-GAR architecture and FIG. 10 is a block diagram of elements of the C-GAR architecture, for generating pointmaps aligned in a common coordinate frame using neural network 403c.

At 902, a plurality of pointmaps 306 are initialized using random input generator 950 with random input (e.g., random noise). At 904, (i) for each of the plurality of images 302 {I₁, I₂, . . . , I_{N}}, image patches 952 are generated with a pre-encoder 951, and (ii) the generated image patches 952 are encoded with a transformer encoder 953 to generate image token encodings 954 representative thereof. At 906, (i) for each of the plurality of pointmaps 306 initialized at 902, pointmap patches 956 are generated by a pre-encoder 955; and (ii) the generated pointmap patches 956 are encoded with a transformer encoder 957 to generate pointmap token encodings 958 representative thereof.

At 908, a mixer 959, e.g., a transformer decoder neural network, aggregates the image token encodings 954 and the pointmap token encodings 958 for each respective image of the plurality of images 302 {I₁, I₂, . . . , I_{N}} to generate mixed token encodings 960. At 910, the mixed token encodings 960 are decoded by a transformer decoder 961 with decoder blocks 963 to generate mixed token decodings 962, respectively. Similar to the DUSt3R architecture, each decoder block 963 performs self-attention (each token of a view attends to tokens of the same view) and cross-attention (each token of a view attends to all other tokens of the other view).

At 912, for each of the mixed token decodings 962, the plurality of pointmaps 306 corresponding to the plurality of images 302 are replaced with pointmaps 306 generated by a regression head 964 that produces pointmaps 306 in a coordinate frame 965 that is common to the plurality of images 302, which may be different from the coordinate frame 967 from which the respective images 302 are captured. At 914, a determination is made whether a predetermined number of iterations has been performed. In the event the number of iterations has not been performed at 912, the pointmaps 306 generated by regression head 964 now serve as input pre-encoder 955 and steps 906, 908, 910, 912 and 914 are repeated. In the event the number of iterations has been performed at 912, the pointmaps produced by the regression head 964 on the last iteration are output with confidence scores 966, corresponding to the plurality of images 302 that are aligned in the common coordinate frame 965.

Additional details concerning the C-GAR architecture described in this Section are set forth in Section D (below), including training and experimentation.

### Section A.6 Global Alignment

With reference again to the example shown in FIG. 3 that uses a single neural network 304 to process a set of two or more (1 . . . . M) input images 302, where M≥N, the total number of images 302 to be processed by neural network 304. In the event the total number of images N of the scene 301 to be processed exceeds M (the total number of images network 304 may process), the embodiment in FIG. 4 may be used to process subsets of images 403 (at 506 in FIG. 5). For example, assuming M=2 and N=2, given two views of a scene (I₁,I₂), the neural network 302 processes the two images and produces two pointmaps aligned in a common coordinate frame as shown in FIG. 3.

In contrast, the embodiment shown in FIG. 4 uses neural network 304 at least twice. Assuming M=2 (the total number of images network 304 may process) and N=3 (the total number of images to be processed, i.e., there exists three views of a scene (I₁, I₂, I₃)), the neural network 304 processes a first subset 403a of two images (for example, I₁, I₂) and a second subset 403b of two images (for example, I₃, I₂), resulting in two sets of pointmaps at 405a and 405b in FIG. 4 (at 506 and 504 in FIG. 5). Assuming all subsets of images 403 have been processed at 506 in FIG. 5 (image pair I₁, I₃ could also be processed but it may not be necessary), a global coordinate frame alignment is performed by global aligner 407 (at 510 in FIG. 5) to align processed subsets 405 of pointmaps (e.g., to align in a common coordinate frame the subset of pointmaps 405a for image pairs I₁, I₂ with pointmaps that are aligned together in a first coordinate frame and the subset of pointmaps 405b for image pairs I₃, I₂ with pointmaps that are aligned together in second common coordinate frame). Such processing at 510 enables the alignment of multiple subsets of pointmaps 405 predicted from multiple subsets of images 403 into a joint 3D space of aligned pointmaps 308 for a scene 301. This is possible because the content of the pointmaps 306 encompasses subsets of aligned point-clouds and their corresponding pixel-to-3D mappings as discussed with reference to FIG. 6.

Aligning subsets of pointmaps 405 of a scene 301 processed by global aligner 407 in FIG. 4 (at 510 in FIG. 5) involves the construction of a connectivity graph. For example, given a set of images {I¹, I², . . . , I^{N}} for a given scene, a connectivity graph G(V, E) is constructed by the global aligner 407 where N images form vertices V and each edge e=(n,m)∈E indicates that images Iⁿ and I^{m} shares some visual content. In one embodiment, all image pairs are passed through network 304 and their overlap is measured based on the average confidence in both pairs, then low-confidence pairs are filtered out. In various implementations, image retrieval methods may be used to construct a connectivity graph.

After constructing a connectivity graph G, globally aligned pointmaps are recovered {Xₙ∈R^{W×H×3}} for all camera viewpoints n=1 . . . . N that captured images of the scene, by predicting for each image pair e=(n,m)∈E, the pairwise pointmaps X^{n,n}, X^{m,n} and their associated confidence maps C^{n,n}, C^{m,n}. More specifically, denoting X^{n,e}: =X^{m,n} and X^{m,e}: =X^{m,n}, and since the goal involves rotating all pairwise predictions in a common frame, a pairwise pose Pₑ and scaling o^{e}>0 associated with each edge e∈E are defined. Given the forgoing, the following optimization problem may be solved:

$${χ}^{*} = {arg min}_{χ , P , σ} {\sum }_{e ∈ ℰ} {\sum }_{v ∈ e} {\sum }_{i = 1}^{HW} {C}_{i}^{v , e} ‖ {χ}_{i}^{v} - {σ}_{e} {P}_{e} {X}_{i}^{v , e} ‖ .$$

Solving such global optimization may be carried out using gradient descent which in an example converges after a few hundred steps, involving seconds on a standard GPU (Graphics Processing Unit). The idea is that, for a given pair e=(n,m), the same rotation Pₑ should align both pointmaps X^{n,e} and X^{m,e} with the world-coordinate pointmaps Xⁿ and X^{m}, since X^{n,e} and X^{m,we} are by definition both expressed in the same coordinate frame. To avoid the trivial optimum where σₑ=0, ∀e∈E, Πₑ σₑ=1 is enforced. An extension to this framework enables the recovery of all cameras parameters: by replacing Xⁿ: =Pₙ⁻¹ h(Kₙ⁻¹ [U Dₙ; V Dₙ; Dₙ]), all camera poses {Pₙ}, associated intrinsics {Kₙ} and depthmaps {Dₙ} for n=1 . . . . N may be estimated.

### Section A.7 Review

Generally speaking, the neural networks disclosed herein reconstruct a 3D scene from un-calibrated and un-posed images by unifying monocular and binocular 3D reconstruction. The pointmap representation for Multi-View Stereo (MVS) applications enables the neural network to predict 3D shapes in a canonical frame, while preserving the implicit relationship between pixels and the scene. This effectively drops many constraints of the usual perspective camera formulation. Further, an optimization procedure may be used to globally align pointmaps in the context of multi-view 3D reconstruction by optimizing the camera pose and geometry alignment directly in 3D space. This procedure can extract intermediary outputs of existing Structure-from-Motion (SfM) and MVS pipelines. Finally, the neural networks disclosed herein are adapted to handle real-life monocular and multi-view reconstruction scenarios seamlessly, even when the camera is not moving between frames.

In addition to methods set forth for generating 3D representations of scenes from a plurality of images, the present application includes a computer program product comprising code instructions to execute the methods described herein (particularly data processors 112 of the servers 101 and the client devices 102), and storage readable by computer equipment (memory 113) provided with this computer program product for storing such code instructions.

### Section B. DUSt3R: Dense Unconstrained Stereo 3D Reconstruction

Multi-view stereo reconstruction (MVS) in the wild involves first estimating by one or more processors the camera parameters (e.g., intrinsic and extrinsic parameters). These may be tedious and cumbersome to obtain, yet they are used to triangulate corresponding pixels in 3D space, which may be important. In this disclosure, an opposite stance is taken and DUSt3R is introduced, a novel paradigm for Dense and Unconstrained Stereo 3D Reconstruction (DUSt3R) of arbitrary image collections (operating without prior information about camera calibration nor viewpoint poses). The pairwise reconstruction problem is cast as a regression of pointmaps, relaxing the hard constraints of projective camera models. This present application shows that this formulation smoothly unifies the monocular and binocular reconstruction cases. In the case where more than two images are provided, this application proposes a simple yet effective global alignment strategy that expresses all pairwise pointmaps in a common reference frame. The disclosed network architecture is based on transformer encoders and decoders, which allows powerful pretrained models to be leveraged. The disclosed formulation directly provides a 3D model of the scene as well as depth information, but interestingly, pixel matches, relative and absolute cameras can be seamlessly recovered from it. Experiments on all these tasks showcase that DUSt3R can unify various 3D vision tasks and set high performance on monocular/multi-view depth estimation as well as relative pose estimation. Advantageously, DUSt3R makes many geometric 3D vision tasks easy to perform.

### Section B.1 Introduction

Unconstrained image-based dense 3D reconstruction from multiple views is useful for computer vision. Generally speaking, the task aims at estimating the 3D geometry and camera parameters of a scene, given a set of images of the scene. Not only does it have numerous applications/tasks like mapping, navigation, archaeology, cultural heritage preservation, robotics, but perhaps more importantly, it holds a fundamentally special place among all 3D vision tasks. Indeed, it subsumes nearly all of the other geometric 3D vision tasks. Thus, some approaches for 3D reconstruction include keypoint detection and matching, robust estimation, Structure-from-Motion (SfM) and Bundle Adjustment (BA), dense Multi-View Stereo (MVS), etc.

SfM and MVS pipelines may involve solving a series of minimal problems: matching points, finding essential matrices, triangulating points, sparsely reconstructing the scene, estimating cameras and finally performing dense reconstruction. This rather complex chain may be a viable solution in some settings, but here may be unsatisfactory: each sub-problem may not be solved perfectly and adds noise to the next step, increasing the complexity and the engineering effort for the pipeline to work as a whole. In this regard, the absence of communication between each sub-problem may be telling: it would seem more reasonable if they helped each other, i.e., dense reconstruction may benefit from the sparse scene that was built to recover camera poses, and vice-versa. In addition, functions in this pipeline may be brittle. For instance, a stage of SfM that serves to estimate all camera parameters, may fail in situations, e.g., when the number of scene views is low, for objects with non-Lambertian surfaces, in case of insufficient camera motion, etc.

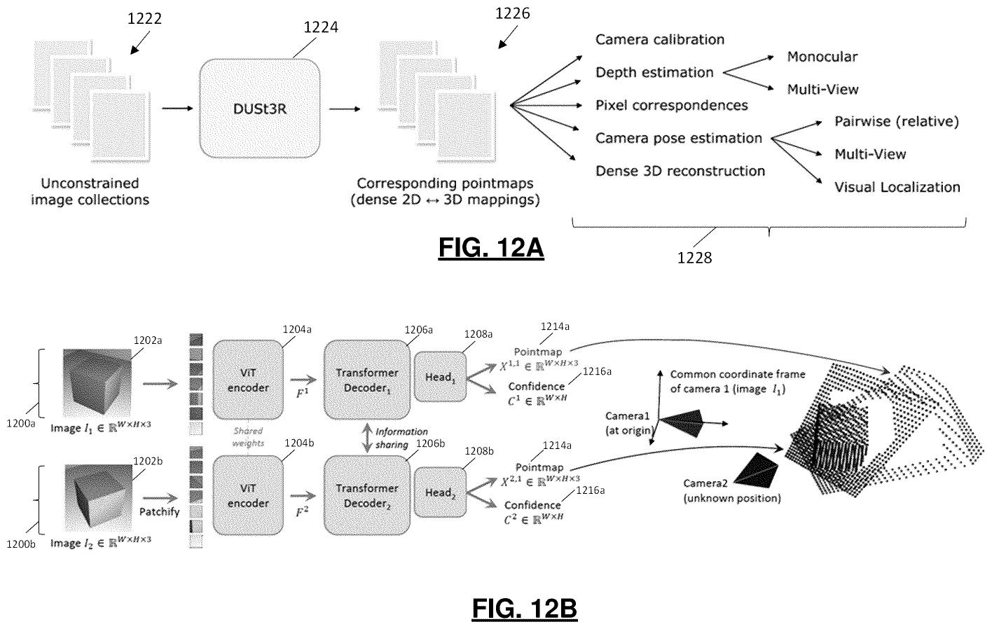

In this Section B, DUSt3R, a novel approach for Dense Unconstrained Stereo 3D Reconstruction from un-calibrated and un-posed cameras, is presented. FIG. 12A illustrates that given a set of photographs 1222 with unknown camera poses and intrinsics, the proposed DUSt3R network 1224 outputs a set of corresponding pointmaps 1226, from which can be recovered a variety of geometric quantities 1228 normally difficult to estimate all at once, such as the camera parameters, pixel correspondences, depthmaps, and fully consistent 3D reconstruction. The DUSt3R network 1224 also works for a single input image (e.g., achieving in this case monocular reconstruction).

A component is a network that can regress a dense and accurate scene representation solely from a pair of images, without prior information regarding the scene nor the cameras (not even the intrinsic parameters). The resulting scene representation is based on 3D pointmaps with rich properties: they simultaneously encapsulate (a) the scene geometry, (b) the relation between pixels and scene points and (c) the relation between the two viewpoints. From this output alone, practically all scene parameters (i.e., cameras and scene geometry) can be extracted. This is possible because the disclosed systems and methods jointly processes the input images and the resulting 3D pointmaps, thus learning to associate 2D structures with 3D shapes, and having the opportunities of solving multiple minimal problems simultaneously, enabling internal ‘collaboration’ between them.

As set forth above, the disclosed model may be trained in a fully-supervised manner using a regression loss, leveraging large public datasets for which ground-truth annotations are either synthetically generated, reconstructed from SfM software or captured using dedicated sensors). The disclosed embodiments drift away from integrating task-specific modules, and instead adopt a fully data-driven strategy based on a transformer architecture, not enforcing any geometric constraints at inference, but being able to benefit from powerful pretraining schemes. The network learns strong geometric and shape priors, like shape from texture, shading or contours.

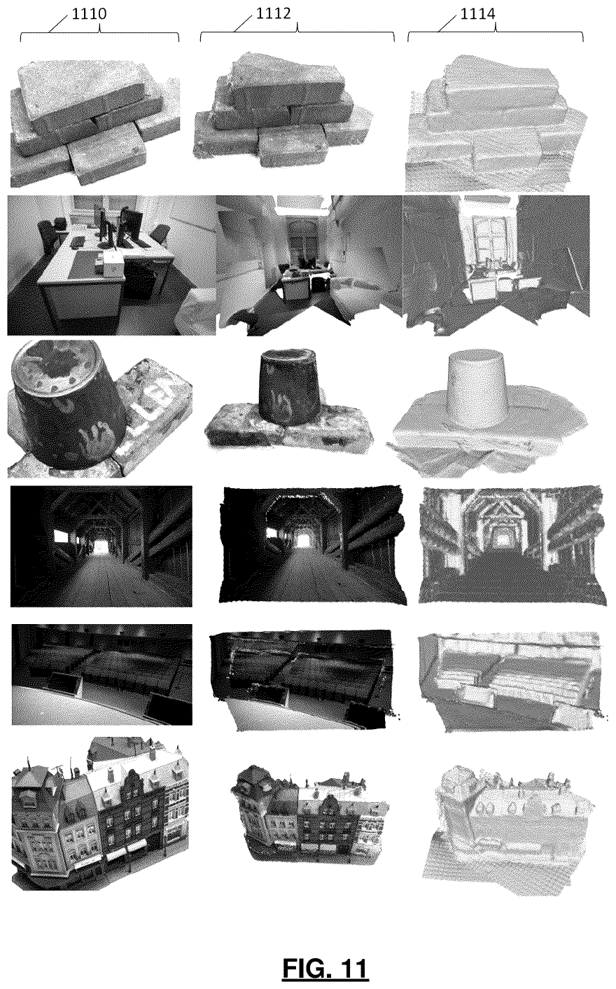

To fuse predictions from multiple images pairs, bundle adjustment (BA) for the case of pointmaps may be used, thereby achieving full-scale MVS. The disclosed embodiments introduce a global alignment procedure that, contrary to BA, does not involve minimizing reprojection errors. Instead, the camera pose and geometry alignment directly in 3D space are optimized, which is fast and shows excellent convergence in practice. The disclosed experiments show that the reconstructions are accurate and consistent between views in real-life scenarios with various unknown sensors. The disclosed embodiments further demonstrate that the same architecture can handle real-life monocular and multi-view reconstruction scenarios seamlessly. Examples of reconstructions using the DUSt3R network shown in FIG. 12A are shown in FIG. 11. More specifically, FIG. 11 shows qualitative examples using samples from the DTU dataset (see Aanæs et al., “Large-Scale Data for Multiple-View Stereopsis” in IJCV, 2016), Tanks and Temples (see Knapitsch et al., “Tanks and temples: Benchmarking large-scale scene reconstruction”, in ACM Transactions on Graphics, 36 (4), 2017) and ETH-3D (see Schops et al., “A Multi-View Stereo Benchmark with High-Resolution Images and Multi-Camera Videos”, CVPR, 2017) datasets obtained without camera parameters; for each sample there is shown: an input image 1110, a point cloud 1112, and a rendered (with shading for a better) view of the underlying geometry 1114.

The disclosed contributions are fourfold. First, the first holistic end-to-end 3D reconstruction pipeline from un-calibrated and un-posed images is presented that unifies monocular and binocular 3D reconstruction. Second, the pointmap representation for MVS applications is introduced that enables the network to predict the 3D shape in a canonical frame, while preserving the implicit relationship between pixels and the scene. This effectively drops many constraints of perspective camera formulations. Third, an optimization procedure to globally align pointmaps in the context of multi-view 3D reconstruction is introduced. The disclosed procedure can extract effortlessly all usual intermediary outputs of the classical SfM and MVS pipelines. The disclosed approaches unify 3D vision tasks and considerably simplify other reconstruction pipelines, making DUSt3R seem simple and easy in comparison. Fourth, promising performance is demonstrated on a range of 3D vision tasks, such as multi-view camera pose estimation.

### Section B.2 Related Work

Some related works in 3D vision are summarized in this Section. Additional related works are summarized in Section B.6.2 (below).

Structure-from-Motion (SfM) involves reconstructing sparse 3D maps while jointly determining camera parameters from a set of images. Some pipelines starts from pixel correspondences obtained from keypoint matching between multiple images to determine geometric relationships, followed by bundle adjustment to optimize 3D coordinates and camera parameters jointly. Learning-based techniques may be incorporated into subprocesses. The sequential structure of the SfM pipelines persist however, making it vulnerable to noise and errors in each individual component.

MultiView Stereo (MVS) involves the task of densely reconstructing visible surfaces, which is achieved via triangulation between multiple viewpoints. In a formulation of MVS, all camera parameters may be provided as inputs. Approaches may depend on camera parameter estimates obtained via calibration procedures, either during the data acquisition or using Structure-from-Motion approaches for in-the-wild reconstructions. In real-life scenarios, inaccuracy of pre-estimated camera parameters can be detrimental for proper performance. This present application proposes instead to directly predict the geometry of visible surfaces without any explicit knowledge of the camera parameters.

Direct RGB-to-3D. Some approaches may directly predict 3D geometry from a single RGB image. Neural networks that learn strong 3D priors from large datasets to solve ambiguities may be leveraged. These methods can be classified into two groups. A first group leverages class-level object priors. For instance, learning a model that can fully recover shape, pose, and appearance from a single image, given a large collection of 2D images may be used. A second group may involve general scenes. Systematically built may be monocular depth estimation (MDE) networks. Depth maps encode a form of 3D information and, combined with camera intrinsics, can yield pixel-aligned 3D point-clouds. SynSin (see Wiles et al., “SynSin: End-to-end view synthesis from a single image”, in CVPR, pp. 7465-7475, 2020), for example, performs new viewpoint synthesis from a single image by rendering feature-augmented depthmaps knowing all camera parameters. Without camera intrinsics, they can be inferred by exploiting temporal consistency in video frames, either by enforcing a global alignment or by leveraging differentiable rendering with a photometric reconstruction loss. Another way is to explicitly learn to predict camera intrinsics, which enables performing metric 3D reconstruction from a single image when combined with MDE networks. These methods are, however, intrinsically limited by the quality of depth estimates, which is poorly suited for monocular settings.

The proposed network processes two viewpoints simultaneously in order to output depthmaps, or rather, pointmaps. In theory, at least, this makes triangulation between rays from different viewpoint possible. The disclosed networks output pointmaps (i.e., dense 2D field of 3D points), which handle camera poses implicitly and makes the regression problem better posed.

Pointmaps. Using a collection of pointmaps as shape representation is counter-intuitive for MVS.

### Section B.3 Method

Before discussing the details of the disclosed method, this Section introduces some concepts of pointmaps introduced above.

Pointmap. In the following, a dense 2D field of 3D points is denoted as a pointmap X∈ [symbol] ^{W×H×3}. In association with its corresponding RGB image I of resolution W×H, X forms a one-to-one mapping between image pixels and 3D scene points, i.e., I_{i,j}←X_{i,j}, for all pixel coordinates (i, j)∈{1 . . . . W}×{1 . . . . H}. The disclosed embodiments assume that each camera ray hits a single 3D point (i.e., ignoring the case of translucent surfaces).

Camera and scene. Given the camera intrinsics K∈ [symbol] ^{3×3}, the pointmap X of the observed scene can be obtained by one or more processors from the ground-truth depthmap D∈ [symbol] ^{W×H} as X_{i,j}=K⁻¹ [iD_{i,j}, jD_{i,j}, D_{i,j}]^{T}. Here, X is expressed in the camera coordinate frame. In the following, X^{n,m} is denoted as the pointmap Xⁿ from camera n expressed in camera m's coordinate frame:

$${X}^{n , m} = {P}_{m} {P}_{n}^{- 1} h ( {X}^{n} ) \qquad ( B1 )$$

with Pₘ, Pₙ∈ [symbol] ^{3×4} the world-to-camera poses for images n and m, and h: (x, y, z)→(x, y, z, 1) the homogeneous mapping.

### Section B.3.1 Overview

The disclosed embodiments describe a network that solves the 3D reconstruction task for the generalized stereo (multiple image) case through direct regression. To that aim, a network [symbol] is trained that takes as input 2 RGB images I¹, I² ∈ [symbol] ^{W×H×3} and generates 2 corresponding pointmaps X^{1,1}, X^{2,1} ∈ [symbol] ^{W×H×3} with associated confidence maps C^{1,1}, C^{2,1}∈ [symbol] ^{W×H} based on the respective RGB images. Both pointmaps are expressed in the same coordinate frame of I¹, which offers advantages as described herein. For the sake of clarity and without loss of generality, both images are assumed to have the same resolution W×H, but in practice their resolution can differ.

Network architecture. FIG. 12B illustrates an example architecture of the DUSt3R network shown in FIG. 12A. The architecture of the disclosed network [symbol] 1204 may benefit from CroCo pretraining. Details on the Cross-view Completion “CroCo” architecture and pretraining is set forth in Weinzaepfel et al., (i) “CroCo: Self-Supervised Pre-Training for 3D Vision Tasks by Cross-View Completion”, in NeurIPS, 2022 and (ii) “CroCo v2: Improved Cross-view Completion Pre-training for Stereo Matching and Optical Flow”, in ICCV, 2023 ((i) and (ii) also referred to herein as “Weinzaepfel et al. 2023”), and in (iii) U.S. patent application Ser. Nos. 18/230,414 and 18/239,739, each of which is incorporated herein in its entirety. The resulting token representations F¹ and F² of networks 1204a and 1204b, respectively, are passed to two transformer decoders 1206 that constantly exchange information via cross-attention and finally, two regression heads 1208 output the two corresponding pointmaps 1214 and associated confidence maps 1216. The two pointmaps 1214a and 1214b may be expressed in the same coordinate frame of the first image I¹, and the network F is trained using a simple regression loss.

More specifically, as shown in FIG. 12B, an architecture of the DUSt3R network shown in FIG. 12A include two (e.g., identical) branches 1200a and 1200b (one for each image 1202) comprising each an image encoder 1204, a decoder 1206 and a regression head 1208. The two input images 1202 are first encoded in a Siamese manner by the same weight-sharing ViT encoder 1204 (see Dosovitskiy et al.), yielding two token representations F¹ and F²:

$${F}^{1} = Encoder ( {I}^{1} ) , {F}^{2} = Encoder ( {I}^{2} ) .$$

The network reasons over both token representations jointly in the decoder 1206. Similarly to CroCo, the decoder 1206 may be a transformer network equipped with cross attention. Each decoder block 1206 sequentially performs self-attention (each token of a view attends to tokens of the same view), then cross-attention (each token of a view attends to all other tokens of the other view), and finally feeds tokens to regression head 1208, such as a Multi-Layer Perceptron (MLP). Importantly, information is constantly shared between the two branches during the decoder pass/operation 1206. This is to output properly aligned pointmaps. Namely, each decoder block 1206 attends to tokens from the other branch, such as follows:

$${G}_{i}^{1} = {DecoderBlock}_{i}^{1} ( {G}_{i - 1}^{1} , {G}_{-} ( i - 1 ) \hat{} 2 ) \\ {G}_{i}^{2} = {DecoderBlock}_{i}^{2} ( {G}_{i - 1}^{2} , {G}_{-} ( i - 1 ) \hat{} 1 )$$

for i=1, . . . , B for a decoder with B blocks and initialized with encoder tokens G₀¹: =F¹ and G₀²: =F². Here, DecoderBlock ^{v}ᵢ(G¹, G²) denotes the i-th block in branch v∈{1,2}, G¹ and G² are the input tokens, with G² the tokens from the other branch. Finally, in each branch a separate regression head 1208 takes the set of decoder tokens and outputs a pointmap and an associated confidence map:

$${X}^{1 , 1} , {C}^{1 , 1} = {Head}^{1} ( {G}_{0}^{1} , … , {G}_{B}^{1} ) , \\ {X}^{2 , 1} , {C}^{2 , 1} = {Head}^{2} ( {G}_{0}^{2} , … , {G}_{B}^{2} ) ,$$

where X^{1,1} and X^{2,1} are output pointmaps and C^{1,1} and C^{2,1} are output confidence score maps.

The output pointmaps X^{1,1} and X^{2,1} are regressed up to a scale factor, such as by the regression heads. The disclosed architecture may not explicitly enforce any geometrical constraints. Hence, pointmaps may not necessarily correspond to any physically plausible camera model. Rather, the network is allowed learn all relevant priors present from the training set, which only includes geometrically consistent pointmaps. Using the described architecture allows leveraging strong pretraining technique, ultimately surpassing what task-specific architectures can achieve. The learning process is detailed in the next section.

### Section B.3.2 Training/Learning Objective

3D Regression loss. A training objective is based on regression in the 3D space. The ground truth pointmaps are denoted as X̅^{1,1} and X̅^{2,1}, obtained from Equation B1 along with two corresponding sets of valid pixels D¹, D²⊆{1 . . . W}×{1 . . . . H} on which the ground-truth is defined. The regression loss for a valid pixel i∈D^{v} in view v∈{1, 2} may be defined as the Euclidean distance:

$${ℓ}_{regr} ( v , i ) = ‖ \frac{1}{z} {X}_{i}^{v , 1} - \frac{1}{\overline{z}} {\overline{X}}_{i}^{v , 1} ‖ \qquad ( B2 )$$

To handle the scale ambiguity between prediction and ground-truth, the predicted and ground-truth pointmaps may be normalized (e.g., by a normalization module) by scaling factors z=norm (X^{1,1}, X^{2,1}) and z̅=norm (X̅^{1,1}, X̅^{2,1}), respectively, which represent the average distance of all valid points to the origin:

$$norm ( {X}^{1} , {X}^{2} ) = \frac{1}{\vert D 1 \vert + \vert D 2 \vert} {\sum }_{v ∈ \{ 1 , 2 \}} {\sum }_{i ∈ {D}^{v}} ‖ {X}_{i}^{v} ‖ \qquad ( B3 )$$

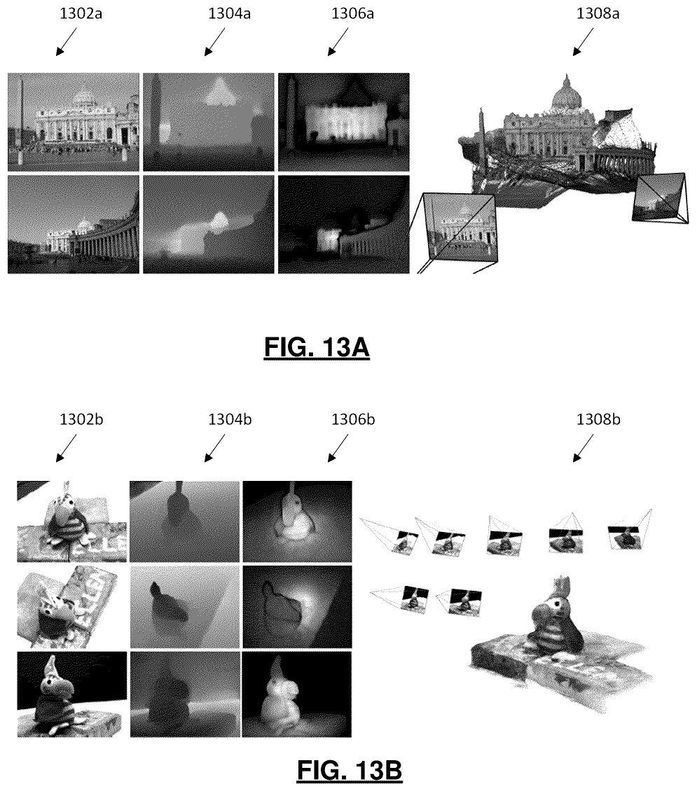

Confidence-aware loss. In reality, there may be ill-defined 3D points, e.g., in the sky or on translucent objects. More generally, some parts in the image may be harder to predict that others. The disclosed embodiments jointly learn to predict a score for each pixel which represents the confidence that the network has about this particular pixel. The final training objective is the confidence-weighted regression loss from Equation B2 over all valid pixels:

$${ℒ}_{conf} = {\sum }_{v ∈ \{ 1 , 2 \}} {\sum }_{i ∈ {D}^{v}} {C}_{i}^{v , 1} {l}_{regr} ( v , i ) - α log {C}_{i}^{v , 1} , \qquad ( B4 )$$

where Cᵢ^{v,1} is the confidence score for pixel i, and α is a hyper-parameter controlling the regularization term (see Wan et al., “Confnet: Predict with confidence”, in ICASSP, pp. 2921-2925, 2018, which is incorporated herein in its entirety). To ensure a strictly positive confidence, define Cᵢ^{v,1}=1+exp [symbol] >1. This has the effect of forcing the network to extrapolate in harder areas, e.g., like those ones covered by a single view. Training network F with this objective allows to estimate confidence scores without explicit supervision. Examples of input image pairs with their corresponding outputs are shown in FIGS. 13A and 13B. More specifically, FIGS. 13A and 13B show reconstruction examples on two scenes never seen during training, with from left to right: RGB 1302, depth map 1304, confidence map 1306 and reconstruction 1308; the scene in FIG. 13A shows the raw result output from F(I1, I2) and the scene in FIG. 13B shows the outcome of global alignment discussed in Section B.3.4.

### Section B.3.3 Downstream Applications

The rich properties of the output pointmaps allows various convenient operations/tasks to be performed using the pointmaps.

Establishing correspondences between pixels of two images can be achieved using nearest neighbor (NN) search in the 3D pointmap space. To minimize errors, retaining of reciprocal (mutual) correspondences M_{1,2} between images I¹ and I² may be performed, i.e., providing:

$$〚 M\_ 1 , 2 = \{ ( i , j ) \vert i = NN 〛 \_ 1 \hat{} 1 , 2 ( j ) and j = 〚 NN 〛 \_ 1 \hat{} 2 , 1 ( i ) \} \\ with {NN}_{k}^{n , m} ( i ) = {arg min}_{j ∈ \{ 0 , … , WH \}} 〚 ‖ 〛 {X}_{j}^{n , k} - {X}_{i}^{m , k} ‖ .$$

The pointmap X^{1,1} is expressed in image I¹'s coordinate frame. It is therefore possible to estimate the camera intrinsic parameters by solving an optimization problem based on the pointmap. In this disclosure, it is assumed that the principal point is approximately centered and pixel are squares, hence only the focal length f₁* remains to be estimated:

$${f}_{1}^{*} = {arg min}_{{f}_{1}} {\sum }_{i = 0}^{W} {\sum }_{j = 0}^{H} {C}_{i , j}^{1 , 1} ‖ ( {i}^{′} , {j}^{′} ) - {f}_{1} \frac{( {X}_{i , j , 0}^{1 , 1} , {X}_{i , j , 1}^{1 , 1} )}{{X}_{i , j , 2}^{1 , 1}} ‖ , \qquad ( B5 )$$

with

$${i}^{′} = i - \frac{W}{2} and {j}^{′} = j - \frac{H}{2} .$$

Fast iterative solvers, e.g., based on the Weiszfeld algorithm (see Frank Plastria, “The Weiszfeld Algorithm: Proof, Amendments, and Extensions” in Foundations of Location Analysis, pp. 357-389, Springer, 2011, which is incorporated herein in its entirety), can be used to find the focal length f₁* in a few iterations. For the focal length f₂* of the second camera, an option is to perform the inference for the image pair (I², I¹) and use Equation B5 with pointmap X^{2,2} instead of pointmap X^{1,1}.

Relative pose estimation can be achieved in several ways. One way is to perform 2D matching and recover intrinsics as described above, then estimate the Epipolar matrix and recover the relative pose. Another, more direct, way is to compare the pointmaps X^{1,1}↔X^{1,2} (or, equivalently, X^{2,2}↔X^{1,2}) using Procrustes alignment (see Luo et al., “Procrustes alignment with the EM algorithm”, in CAIP, vol. 1689 of Lecture Notes in Computer Science, pp. 623-631, Springer, 1999, which is incorporated herein in its entirety) to determine the relative pose P*=[R*|t*]:

$${R}^{*} , {t}^{*} = {arg min}_{σ , R , t} {\sum }_{i} {C}_{i}^{1 , 1} {C}_{i}^{1 , 2} {‖ σ ( {RX}_{i}^{1 , 1} + t ) - {X}_{i}^{1 , 2} ‖}^{2} ,$$

which can be achieved in closed-form. Procrustes alignment may be sensitive to noise and outliers. Another solution is to use RANSAC (Random Sample Consensus) with PnP (Perspective-n-Point), i.e., PnP-RANSAC (see Fischler et al., “Random Sample Consensus: A Paradigm for Model Fitting with Applications to Image Analysis and Automated Cartography”, in Commun. ACM 24(6): 381-95, 1981 and Lepetit et al., “EPnP: An accurate O(n) solution to the PnP problem”, in IJCV, 2009, which is incorporated herein in its entirety).

Absolute pose estimation, also termed visual localization, can likewise be achieved in several different ways. Let I^{Q} denote the query image and I^{B} the reference image for which 2D to 3D correspondences are available. First, intrinsics for IQ can be estimated from pointmap X^{Q,Q} as discussed above. One solution includes obtaining 2D correspondences between I^{Q} and I^{B}, which in turn yields 2D-3D correspondences for 19, and then running PnP-RANSAC. Another solution is to determine the relative pose between I^{Q} and I^{B} as described previously. Then, this pose is converted to world coordinates by scaling it appropriately, according to the scale between X^{B,B} and the ground-truth pointmap for IB. A pose module may determine pose as described herein.

### Section B.3.4 Global Alignment

The network [symbol] presented so far in this Section B.3 can handle a pair of images. Presented now is a fast and simple post-processing optimization for entire scenes that enables the alignment of pointmaps predicted from multiple (e.g., more than two) images into a joint 3D space (i.e., global aligner 407 shown in FIG. 4). This is possible due to the rich content of the disclosed pointmaps, which encompasses by design two aligned point-clouds and their corresponding pixel-to-3D mapping.

Pairwise graph. Given a set of images {I¹, I², . . . , I^{N}} for a given scene, first a connectivity graph G (V, E) is generated where N images form vertices V and each edge e=(n,m)∈E indicates that images Iⁿ and I^{m} shares some visual content. To that aim, either an image retrieval method is used, or all pairs are passed through network F and their overlap is measured based on the average confidence in both pairs, then out low-confidence pairs are filtered out.

Global optimization. The disclosed embodiments use the connectivity graph G to recover globally aligned pointmaps {Xⁿ∈ [symbol] ^{W×H×3}} for all cameras n=1 . . . . N. To that aim, first predict, for each image pair e=(n,m)∈E, the pairwise pointmaps X^{n,n}, X^{m,n} and their associated confidence maps C^{n,n}, C^{m,n}. For the sake of clarity, let the following be defined as: X^{n,e}: =X^{n,n} and X^{m,e}: =X^{m,n}. Since the disclosed goal involves rotating all pairwise predictions in a common coordinate frame, a pairwise pose Pₑ ∈R^{3×4} and scaling σₑ>0 associated to each pair e∈E is introduced. Then the following optimization problem may be formulated:

$${χ}^{*} = {arg min}_{X , P , σ} {\sum }_{e ∈ E} {\sum }_{v ∈ e} {\sum }_{i = 1}^{WH} {C}_{i}^{v , e} ‖ {χ}_{i}^{v} - {σ}_{e} {P}_{e} {X}_{i}^{v , e} ‖ . \qquad ( B6 )$$

where v∈e for v∈{n,m} if e=(n,m). For a given image pair e, the same rigid transformation Pₑ should align both pointmaps χ^{n,e} and χ^{m,e} with the world-coordinate pointmaps χⁿ and χ^{m}, since χ^{n,e} and χ^{m,e} are by definition both expressed in the same coordinate frame. To avoid the trivial optimum where σₑ=0, ∀e∈E, Πₑ σe=1 is enforced.

Recovering camera parameters. An extension to this framework enables the recovery of all cameras parameters. By replacing χ_(i, j)\hat{ }n:=P_n\hat{ }(−1) h(K_n\hat{ }(−1) [iD_(i, j)\hat{ }n; [symbol] jD [symbol] _(i, j)\hat{ }n; D_(i, j)\hat{ }n] (i.e., enforcing a standard camera pinhole model as in Equation B1), all camera poses {Pₙ}, associated intrinsics {Kₙ} and depthmaps {Dₙ} for n=1 . . . . N can be estimated.

Discussion Different than bundle adjustment, global optimization embodiments are fast and simple to perform in practice. The disclosed examples are not minimizing 2D reprojection errors, as in bundle adjustment, but 3D projection errors. The optimization may be carried out by a training module using gradient descent and typically converges after a few hundred steps, requiring mere seconds on a standard GPU.

Section B.4 Experiments with DUSt3R

Training data. In one embodiment, the disclosed network is trained with a mixture of eight datasets: Habitat (see Savva et al., “Habitat: A Platform for Embodied AI Research” in ICCV, 2019), MegaDepth (see Li et al., “Megadepth: Learning single-view depth prediction from internet photos”, in CVPR, pp. 2041-2050, 2018.), ARKitScenes (see Dehghan et al., “ARKitScenes: A diverse real-world dataset for 3d indoor scene understanding using mobile RGB-D data”, in NeurIPS Datasets and Benchmarks, 2021, MegaDepth, Static Scenes 3D (see Mayer et al., “A Large Dataset to Train Convolutional Networks for Disparity, Optical Flow, and Scene Flow Estimation”, in CVPR, 2016), Blended MVS (Yao et al., “BlendedMVS: A Large-Scale Dataset for Generalized Multi-View Stereo Networks”, in CVPR, 2020), ScanNet++ (see Yeshwanth et al., “ScanNet++: A high-fidelity dataset of 3d in-door scenes”, in ICCV 2023), CO3Dv2 (see Reizenstein et al., “Common Objects in 3D: Large-Scale Learning and Evaluation of Real-Life 3D Category Reconstruction”, in ICCV, 2021), and Waymo (see Sun et al., “Scalability in Perception for Autonomous Driving: Waymo Open Dataset”, in CVPR, 2020). These datasets feature diverse scenes types: indoor, outdoor, synthetic, real-world, object-centric, etc. When image pairs are not directly provided with the dataset, they are extracted based on the CroCo method. Specifically, image retrieval and point matching algorithms may be utilized to match and verify image pairs. In one embodiment 8.5 M pairs in total were extracted.

Training details. The training described herein may be performed by the training module. During each epoch, an equal number of pairs are randomly sampled from each dataset to equalize disparities in dataset sizes. In an embodiment relatively high-resolution images are fed to the disclosed network that are for example 512 pixels in the largest dimension. To mitigate the high cost associated with such input, the disclosed network is trained sequentially, first on 224×224 images and then on larger 512-pixel images. The image aspect ratios are randomly selected for each batch (e.g., 16/9, 4/3, etc.), so that at test time the disclosed network is familiar with different image shapes. Images are cropped to the target aspect-ratio, and resized so that the largest dimension is 512 pixels.

Data augmentation techniques and training set-up are used. The disclosed network architecture comprises a ViT-Large for the encoder (see Dosovitskiy et al.), a ViT-Base for the decoder and a DPT head (see Ranftl et al., “Vision transformers for dense prediction,” in ICCV, 2021, which is referred to hereinafter as “DPT” or “DPT-KITTI”). Note Section B.6.5 (below) sets forth additional details on the training and the network architecture. Before training, the network is initialized with the weights of a CroCo pretrained model. CroCo is a pretraining paradigm that has been shown to excel on various downstream 3D vision tasks and is thus suited to the disclosed framework. In Section B.4.6 the impact of CroCo pretraining and increase in image resolution is ablated.

Evaluation. In the remainder of this Section, DUSt3R is benchmarked on a representative set of classical 3D vision tasks, each time specifying datasets, metrics and comparing performance with other approaches. All results are obtained with the same DUSt3R model (the disclosed default model is denoted as ‘DUSt3R 512’, other DUSt3R models serves for the ablations in Section B.4.6), i.e., the disclosed model may not be finetuned on a particular downstream task. During testing, all test images are rescaled to 512 pixels while preserving their aspect ratio. Since there may exist different ‘routes’ to extract task-specific outputs from DUSt3R, as described in Section B.3.3 and Section B.3.4, it is noted each time the method is employed.

Qualitative results. DUSt3R yields high-quality dense 3D reconstructions even in challenging situations. See Section B.6.1 for visualizations of pairwise and multi-view reconstructions.

### Section B.4.1 Visual Localization

Dataset and metrics. DUSt3R is evaluated in this Section for the task of absolute pose estimation on the 7Scenes (see Shotton et al., “Scene coordinate regression forests for camera relocalization in RGB-D images”, in CVPR, pp. 2930-2937, 2013) and Cambridge Landmarks datasets (see Kendall et al., “PoseNet: a Convolutional Network for Real-Time 6-DOF Camera Relocalization”, in ICCV, 2015). 7Scenes contains 7 indoor scenes with RGB-D images from videos and their 6-DOF camera poses. Cambridge-Landmarks contains 6 outdoor scenes with RGB images and their associated camera poses, which are obtained via SfM. The median translation and rotation errors in (cm/°) respectively, are reported.

Protocol and results. To compute camera poses in world coordinates, DUSt3R is used as a 2D-2D pixel matcher (see Section B.3.3) between a query and the most relevant database images obtained using known image retrieval APGeM (see Revaud et al., “Learning with average precision: Training image retrieval with a listwise loss,” in ICCV, 2019). In other words, the raw pointmaps output from F(I^{Q}, I^{B}) without any refinement are used, where I^{Q} is the query image and I^{B} is a database image. The top 20 retrieved images for Cambridge-Landmarks and top 1 for 7Scenes are used, and query intrinsics are leveraged. For results obtained without using ground-truth intrinsics parameters, refer to Section B.6.4 (below).

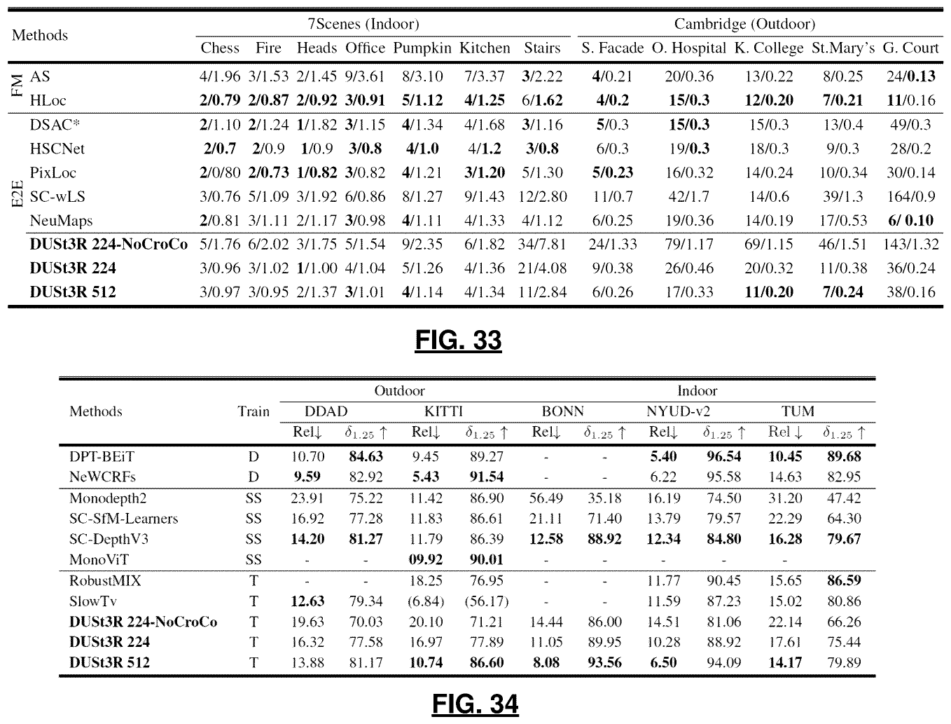

Obtained results are compared against others in the table in FIG. 33 for each scene of the 7Scenes and Cambridge-Landmarks datasets, where the median translation and rotation errors (cm/°) to feature matching (FM) based and end-to-end (E2E) learning-base methods are reported and the best results at each category are in bold. The disclosed systems and methods obtain comparable accuracy compared to other approaches, being feature-matching ones (e.g., HLoc, AS) or end-to-end learning based methods (e.g., DSAC, HSCNet, NeuMaps, SC-uLS), even managing to outperform strong baselines like HLoc in some cases. This is believed to be important for two reasons. First, DUSt3R was never trained for visual localization in any way. Second, neither query image nor database images were seen during DUSt3R's training.

### Section B.4.2 Multi-View Pose Estimation

DUSt3R is evaluated in this Section on multi-view relative pose estimation after the global alignment from Section B.3.4.

Datasets. Following, two multi-view datasets, CO3Dv2 and RealEstate10 k (Zhou et al., “Stereo Magnification: Learning View Synthesis Using Multiplane Images”, in SIGGRAPH, 2018) are used for the evaluation. CO3Dv2 contains 6 million frames extracted from approximately 37 k videos, covering 51 MS-COCO categories. The ground-truth camera poses are annotated using COLMAP (see Schonberger et al., “Structure-from-motion revisited”, in CVPR, 2016, and Schonberger et al, Pixelwise view selection for unstructured multi-view stereo”, in ECCV, 2016, which are hereinafter referred to as “COLMAP”) from 200 frames in each video. RealEstate10 k is an indoor/outdoor dataset with 10 million frames from about 80K video clips, the camera poses being obtained by SLAM (Simultaneous Localization and Mapping) with bundle adjustment. The protocol introduced in PoseDiffusion (see Wang et al., “PoseDiffusion: Solving Pose Estimation via Diffusion-Aided Bundle Adjustment” in ICCV, 2023) is followed to evaluate DUSt3R on 41 categories from CO3Dv2 and 1.8K video clips from the test set of RealEstate10 k. For each sequence, 10 frames are randomly selected and all possible 45 pairs are fed to DUSt3R.

Baselines and metrics. DUSt3R is compared to pose estimation results, obtained either from PnP-RANSAC or global alignment, against the learning-based RelPose (see Zhang et al., “RelPose: Predicting Probabilistic Relative Rotation for Single Objects in the Wild”, in ECCV, 2022), PoseReg and PoseDiffusion, and structure-based PixSFM (see Lindenberger et al., “Pixel-Perfect Structure-from-Motion with Feature metric Refinement,” in ICCV, pages 5967-5977, 2021), COLMAP+SPSG (COLMAP extended with SuperPoint (see DeTone et al., “Superpoint: Self-supervised Interest Point Detection and Description,” in CVPR Workshops, pages 224-236, 2018) and SuperGlue (see Sarlin et al., “SuperGlue: Learning Feature Matching with Graph Neural Networks,” in CVPR, pp. 4937-4946, 2020). Similar to PoseReg, the Relative Rotation Accuracy (RRA) and Relative Translation Accuracy (RTA) for each image pair to evaluate the relative pose error and select a threshold τ=15 to report RTA@15 and RRA@15 is reported. Additionally, the mean Average Accuracy (mAA) @30 is calculated, defined as the area under the curve accuracy of the angular differences at min (RRA@30, RTA@30).

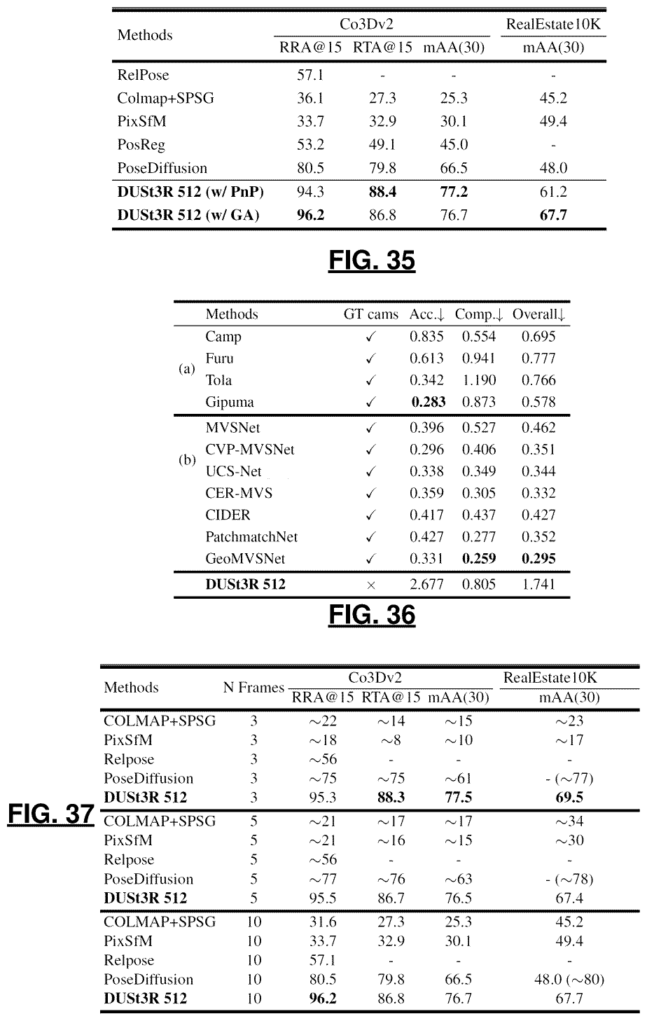

Results. As shown in tables in FIGS. 34 and 35, DUSt3R with global alignment achieves the best overall performance on the two datasets and surpasses PoseDiffusion. Moreover, DUSt3R with PnP also demonstrates superior performance over both learning and structure-based methods. It is worth noting that RealEstate10K results reported for PoseDiffusion are from the model trained on CO3Dv2. Nevertheless, this comparison is justified considering that RealEstate10K is not used either during DUSt3R's training. Performance is also reported with less input views (between 3 and 10) in Section B.6.3 (below), in which case DUSt3R also yields excellent performance on both benchmarks.

### Section B.4.3 Monocular Depth

For this monocular task, the same input image I is fed to the network as F(I, I). By design, depth prediction is the z coordinate in the predicted 3D pointmap.

Datasets and metrics. DUSt3R is benchmarked on two outdoor (DDAD (see Guizilini et al., “3D packing for self-supervised monocular depth estimation”, in CVPR, pp 2482-2491, 2020), KITTI (see Geiger et al., “Vision meets robotics: The KITTI dataset”, in Int. J. Robotics Res., 32 (11): 1231-1237, 2013)) and three indoor (NYUv2 (see Silberman et al., “Indoor segmentation and support inference from RGBD images” in ECCV, pp. 746-760, 2012), BONN (see Palazzolo et al., “Refusion: 3d reconstruction in dynamic environments for RGB-D cameras exploiting residuals”, in IROS 2019), TUM (see Sturm et al., “A benchmark for the evaluation of RGB-D SLAM systems”, in IEEE IROS, pp. 573-580, 2012.)) datasets. DUSt3R's performance is compared to other methods categorized in supervised, self-supervised and zero-shot settings, this last category corresponding to DUSt3R. Two metrics commonly used in the monocular depth evaluations are used: the absolute relative error AbsRel between target y and prediction ŷ,

$$AbsRel = \frac{\vert y - \hat{y} \vert}{y} ,$$

and the prediction threshold accuracy, δ_{1.25}=max (ŷ/y, y/ŷ)<1.25.

Results. In zero-shot setting, SlowTv (see Spencer et al., “Kick back & relax: Learning to reconstruct the world by watching slowtv”, in ICCV, 2023) performs relatively well. This approach collected a large mixture of curated datasets with urban, natural, synthetic and indoor scenes, and trained one common model. For every dataset in the mixture, camera parameters are known or estimated with COLMAP. As the tables in FIGS. 34 and 35 show, DUSt3R adapts well to outdoor and indoor environments. It outperforms the self-supervised baselines (e.g., Monodepth2, SC-DepthV3, Monodepth2, SC-DepthV3) and performs on-par with other supervised baselines (e.g., NeWCRFs).

### Section B.4.4 Multi-View Depth

DUSt3R is evaluated for the task of multi-view stereo depth estimation. Depthmaps, as the z-coordinate of predicted pointmaps, are extracted. In the case where multiple depthmaps are available for the same image, all predictions are rescaled to align them together and aggregate all predictions via an averaging weighted by the confidence.

Datasets and metrics. Following Schroppel et al. (in “A benchmark and a baseline for robust multi-view depth estimation” in 3DV, pp. 637-645, 2022), it is evaluated on the DTU, ETH3D, Tanks and Temples, and ScanNet (see Dai et al., “ScanNet: Richly-annotated 3d reconstructions of indoor scenes”, in CVPR, 2017) datasets. The Absolute Relative Error (rel) and Inlier Ratio (τ) with a threshold of 1.03 on each test set and the averages across all test sets are reported. Note that the ground-truth camera parameters and poses nor the ground-truth depth ranges are not leveraged, the predictions herein are only valid up to a scale factor. In order to perform quantitative measurements, predictions are normalized using the medians of the predicted depths and the ground truth ones, as advocated by Schroppel et al.

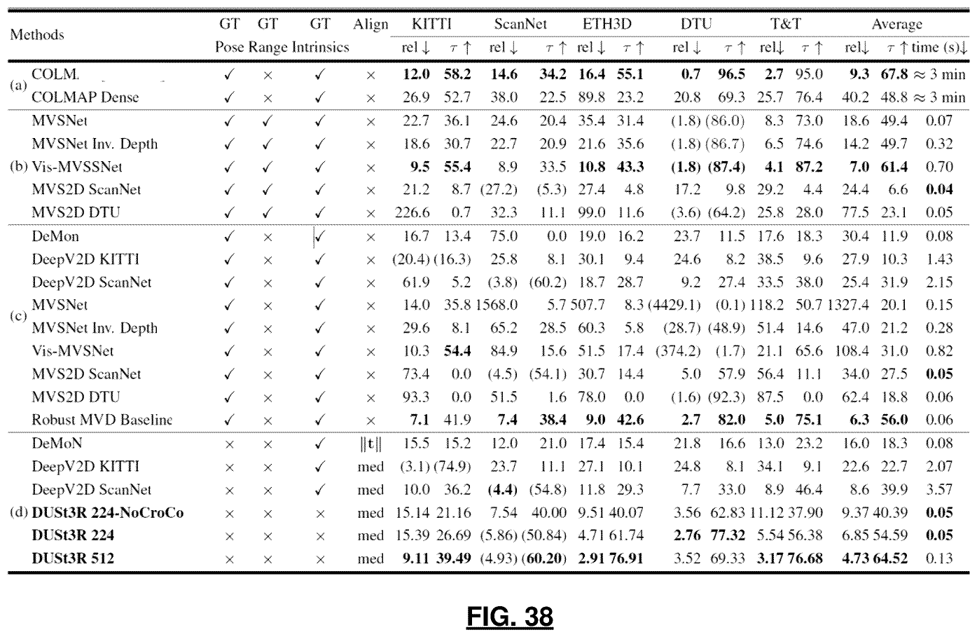

Results. In the table in FIG. 38, it can be observed that DUSt3R achieves high accuracy on ETH-3D and outperforms other methods overall, even those using groundtruth camera poses. Timewise, the disclosed approach is also much faster than the traditional COLMAP pipeline. This showcases the applicability of the disclosed systems and methods on a large variety of domains, either indoors, outdoors, small scale or large scale scenes, while not having been trained on the test domains, except for the ScanNet test set, since the train split is part of the Habitat dataset.

### Section B.4.5 3D Reconstruction

Finally, the quality of the disclosed full reconstructions obtained after the global alignment procedure described in Section B.3.4 is measured. Again it is emphasized that the disclosed systems and methods method are the first one to enable global unconstrained MVS, in the sense that there is no prior knowledge regarding the camera intrinsic and extrinsic parameters. In order to quantify the quality of the disclosed reconstructions, the predictions are aligned to the ground-truth coordinate system. This is done by fixing the parameters as constants in Section B.3.4. This leads to consistent 3D reconstructions expressed in the coordinate system of the ground-truth.

Datasets and metrics. The disclosed predictions are evaluated on the DTU dataset. The disclosed network is applied in a zero-shot setting, i.e., the disclosed model as is applied without performing any finetuning on the DTU training set. The table in FIG. 36 shows averaged accuracy, averaged completeness and overall averaged error metrics reported as provided by the authors of the benchmarks. The accuracy for a point of the reconstructed shape is defined as the smallest Euclidean distance to the ground-truth, and the completeness of a point of the ground-truth as the smallest Euclidean distance to the reconstructed shape. The overall is the mean of both previous metrics.

Results. Other methods all leverage GT (Ground Truth) poses and train specifically on the DTU training set whenever applicable. Furthermore, results on this task are usually obtained via sub-pixel accurate triangulation, requiring the use of explicit camera parameters, whereas the disclosed systems and methods use regression. Yet, without prior knowledge about the cameras, an average accuracy of 2.7 mm is reached, with a completeness of 0.8 mm, for an overall average distance of 1.7 mm. This level of accuracy is of great use in practice, considering the plug-and-play nature of the disclosed systems and methods.

### Section B.4.6 Ablations

The impact of the CroCo pretraining and image resolution on DUSt3R's performance was ablated. Results are set forth in the tables in FIGS. 33, 34, 35 and 38 for the tasks mentioned above. Overall, the observed consistent improvements suggest the crucial role of pretraining and high resolution in modern data-driven approaches.

### Section B.5 Conclusion

A novel paradigm has been presented to solve not only 3D reconstruction in-the-wild without prior information about scene nor cameras, but a whole variety of 3D vision tasks as well.

### Section B.6 Results and Extensions

This Section provides additional details and qualitative results of DUSt3R. First, Section B.6.1 presents qualitative pairwise predictions of the presented architecture on challenging real-life datasets. Extended related works are set forth in Section B.6.2, encompassing a wider range of methodological families and geometric vision tasks. Section B.6.3 provides auxiliary ablative results on multi-view pose estimation, that are not set out in Section B.4. Then results are reported in Section B.6.4 on an experimental visual localization task, where the camera intrinsics are unknown. Finally, training and data augmentation procedures are detailed in Section B.6.5.

### Section B.6.1 Qualitative Results

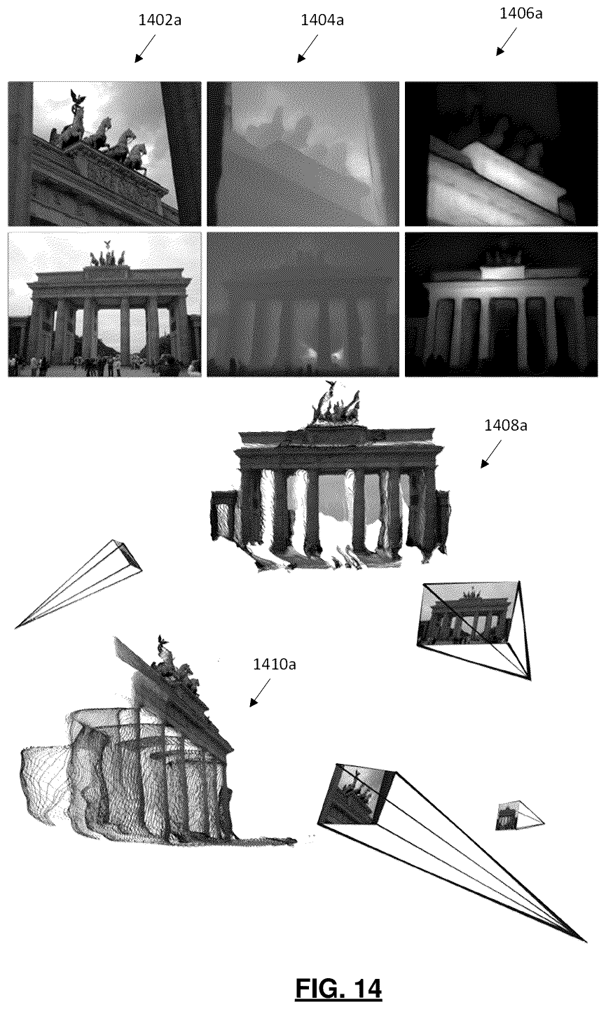

Point-cloud visualizations. Some visualization of DUSt3R's pairwise results are presented in FIGS. 14 to 18. FIGS. 14 and 15 are examples of 3D reconstruction of an unseen MegaDepth scene from two images 1402; this is the raw output of the DUSt3R network (i.e., the output depthmaps 1404 and confidence maps 1406, as well as two different viewpoints on the pointclouds 1408 and 1410). The scenes in FIGS. 16 and 17 show raw output of the DUSt3R network (i.e., new viewpoints on the pointclouds, where camera parameters may be recovered from the raw pointmaps) from five scenes in FIG. 16 (i.e., Kings College (top-left), Old Hospital (top-middle), St Mary's Church (top-right), Shop Façade (bottom-left), Great Court (bottom-right) and seven scenes in FIG. 17 (i.e., Chess (top-left), Fire (top-middle-left), Heads (top-middle-right), Office (top-right), Pumpkin (bottom-left), Kitchen (bottom-middle, Stairs (bottom-right)).

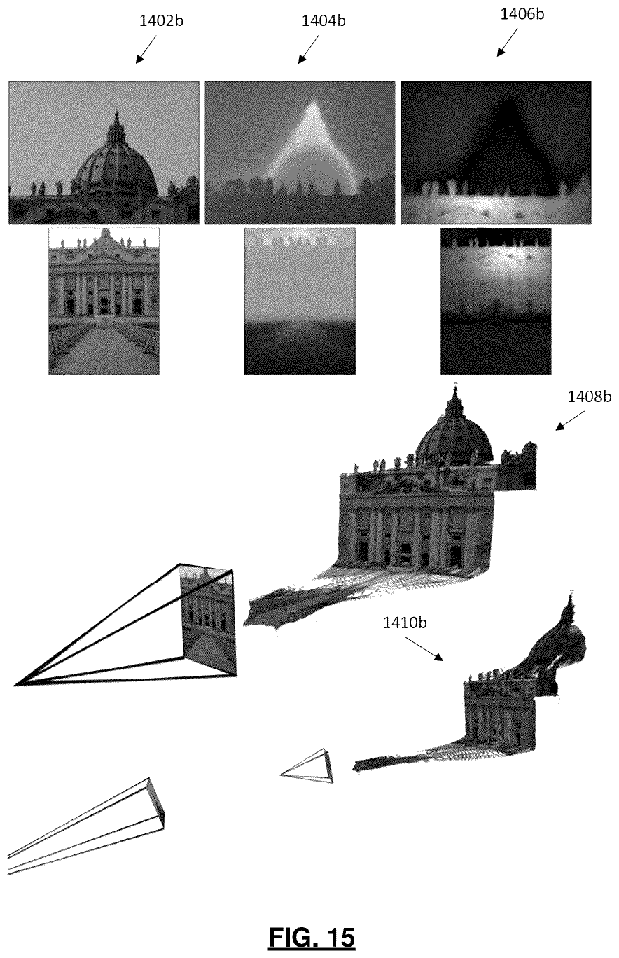

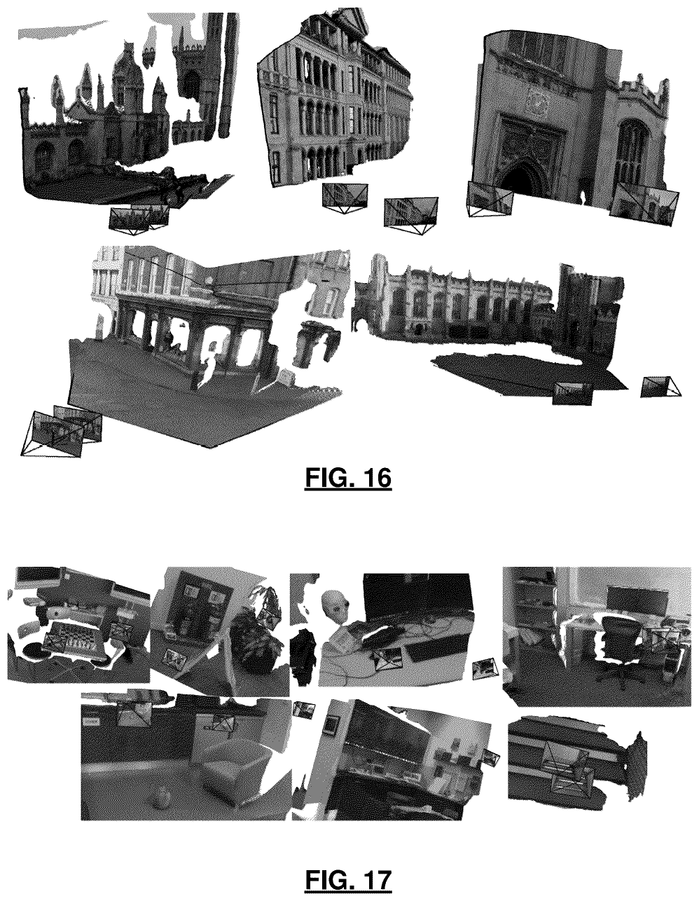

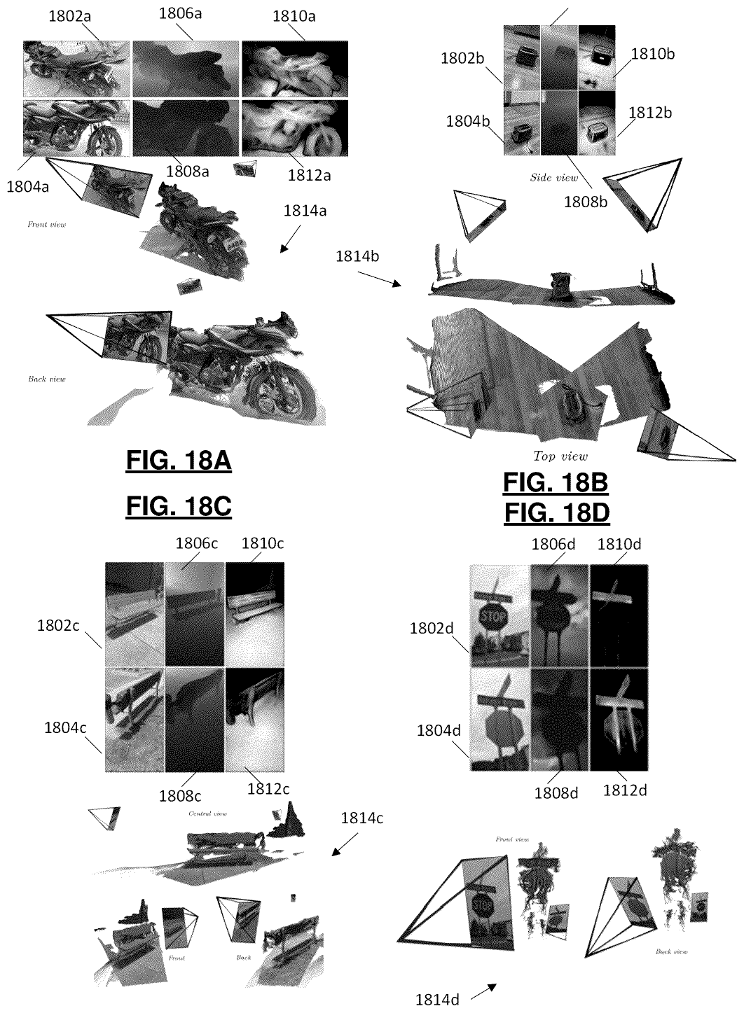

FIGS. 18A, 18B, 18C and 18D show examples of 3D reconstructions from nearly opposite viewpoints for each of 4 cases (respectively, a motorcycle, a toaster, a bench, and a stop sign); in each of the Figures are shown: two input images 1802 and 1804, corresponding depthmaps 1806 and 1808 output by the DUSt3R network, corresponding confidence maps 1810 and 1812 output by the DUSt3R network, and different views on the colored point-clouds 1814. As with other examples, camera parameters may be recovered from raw pointmaps. Further, these examples show that the DUSt3R network handles drastic viewpoint changes without apparent issues, even when there is almost no overlapping visual content between images (e.g., for the stop sign and motorcycle, which example cases are randomly chosen from the set of unseen sequences).

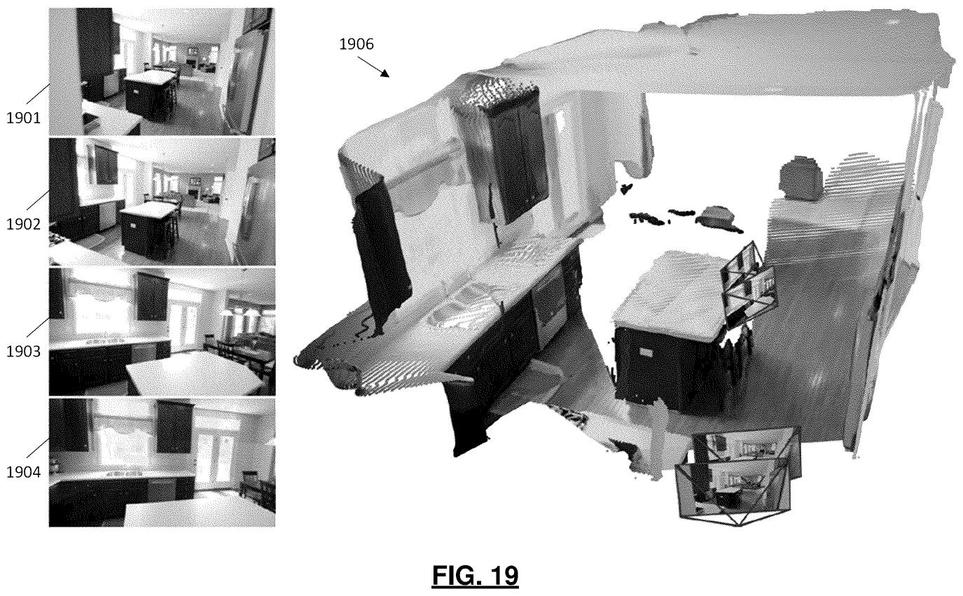

Note the scenes in FIGS. 14 to 18 were never seen during training and were not cherry-picked. Also, these results were not post-processed, except for filtering out low-confidence points (based on the output confidence) and removing sky regions for the sake of visualization (i.e., these figures accurately represent the raw output of DUSt3R). Overall, the proposed systems and methods are able to perform highly accurate 3D reconstruction from just two images. FIG. 19 is a reconstruction example from four random frames 1901 to 1904 of an indoor sequence, In FIG. 19, the output 1906 of the DUSt3R network is shown after the global alignment stage (i.e., the resulting point-cloud and the recovered camera intrinsics and poses). In this case, the DUSt3R network has processed all pairs of the 4 input images, and outputs 4 spatially consistent pointmaps along with the corresponding camera parameters. Note that, for the case of image sequences captured with the same camera, the fact that camera intrinsics must be identical for every frame (i.e., all intrinsic parameters are optimized independently) is never enforced. This remains true for all results reported in Section B.6 and in Section B.4 (e.g., on multi-view pose estimation with the CO3Dv2 and RealEstate10K datasets).

### Section B.6.2 Additional Related Works

Section B.2 covered some other works. Because this work covers a large variety of geometric tasks, Section B.2 is completed in this Section with additional topics.

Implicit Camera Models. The disclosed systems and methods may not explicitly output camera parameters. Likewise, there are works aiming to express 3D shapes in a canonical space that is not directly related to the input viewpoint. Shapes can be stored as occupancy in regular grids, octree structures, collections of parametric surface elements, point clouds encoders, free-form deformation of template meshes or per-view depthmaps. While these approaches arguably perform classification and not actual 3D reconstruction, all-in-all, they work only in very constrained setups, usually on ShapeNet (see Chang et al., “ShapeNet: An Information-Rich 3D Model Repository”, in arXiv: 1512.03012, 2015) and have trouble generalizing to natural scenes with non object-centric views. The question of how to express a complex scene with several object instances in a single canonical frame had yet to be answered: in this disclosure, the reconstruction is expressed in a canonical reference frame, but due to the disclosed scene representation (pointmaps), a relationship is preserved between image pixels and the 3D space, and thus 3D reconstruction may be performed consistently.

Dense Visual SLAM. In visual SLAM, 3D reconstruction and ego-motion estimation may use active depth sensors. Dense visual SLAM from RGB video stream may be able to produce high-quality depth maps and camera trajectories, but they inherit the traditional limitations of SLAM, e.g., noisy predictions, drifts and outliers in the pixel correspondences. To make the 3D reconstruction more robust, R3D3 (see Schmied et al., “R3D3: Dense 3D Reconstruction of Dynamic Scenes from Multiple Cameras”, in arXiv: 2308.14713, 2023) jointly leverages multi-camera constraints and monocular depth cues. Most recently, GO-SLAM (see Zhang et al., “GO-SLAM: Global optimization for consistent 3d instant reconstruction”, in ICCV, pp. 3727-3737 October 2023) proposed real-time global pose optimization by considering the complete history of input frames and continuously aligning all poses that enables instantaneous loop closures and correction of global structure. Still, all SLAM methods assume that the input consists of a sequence of closely related images, e.g., with identical intrinsics, nearby camera poses and small illumination variations. In comparison, the disclosed systems and methods handle completely unconstrained image collections.

3D reconstruction from implicit models has undergone advancements, such as by the integration of neural networks. Multi-Layer Perceptrons (MLP) may be used to generate continuous surface outputs with only posed RGB images. Others involve density-based volume rendering to represent scenes as continuous 5D functions for both occupancy and color, showing ability in synthesizing novel views of complex scenes. To handle large-scale scenes, geometry priors to the implicit model may be used, leading to much more detailed reconstructions. In contrast to the implicit 3D reconstruction, this disclosure focuses on the explicit 3D reconstruction and showcases that DUSt3R can not only have detailed 3D reconstruction but also provide rich geometry for multiple downstream 3D tasks.

RGB-pairs-to-3D takes its roots in two-view geometry and may be considered as a stand-alone task or an intermediate step towards the multi-view reconstruction. This process may involve estimating a dense depth map and determining the relative camera pose from two different views. This problem may be formulated either as pose and monocular depth regression or pose and stereo matching. A goal is to achieve 3D reconstruction from the predicted geometry. In addition to reconstruction tasks, learning from two views also gives an advance in unsupervised pretraining; CroCo introduces a pretext task of cross-view completion from a large set of image pair to learn 3D geometry from unlabeled data and to apply this learned implicit representation to various downstream 3D vision tasks. Instead of focusing on model pretraining, the systems and methods herein leverage this pipeline to directly generate 3D pointmaps from the image pair. In this context, the depth map and camera poses are only by-products in the disclosed pipeline.

### Section B.6.3 Multi-View Pose Estimation

Additional results are included for the multi-view pose estimation task from Section B.4.2. Namely, the pose accuracy is computed for a smaller number of input images (they are randomly selected from the entire test sequences). The table in FIG. 37 reports performance of the disclosed methods and compares with the other methods. Numbers for other methods are acquired from PoseDiffusion publication's tables and plots, hence some numbers are only approximate. The disclosed systems and methods consistently outperform other methods on the CO3Dv2 dataset by a large margin, even for small number of frames. As can be observed in FIG. 18, DUSt3R handles opposite viewpoints (i.e., nearly 180° apart) seemingly without much trouble. In the end, DUSt3R obtains relatively stable performance, regardless of the number of input views. When comparing with PoseDiffusion on RealEstate10K, performances are reported with and without training on the same dataset. Note that DUSt3R's training data includes a small subset of CO3Dv2 (50 sequences for each category are used, i.e., less than 7% of the full training set) but no data from RealEstate10K whatsoever.

An example of reconstruction on RealEstate10K is shown in FIG. 19. The disclosed systems and methods generate a consistent pointcloud despite wide baseline viewpoint changes between the first and last pairs of frames.

### Section B.6.4 Visual Localization

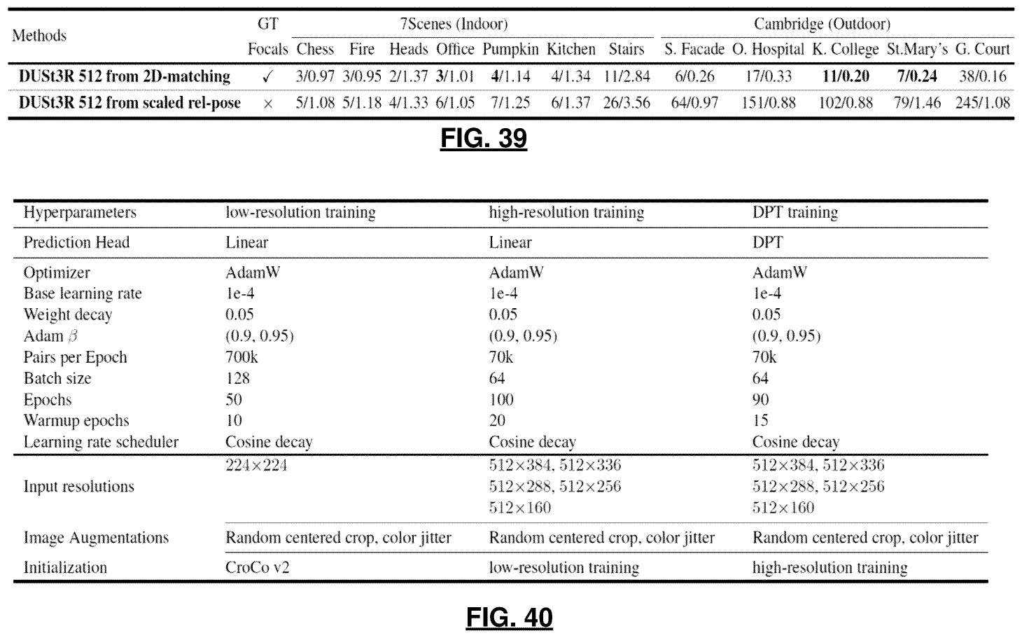

Additional results of visual localization on the 7-scenes and Cambridge-Landmarks datasets are included herein. Namely, experiments with a scenario where the focal parameter of the querying camera is unknown were performed. In this case, the query image and a database image are input into DUSt3R, and an un-scaled 3D reconstruction is output. The resulting pointmap is then scaled according to the ground-truth pointmap of the database image, and extract the pose as described in Section B.3.3. The table in FIG. 39 shows that this method performs reasonably well on the 7-scenes dataset, where the median translation error is on the order of a few centimeters. On the Cambridge-Landmarks dataset, however, considerably larger errors are obtained. After inspection, it is found that the ground-truth database pointmaps are sparse, which prevents any reliable scaling of the disclosed reconstruction. On the contrary, 7-scenes provides dense ground-truth pointmaps. Further work believed to be necessary for “in-the-wild” visual-localization with unknown intrinsics.

### Section B.6.5 Training

### Section B.6.5.1 Training Data

Ground-truth pointmaps. Ground-truth pointmaps X̅^{1,1} and X̅^{2,1} for images I¹ and I², respectively, from Equation B2 in Section B.3.2 are obtained from the ground-truth camera intrinsics K₁, K₂ ∈R^{3×3}, camera poses P₁, P₂ ∈R^{3×4} and depthmaps D₁, D₂ ∈R^{W×H}. Specifically, both pointmaps are projected in the reference frame of P1:

$${\overline{X}}^{1 , 1} = {K}_{1}^{- 1} ( [ U ; V ; 1 ] \cdot {D}_{1} ) \qquad ( B7 )$$

$${\overline{X}}^{2 , 1} = {P}_{1} {P}_{2}^{- 1} h ( {\overline{X}}^{2 , 2} ) = {P}_{1} {P}_{2}^{- 1} {h 〚 ( K 〛}_{2}^{- 1} ( [ U ; V ; 1 ] \cdot {D}_{2} ) ) \qquad ( B8 )$$

where X·Y denotes element-wise multiplication, U, V∈R^{W×H} are the x, y pixel coordinate grids and h is the mapping to homogeneous coordinates, see Equation B1 in Section B.3.

Relation between depthmaps and pointmaps. As a result, the depth value D_{i,j}¹ at pixel (i, j) in image I¹ can be recovered as

$${D}_{i , j}^{1} = {\overline{X}}_{i , j , 2}^{1 , 1} . \qquad ( B9 )$$

Therefore, depthmaps set forth in Section B are extracted from DUSt3R's output as X_{:,:,2}^{1,1} and X_{:,:,2}^{2,2} for images I¹ and I², respectively.

Dataset mixture. DUSt3R may be trained with a mixture of eight datasets: Habitat, ARKitScenes, MegaDepth, Static Scenes 3D, Blended MVS, ScanNet++, CO3Dv2 and Waymo. These datasets feature diverse scene types: indoor, outdoor, synthetic, real-world, object-centric, etc. Table B-1 shows the number of extracted pairs in each dataset (i.e., the dataset mixture and sample sizes for DUSt3R training), which amounts to 8.5 M in total.

TABLE B-1

| Datasets | Type | N Pairs |
|---|---|---|
| Habitat | Indoor/Synthetic | 1000k |
| CO3Dv2 | Object-centric | 941k |
| ScanNet++ | Indoor/Real | 224k |
| ArkitScenes | Indoor/Real | 2040k |
| Static Thing 3D | Object/Synthetic | 337k |
| MegaDepth | Outdoor/Real | 1761k |
| BlendedMVS | Outdoor/Synthetic | 1062k |
| Waymo | Outdoor/Real | 1100k |

Data augmentation. Data augmentation techniques may be used for the training, such as random color jittering and random center crops, the latter being a form of focal augmentation. Indeed, some datasets are captured using a single or a small number of camera devices, hence many images have practically the same intrinsic parameters. Centered random cropping thus helps in generating more focal lengths. Crops may also be centered so that the principal point is centered in the training pairs. At test time, little impact is observed on the results when the principal point is not exactly centered. During training, each training pair (I¹, I²) as well as its inversion (I², I¹) are systematically fed to help generalization. Naturally, tokens from these two pairs do not interact.

### Section B.6.5.2 Training Hyperparameters

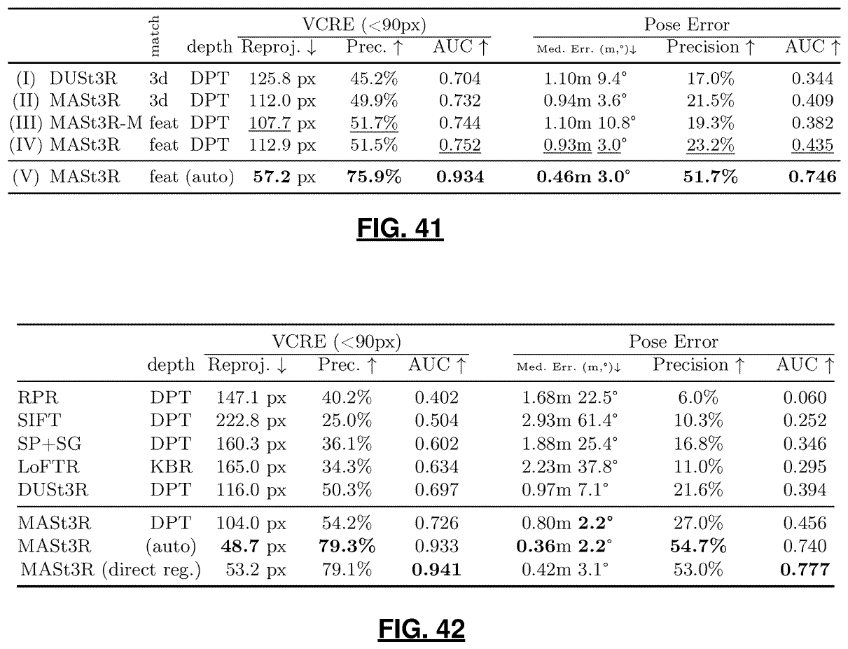

The detailed hyperparameter settings used for training DUSt3R is reported in the table in FIG. 40.

### Section C. MASt3R: Matching and Stereo 3D Reconstruction

Image matching is a component of algorithms and pipelines in 3D vision. Yet despite matching being a 3D problem, intrinsically linked to camera pose and scene geometry, it may be treated as a 2D problem. This makes sense as the goal of matching is to establish correspondences between 2D pixel fields.

This disclosure takes a different stance and propose to cast matching as a 3D task. This Section discloses another example of the DUSt3R architecture referred to as the MASt3R architecture. Based on pointmap regression, the DUSt3R architecture displays impressive robustness in matching views with extreme viewpoint changes, yet with limited accuracy. The MASt3R architecture aims to improve the matching capabilities of such an approach while preserving its robustness. More specifically, the MASt3R architecture augments the DUSt3R network with a new head that outputs dense local features (local descriptors), trained with an additional matching loss. Further, the MASt3R architecture address the issue of quadratic complexity of dense matching, which may become prohibitively slow for downstream applications if not treated carefully. In addition, the MASt3R architecture uses a fast reciprocal matching scheme that not only accelerates matching by orders of magnitude, but also comes with theoretical guarantees and, lastly, yields improved results. Extensive experiments show that the MASt3R architecture outperforms others on multiple matching tasks. In particular, it outperforms other methods by 30% (absolute improvement) in Virtual Correspondence Reprojection Error (VCRE) area under the curve (AUC) on the extremely challenging Map-free localization dataset.

### Section C.1 Introduction

Being able to establish correspondences between pixels across different images of the same scene, denoted as image matching, is a component of all 3D vision applications, spanning mapping, localization, navigation, photogrammetry and autonomous robotics/navigation, and others. Other methods for visual localization, for instance, overwhelmingly rely upon image matching during the offline mapping stage, e.g., using COLMAP, as well as during the online localization step, typically using PnP. This example focuses on this core task and aims at producing, given two images, a list of pairwise correspondences, denoted as matches. In particular, this example seeks to output highly accurate and dense matches that are robust to viewpoint and illumination changes because these are, in the end, the limiting factor for real-world applications.

Matching methods may be cast into a three-step pipeline including first extracting sparse and repeatable keypoints, then describing them with locally invariant features, and finally pairing the discrete set of keypoints by comparing their distance in the feature space. This pipeline has merits: keypoint detectors are precise under low-to-moderate illumination and viewpoint changes, and the sparsity of keypoints makes the problem computationally tractable, enabling very precise matching whenever the images are viewed under similar conditions. This explains the success and persistence of methods like SIFT (see David G. Lowe, “Distinctive image features from scale-invariant keypoints”, in IJCV, 2004) in 3D reconstruction pipelines like COLMAP.

Unfortunately, keypoint-based methods, by reducing matching to a bag-of-keypoint problem, discard the global geometric context of the correspondence task. This makes them especially prone to errors in situation with repetitive patterns or low-texture areas, which are in fact ill-posed for local descriptors. One way to remedy this is to introduce a global optimization strategy during the pairing step, typically leveraging some learned priors about matching. However, leveraging global context during matching might be too late, if keypoints and their descriptors do not already encode enough information. For this reason, another direction is to consider dense holistic matching, i.e., avoiding keypoints altogether, and matching the entire image at once. Images as a whole may be considered and the resulting set of correspondences is dense and more robust to repetitive patterns and low-texture areas. This provides positive results on benchmarks, such as the Map-free localization benchmark (see Arnold et al., “Map-Free Visual Relocalization: Metric Pose Relative to a Single Image”, in ECCV, 2022).

Nevertheless, some methods score a relatively disappointing VCRE precision of 34% on the Map-free localization benchmark. This may be because of treating matching as a 2D problem in image space. The formulation of the matching task may intrinsically and fundamentally be a 3D problem: pixels that correspond are pixels that observe the same 3D point. Indeed, 2D pixel correspondences and a relative camera pose in 3D space are two sides of the same coin, as they are directly related by the epipolar matrix. While DUSt3R may perform 3D reconstruction rather than matching, and for which matches are only a by-product of the 3D reconstruction, and that correspondences obtained naively from this 3D output currently outperform other keypoint- and matching-based methods on the Map-free benchmark provides additional evidence this reasoning is correct.

While the DUSt3R architecture may be used for matching, it may be extremely robust to viewpoint changes. To remedy this limitation, the MASt3R architecture attaches a second head that regresses dense local feature maps, that is trained with an InfoNCE loss (see Oord et al., “Representation Learning with Contrastive Predictive Coding” arxiv.org/abs/1807.03748, 2018, which is incorporated herein in its entirety). A coarse-to-fine matching scheme during which matching may be performed at several scales to obtain pixel-accurate matches. Each matching step involves extracting reciprocal matches from dense feature maps which, may be more time consuming than computing the dense feature maps themselves. The solution set forth in this Section is an algorithm for finding reciprocal matches that is almost two orders of magnitude faster while improving pose estimation quality.

To summarize, this Section C sets forth in detail the MASt3R architecture, a 3D-aware matching approach building on the DUSt3R architecture, that outputs local feature maps, which advantageously enable accurate and robust matching, and which advantageously outperforms other methods on several absolute and relative pose localization benchmarks. In addition, this Section sets forth a coarse-to-fine matching scheme associated with a fast-matching algorithm that may be used with high-resolution images.

### Section C.2

Keypoint-based matching has been an important feature of computer vision. Matching is carried out in three stages: keypoint detection, locally invariant description, and nearest-neighbor search in descriptor space. Departing from the former handcrafted methods like SIFT (see Lowe 2004), learning-based data-driven schemes for detecting keypoints and describing them or both at the same time may be used. Keypoint-based approaches may be used, underscoring their enduring value in tasks requiring high precision and speed. One notable issue, however, may be that they reduce matching to a local problem, discarding its holistic nature. Global reasoning may be used in the last pairing step leveraging stronger priors to guide matching, yet leaving the detection and description local. While successful, it is still limited by the local nature of keypoints and their inability to remain invariant to strong viewpoint changes.

Dense matching. In contrast to keypoint-based approaches, semi-dense and dense approaches offer a different paradigm for establishing image correspondences, considering all possible pixel associations. Used may be coarse-to-fine schemes to decrease computational complexity. Matching may be considered from a global perspective, at the cost of increased computational resources. Dense matching may be effective where detailed spatial relationships and textures are helpful for understanding scene geometry, leading to high performance on benchmarks that are especially challenging for keypoints, such as due to extreme changes in viewpoint or illumination. Matching may be cast as a 2D problem, which limits usage for visual localization.

Camera Pose estimation techniques vary, but may be based on pixel matching. Camera pose estimation benchmarks include Aachen Day-Night (see Zhang et al., “Reference Pose Generation for Long-Term Visual Localization via Learned Features and View Synthesis”, in IJCV, 2021), InLoc (see Taira et al., “InLoc: Indoor Visual Localization with Dense Matching and View Synthesis”, in PAMI, 2019), CO3D (an earlier version of CO3Dv2) or Map-free, all featuring strong viewpoint and/or illumination changes. Another benchmark is Map-free (see Arnold et al.), a localization dataset for which a single reference image is provided but no map, with viewpoint changes up to 180°.

Grounding matching in 3D thus becomes important in challenging conditions where classical 2D-based matching utterly falls short. Leveraging priors about the physical properties of the scene in order to improve accuracy or robustness has been widely explored in the past, but most previous works settle for leveraging epipolar constraints for semi-supervised learning of correspondences without any fundamental change. Toft et al. (“Single-Image Depth Prediction Makes Feature Matching Easier”, in ECCV, 2020) proposes to improve keypoint descriptors by rectifying images with perspective transformations obtained from a known monocular depth predictor. Diffusion for pose or rays, although not matching approaches strictly speaking, show promising performance by incorporating 3D geometric constraints into their pose estimation formulation.

### Section C.3 The MASt3R Architecture

Given two images I¹ and I², respectively captured by two cameras C¹ and C² with unknown parameters, a set of pixel correspondences {(i, j)} are recovered where i, j are pixels i=(uᵢ, vᵢ),j=(uⱼ, vⱼ)∈{1, . . . , W}×{1, . . . , H}, with W, H being the respective width and height of the images. It is assumed for the purpose of explanation that the images have the same resolution for the sake of simplicity, yet without loss of generality, namely that the MASt3R network may handle image pairs of variable aspect ratios.

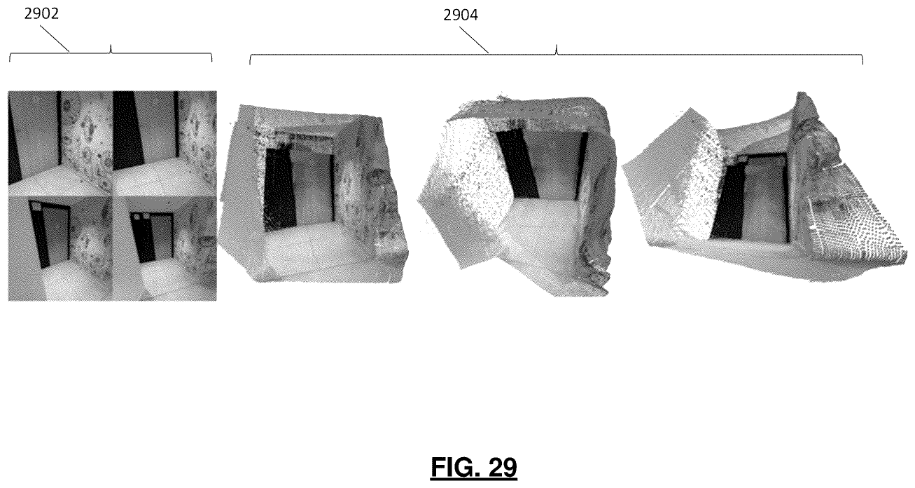

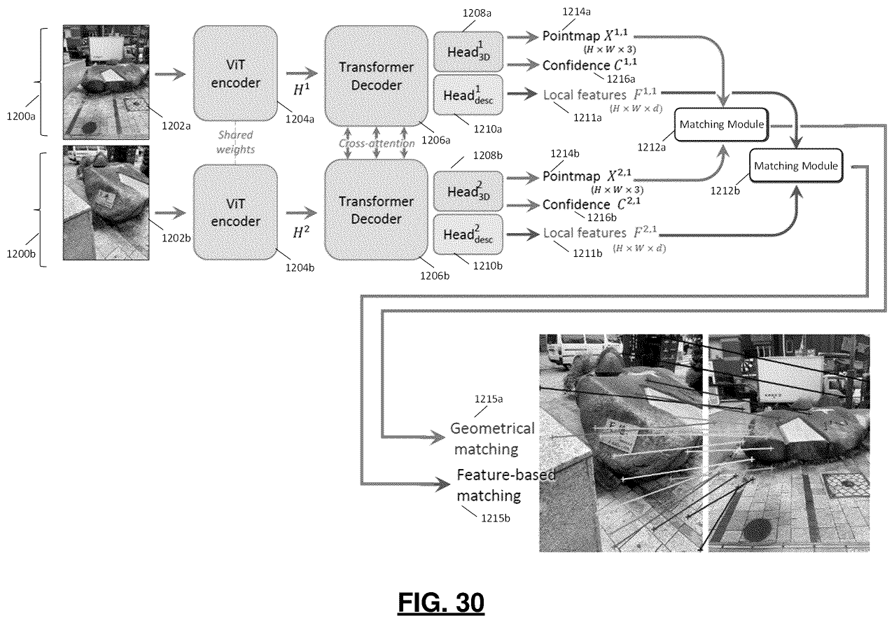

An example embodiment of the MASt3R architecture, illustrated in FIG. 30, aims at jointly performing 3D scene reconstruction and matching given two input images. It is based on the DUSt3R architecture, which is discussed in detail Sections A.3 and B, is summarized in Section C.3.1 before presenting the matching head and its corresponding loss of the MASt3R architecture in Section C.3.2, as well as, an optimized matching scheme for dense feature maps, in Section C.3.3, that is used for coarse-to-fine matching in Section C.3.4.

### Section C.3.1 the DUSt3R Framework

The DUSt3R architecture, which is discussed in detail Sections A.3 and B, jointly solves the calibration and 3D reconstruction problems from images alone. A transformer-based network predicts a local 3D reconstruction given two input images, in the form of two dense 3D point-clouds X^{1,1} and X^{2,1}, denoted as pointmaps, where a pointmap X^{a,b} ∈ [symbol] ^{H×W×3} represents a dense 2D-to-3D mapping between each pixel i=(u, v) of the image I^{a} and its corresponding 3D point X_{u,v}^{a,b}∈ [symbol] ³ expressed in the coordinate system of camera C^{b}. By regressing two pointmaps X^{1,1}, X^{2,1} expressed in the same coordinate system of camera C¹, the DUSt3R architecture effectively solves the joint calibration and 3D reconstruction problem. In the case where more than two images are provided, a second step of global alignment merges all pointmaps in the same coordinate system. Note that, in this Section, this step is not used given the example discussed herein is limited to the binocular case. Inference for the binocular case is now explained in greater detail with reference to FIG. 30.

Both images 1202 are first encoded in a Siamese manner with a ViT encoder 1204 (see Dosovitskiy et al.), yielding two representations H¹ and H²:

$${H}^{1} = Encoder ( {I}^{1} ) . \qquad ( C1 )$$

$${H}^{2} = Encoder ( {I}^{2} ) . \qquad ( C2 )$$

Then, two intertwined decoders 1206 process these representations jointly, exchanging information via cross-attention to ‘understand’ the spatial relationship between viewpoints and the global 3D geometry of the scene. The new representations augmented with this spatial information are denoted as H′¹ and H′²:

$${H}^{′1} , {H}^{′2} = Decoder ( {H}^{1} , {H}^{2} ) . \qquad ( C3 )$$

Finally, two prediction heads 1208 regress the final pointmaps X and confidence maps C from the concatenated representations output by the encoder and decoder:

$${X}^{1 , 1} , {C}^{1} = {Head}_{3 D}^{1} ( [ {H}^{1} , {H}^{′1} ] ) , \qquad ( C4 )$$

$${X}^{2 , 1} , {C}^{2} = {Head}_{3 D}^{2} ( [ {H}^{2} , {H}^{′2} ] ) , \qquad ( 5 )$$

Regression loss. The DUSt3R network is trained in a fully-supervised manner using a regression loss:

$${ℓ}_{regr} ( v , i ) = ‖ \frac{1}{z} {X}_{i}^{v , 1} - \frac{1}{\hat{z}} {\hat{X}}_{i}^{v , 1} ‖ , \qquad ( C6 )$$

where v∈{1,2} is the view and i is a pixel for which the ground-truth 3D point \hat{X}^{v,1}∈ [symbol] ³ is defined. In one formulation, normalizing factors z, \hat{z} may be introduced to make the reconstruction invariant to scale. These are simply defined as the mean distance of all valid 3D points to the origin.

Scale-dependent predictions. Alternative to scale-invariant predictions, as some potential use-cases like map-free visual localization involve scale-dependent (e.g., metric-scale) predictions. In this alternate example, the regression loss may be modified to ignore normalization for the predicted pointmaps when the ground-truth pointmaps are scale-dependent.

That is, in the case of scale dependence z and \hat{z} are set such that z: =2 whenever ground-truth is scale-dependent (e.g., metric-scale), so that:

$${ℓ}_{regr} ( v , i ) = \frac{‖ {X}_{i}^{v , 1} - {\hat{X}}_{i}^{v , 1} ‖}{\hat{z}} . \qquad ( C7 )$$

As in Section B.3.2 discussing the DUSt3R architecture, the final confidence-aware regression loss [symbol] _{conf} is defined as:

$${ℒ}_{cont} = {\sum }_{v ∈ \{ 1 , 2 \}} {\sum }_{i ∈ {D}^{v}} {C}_{i}^{v , 1} {ℓ}_{regr} ( v , i ) - α log {C}_{i}^{v , 1} . \qquad ( C8 )$$

### Section C.3.2 Matching Prediction Head and Loss

To obtain reliable pixel correspondences from pointmaps, a solution is to look for reciprocal matches in some invariant feature space (see Wu, Sankaranarayanan, and Chellappa, “In Situ Evaluation of Tracking Algorithms Using Time Reversed Chains”, in CVPR 2007). While such a scheme works well with the DUSt3R architecture's regressed pointmaps (i.e., in a 3-dimensional space) even in presence of extreme viewpoint changes, the resulting correspondences are imprecise, yielding suboptimal accuracy. This may be a natural result (i) as regression is inherently affected by noise, and (ii) because the DUSt3R architecture was never explicitly trained for matching.

Matching head. For these reasons, a second descriptor head 1210 is added that outputs two dense feature maps D₁ and D₂ ∈ [symbol] ^{H×W×d} of dimensional d:

$${D}^{1} = {Head}_{desc}^{1} ( [ {H}^{1} , {H}^{′1} ] ) , \qquad ( C9 )$$

$${D}^{2} = {Head}_{desc}^{2} ( [ {H}^{2} , {H}^{′2} ] ) , \qquad ( C10 )$$

In one embodiment, the descriptor head 1210 is a 2-layer MLP interleaved with a non-linear Gaussian Error Linear Unit (GELU) activation function (see Hendrycks et al., “Bridging Nonlinearities and Stochastic Regularizers with Gaussian Error Linear Units”, in arXiv, 1606.08415, 2016, which is incorporated herein in its entirety), and each local feature is normalized to unit norm.

Matching objective. A matching objective is to encourage each local descriptor from one image to match with at most a single descriptor from the other image that represents the same 3D point in the scene. To this aim, the InfoNCE loss (see Oord et al.) is leveraged over the set of ground-truth correspondences [symbol] ={(i, j)|\hat{X}ᵢ^{1,1}=\hat{X}ⱼ^{2,1}} to define the matching loss [symbol] _{match} as:

$${ℒ}_{match} = - {\sum }_{( i , j ) ∈ \hat{ℳ}} log \frac{{s}_{τ} ( i , j )}{{\sum }_{k ∈ {𝒫}^{1}} {s}_{τ} ( k , j )} + log \frac{{s}_{τ} ( i , j )}{{\sum }_{k ∈ {𝒫}^{2}} {s}_{τ} ( i , k )} , \qquad ( C11 )$$

$$with$$

$${s}_{τ} ( i , j ) = exp [ - τ {D}_{i}^{1 ⊤} {D}_{j}^{2} ] . \qquad ( C12 )$$

Here, [symbol] ¹={i|(i,j)∈ [symbol] } and [symbol] ²={j|(i, j)∈ [symbol] } denote the subset of considered pixels in each image and τ is a temperature hyper-parameter. Note that this matching objective may essentially be a cross-entropy classification loss: contrary to regression in Equation C6, the network is only rewarded if it gets the correct pixel right, not a nearby pixel. This strongly encourages the network to achieve high-precision matching. Finally, both regression loss [symbol] _{conf} and matching loss [symbol] _{match} are combined to get the final training objective:

$${ℒ}_{total} = {ℒ}_{conf} + {βℒ}_{match} \qquad ( C13 )$$

where β is a hyperparameter to balance the two losses.

### Section C.3.3 Fast Reciprocal Matching

Given two predicted feature maps D¹, D² ∈ [symbol] ^{H×W×d}, (or pointmaps or combinations thereof) a set of reliable pixel correspondences are extracted by matching modules 1212 to perform tasks 1215 such as geometrical matching 1215a and feature-based matching 1215b, i.e., mutual nearest neighbors of each other's:

$$ℳ = \{ ( i , j ) \vert j = {NN}_{2} ( {D}_{i}^{1} ) and i = {NN}_{1} ( {D}_{j}^{2} ) \} , \qquad ( C14 )$$

$$with$$

$${NN}_{A} ( {D}_{j}^{B} ) = arg {min}_{i} ‖ {D}_{i}^{A} - {D}_{j}^{B} ‖ . \qquad ( C15 )$$

Naive implementation of reciprocal matching has a high computational complexity of O(W²H²), since every pixel from an image must be compared to every pixel in the other image. While optimizing the nearest-neighbor (NN) search is possible (e.g., using K-D Trees), this kind of optimization may become inefficient in high dimensional feature space and, in all cases, orders of magnitude slower than the inference time of the MASt3R architecture to output D¹ and D².

Fast matching. In one embodiment, a fast matching approach based on subsampling may be performed by matching modules 1212. This embodiment is based on an iterated process that starts from an initial sparse set of k pixels U⁰={Uₙ⁰}ₙ₌₁^{k} typically sampled regularly on a grid in the first image I¹. Each pixel is then mapped to its NN on the second I², yielding V¹, and the resulting pixels are mapped back again to the first I¹ in the same way:

$${U}^{t} ↦ {[ {NN}_{2} ( {D}_{u}^{1} ) ]}_{u ∈ {U}^{t}} ≡ {V}^{t} ↦ {[ {NN}_{1} ( {D}_{v}^{2} ) ]}_{v ∈ {V}^{t}} ≡ {U}^{t + 1} \qquad ( C16 )$$

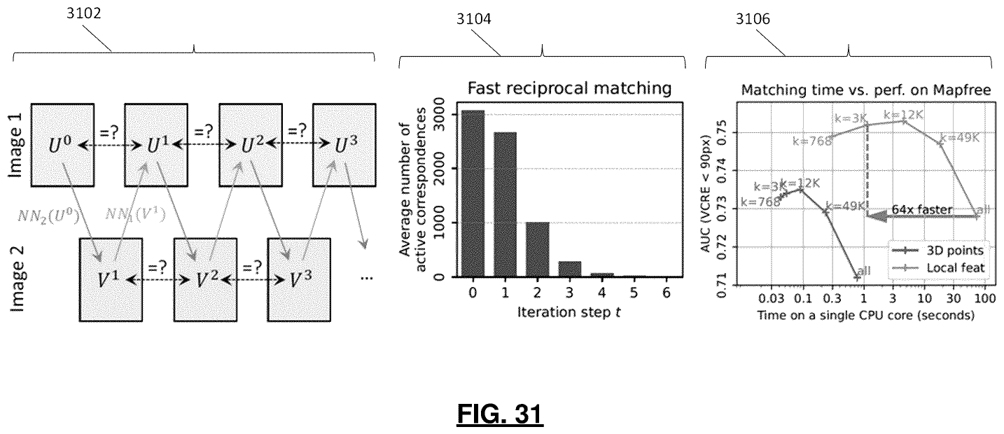

The set of reciprocal matches (those which form a cycle, i.e., [symbol] _k\hat{ }t={(U_n\hat{ }t, V_n\hat{ }t)|U_n\hat{ }t=U_n\hat{ }(t+1)}) are then collected. For the next iteration, pixels that already converged are filtered out, i.e., updating U^{t+1}: =U^{t+1\U}^{^{t}}. Likewise, starting from t=1, v^{t+1} is verified and filtered, comparing it with V^{t} in a similar fashion. FIG. 31 shows graphs demonstrating fast reciprocal matching using the MASt3R network. The fast matching process is illustrated at 3102, starting from an initial subset of pixels U° and propagating it iteratively using nearest-neighbor (NN), where searching for cycles detect reciprocal correspondences and allows to accelerate the subsequent steps, by removing points that converged. This process is iterated a fixed number of times, until most correspondences converge to stable (reciprocal) pairs. FIG. 31 at 3104 shows that the number of un-converged point |U^{t}| rapidly decreases to zero after a few iterations, when the average number of remaining points in U^{t} at iteration t=1 . . . 6, where after only 5 iterations, nearly all points have already converged to a reciprocal match. Finally at 3106 in FIG. 31, the output set of correspondences includes the concatenation of all reciprocal pairs [symbol] ₖ=Uₜ [symbol] ₖ^{t}, which shows that the performance-versus time trade-off on the Map-free dataset, where performance actually improves, along with matching speed, when performing moderate levels of subsampling.

Theoretical. The overall complexity of the fast matching is 0 (KWH), which is

$$\frac{WH}{k} ≫ 1$$

times faster than the naive approach denoted all, as illustrated in FIG. 31 (right). It is noted that the fast matching algorithm extracts a subset of the full set [symbol] , which is bounded in size by | [symbol] ₖ|≤k. This study of convergence guarantees of this algorithm and how it evinces outlier-filtering properties, explains why the end accuracy is actually higher than when using the full correspondence set M.

### Section C.3.4 Coarse-to-Fine Matching

Due to the quadratic complexity of attention with respect to the input image area (W×H), an embodiment of the MASt3R architecture handles images of 512 pixels in their largest dimension. Larger images may involve more compute power to train, and ViTs may not generalize yet to larger test-time resolutions. As a result, high-resolution images (e.g., 1 M pixel) may be downscaled to be matched, afterwards the resulting correspondences are upscaled back to the original image resolution. This can lead to some performance loss, sometimes sufficient to cause degradation in term of localization accuracy or reconstruction quality.

Coarse-to-fine matching is a technique to preserve the benefit of matching high-resolution images with a lower-resolution algorithm that may be used for the for the MASt3R architecture. The procedure starts with performing matching on downscaled versions of the two images. The set of coarse correspondences obtained with subsampling k are denoted as [symbol] ₖ⁰. Next, a grid of overlapping window crops W¹ and W²∈ [symbol] ^{W×4} are generated on each full-resolution image independently. Each window crop measures 512 pixels in its largest dimension and contiguous windows overlap by 50%. Then enumerating the set of all window pairs (w₁, w₂)∈W¹×W², a subset is selected that covers most of the coarse correspondences [symbol] ₖ⁰. Specifically, window pairs are added one by one in a greedy fashion until 90% of correspondences are covered. Finally, matching for each window pair is performed independently:

$${D}^{{w}_{1}} , {D}^{{w}_{2}} = MASt 3 R ( {I}_{{w}_{1}}^{1} , {I}_{{w}_{2}}^{2} ) \qquad ( C17 )$$

$${ℳ}_{k}^{{w}_{1} , {w}_{2}} = fast\_reciprocal \_NN ( {D}^{{w}_{1}} , {D}^{{w}_{2}} ) \qquad ( C18 )$$

Correspondences obtained from each window pair are finally mapped back to the original image coordinates and concatenated, thus providing dense full-resolution matches.

### Section C.4 Experimental Results

This Section is organized as follows, initially the training procedure of MASt3R is detailed (Section C.4.1). Then, several inference tasks are evaluated, each time comparing with others, starting with visual camera pose estimation on the Map-Free Relocalization Benchmark (Section C.4.2), the CO3D and RealEstate datasets (Section C.4.3) and other standard Visual Localization benchmarks (Section C.4.4). Finally, MASt3R is leveraged for the task of Dense Multi-View Stereo (MVS) reconstruction (Section C.4.5).

### Section C.4.1 Training Methods

Training data. The MASt3R network in one example is trained with a mixture of 14 datasets: Habitat, ARKitScenes (see Dehghan et al.), Blended MVS, MegaDepth (Li and Snavely 2018), Static Scenes 3D, ScanNet++, CO3Dv2, Waymo (Sun et al. 2020), Map-free (see Arnold et al.), WildRgb (Xia et al., “RGBD Objects in the Wild: Scaling Real-World 3D Object Learning from RGB-D Videos”, arxiv.org/abs/2401.12592, 2024), VirtualKitti (see Cabon et al., “Virtual KITTI 2.” in arXiv 2001.10773, 2020), Unreal4K (Tosi et al., “SMD-Nets: Stereo Mixture Density Networks” in CVPR, 2021), TartanAir (see Wang et al., “TartanAir: A Dataset to Push the Limits of Visual Slam”, in arXiv 2003.14338 2020) and an internal dataset. These datasets feature diverse scenes types: indoor, outdoor, synthetic, real-world, object-centric, etc. Among them, ten datasets have metric ground-truth. When image pairs are not directly provided with the dataset, they are extracted based on the method described in Weinzaepfel et al. 2023. Generally in one example, systems and methods may be used in for retrieval and point matching to match and verify image pairs.

Training. As set forth above, the MASt3R model architecture is based on the DUSt3R model architecture, permitting the use of the same backbone (e.g., ViT-Large encoder and ViT-Base decoder). To benefit from the DUSt3R architecture's 3D matching abilities, the model weights are initialized to predetermined values for a DUSt3R checkpoint. During each epoch, 650 k pairs equally distributed between all datasets are randomly sampled. The MASt3R network is trained for 35 epoch with a cosine schedule and initial learning rate set to 0.0001. Similar to the training for MASt3R, the image aspect ratio is randomized at training time, ensuring that the largest image dimension is 512 pixels. The local feature dimension is set to d=24 and the matching loss weight to B=1. It is important that the network sees different scales at training time, because coarse-to-fine matching starts from zoomed-out images to then zoom-in on details (see Section C.3.4). Consequently, aggressive data augmentation is performed during training in the form of random cropping. Image crops are transformed with a homography to preserve the central position of the principal point. While example training parameters are provided, the present application is also applicable to other values.

Correspondence sampling. To generate ground-truth correspondences for the matching loss (Equation C11), the reciprocal correspondences between on the ground-truth 3D pointmaps X̅^{1,1}↔X̅^{2,1} are found. Then 4096 correspondences per image pairs are randomly subsampled. If enough correspondences cannot be found, they are padded with random false correspondences so that the likelihood of finding a true match remains constant.

Fast nearest neighbors. For fast reciprocal matching disclosed in Section C.3.3, the nearest neighbor function NN(x) from Equation C15, may be implemented differently depending on the dimension of x. When matching 3D points x∈ [symbol] ³, NN(x) may be implemented using K-d trees (see Maneewongvatana et al, “Analysis of Approximate Nearest Neighbor Searching with Clustered Point Sets”, in DIMACS Series in Discrete Mathematics and Theoretical Computer Science, 1999). For matching local features with d=24, however, K-d trees may be inefficient due to dimensionality. Therefore, the optimized FAISS library is relied on in such cases.

### Section C.4.2 Map-Free Localization

Dataset description. Experiments begin with the Map-free relocalization benchmark (see Arnold et al.), an extremely challenging dataset aiming at localizing the camera in metric space given a single reference image without any map. It comprises a training, validation and test sets of 460, 65 and 130 scenes, respectively, each featuring two video sequences. Following the benchmark, evaluations are performed in term of Virtual Correspondence Reprojection Error (VCRE) and camera pose accuracy, see Arnold et al. for details.

Impact of subsampling. Coarse-to-fine matching may not be performed for this dataset, as the image resolution is already close to MASt3R working resolution (720×540 vs. 512×384 resp.). As mentioned in Section C.3.3, computing dense reciprocal matching may be slow even with optimized code for searching nearest neighbors. Therefore the set of reciprocal correspondences are subsampled, keeping at most k correspondences from the complete set [symbol] (Equation C14). FIG. 31 (right) shows the impact of subsampling in term of AUC (VCRE) performance and timing. Surprisingly, the performance improves for intermediate values of subsampling. Using k=3000, matching can be accelerated by a factor of 64 while improving the performance. Unless stated otherwise, k=3000 is maintained for subsequent experiments set out in this Section.

Ablations on losses and matching modes. Results are reported on the validation set in the table in FIG. 41 for different variants of MASt3R: DUSt3R matching 3D points (I); MASt3R also matching 3D points (II) or local features (III, IV, V). For all methods, the relative pose from the essential matrix estimated with the set of predicted matches (PnP performs similarly) is computed. The metric scene scale is inferred from the depth extracted with a DPT fine-tuned on KITTI (see DPT-KITTI) (I-IV) or from the depth directly output by MASt3R (V).

First, it is noted that all proposed MASt3R methods outperforms others. All other things being equal, matching descriptors perform better than matching 3D points (II versus IV). Regression may be inherently unsuited to compute pixel correspondences, see Section C.3.2.

Also the impact of training only with a single matching objective ( [symbol] _{match} from Equation C11, III) is studied. In this case, the performance overall may degrade compared to training with both 3D and matching losses (IV), in particular in term of pose estimation accuracy (e.g., median rotation of 10.8° for (III) compared to 3.0° for (IV)). It is noted that this is in spite of the decoder now having more capacity to carry out a single task, instead of two when performing 3D reconstruction simultaneously, indicating that grounding matching in 3D is indeed crucial to improve matching. Lastly, it is observed that, when using metric depth directly output by MASt3R, the performance largely improves. This suggests that, as for matching, the depth prediction task is largely correlated with 3D scene understanding, and that the two tasks strongly benefit from each other.

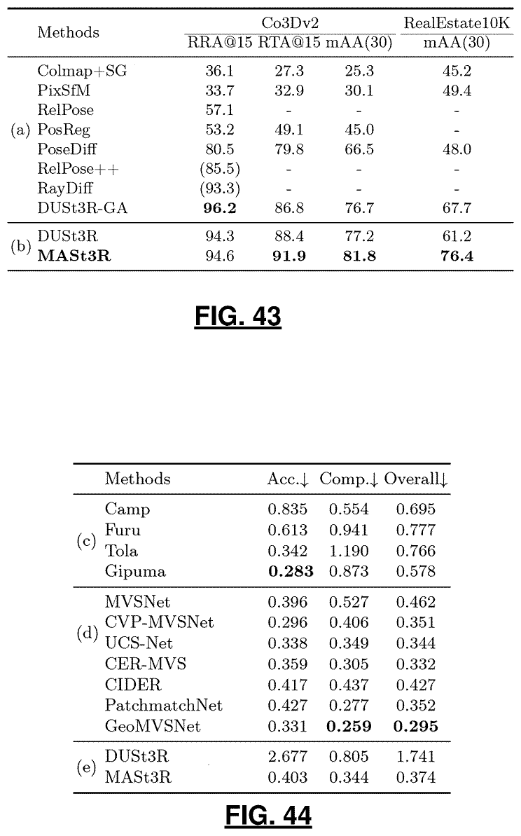

Comparisons on the test set is reported in the table in FIG. 42. Overall, MASt3R outperforms all other approaches by a large margin, achieving more than 93% in VCRE AUC. This is a 30% absolute improvement compared to the second best method, LoFTR+DPT-KITTI, that get 63.4% in AUC. Likewise, the median translation error is vastly reduced to 36 cm, compared to approximately 2 m for the other methods. A large part of the improvement may be due to MASt3R predicting metric depth, but note that a variant that leverages depth from DPT-KITTI (thus purely matching-based) outperforms all other approaches as well.

Also the results of direct regression with MASt3R, i.e., without matching, simply using PnP on the pointmap X^{2,1} of the second image is provided. These results are on par with the MASt3R matching-based variant, even though the ground-truth calibration of the reference camera is not used. As shown below, this does not hold true for other localization datasets, and computing the pose via matching (e.g., with PnP or essential matrix) with known intrinsics may be safer.

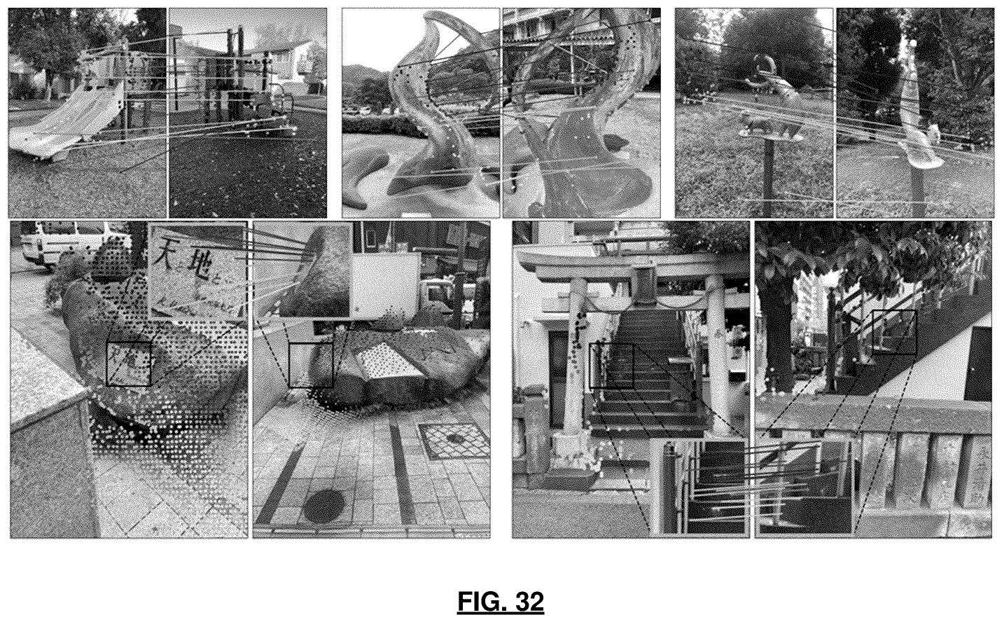

Qualitative results. FIG. 32 shows some matching results for pairs with strong viewpoint change (up to) 180°, where 3 pairs of images with strong viewpoint changes are showed in the top row (the third one is a failure case), and where 2 pairs of images with interesting spots in close-up, that could hardly be matched by local keypoints, are shown in the bottom row. It may be highlighted that with insets some specific regions that are correctly matched by MASt3R in spite of drastic appearance changes. It is believed that these correspondences to be nearly impossible to get with 2D-based matching methods. In contrast, grounding the matching in 3D allows this issue to be solved.

### Section C.4.3 Relative Pose Estimation

Datasets and protocol. Next, the task of relative pose estimation on the CO3Dv2 and RealEstate10 k datasets is evaluated. CO3Dv2 includes 6 million frames extracted from approximately 37 k videos, covering 51 MS-COCO categories. Ground-truth camera poses are obtained using COLMAP from 200 frames in each video. RealEstate10 k is an indoor/outdoor dataset that features 80K video clips on YouTube totaling 10 million frames, camera poses being obtained via SLAM with bundle adjustment. Following PoseDiffusion, MASt3R is evaluated on 41 categories from CO3Dv2 and 1.8K video clips from the test set of RealEstate10 k. Each sequence is 10 frames long, relative camera poses are evaluated between all possible 45 pairs, not using ground-truth focal lengths.

Baselines and metrics. As before, matches obtained with MASt3R are used to estimate Essential Matrices and relative pose. Note that predictions are done pairwise, contrary to all other methods that leverage multiple views (with the exception of DUSt3R-PnP). Other data-driven approaches like RelPose, RelPose++ (see Lin et al., “Relpose++: Recovering 6d poses from sparse-view observations”, in arXiv: 2305.04926, 2023), PoseReg and PoseDiff, the recent RayDiff (see Zhang et al., “Cameras as Rays: Pose Estimation via Ray Diffusion”, in ICLR, 2024) and DUSt3R are compared. Also results are reported for more traditional SfM methods like PixSFM and COLMAP extended with SuperPoint (see DeTone et al.) and SuperGlue (COLMAP+SPSG). The Relative Rotation Accuracy (RRA) and Relative Translation Accuracy (RTA) are reported for each image pair to evaluate the relative pose error and select a threshold T=15 to report RTA@15 and RRA@15. Additionally, the mean Average Accuracy (mAA30), defined as the area under the accuracy curve of the angular differences at min (RRA@30, RTA@30), is calculated.

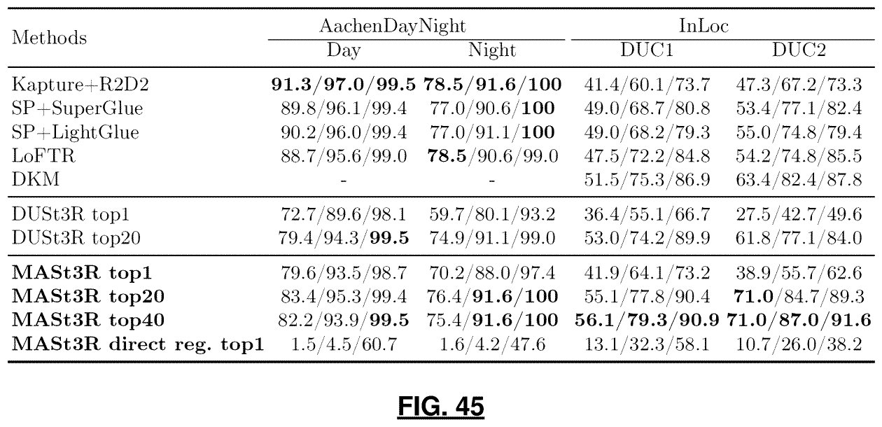

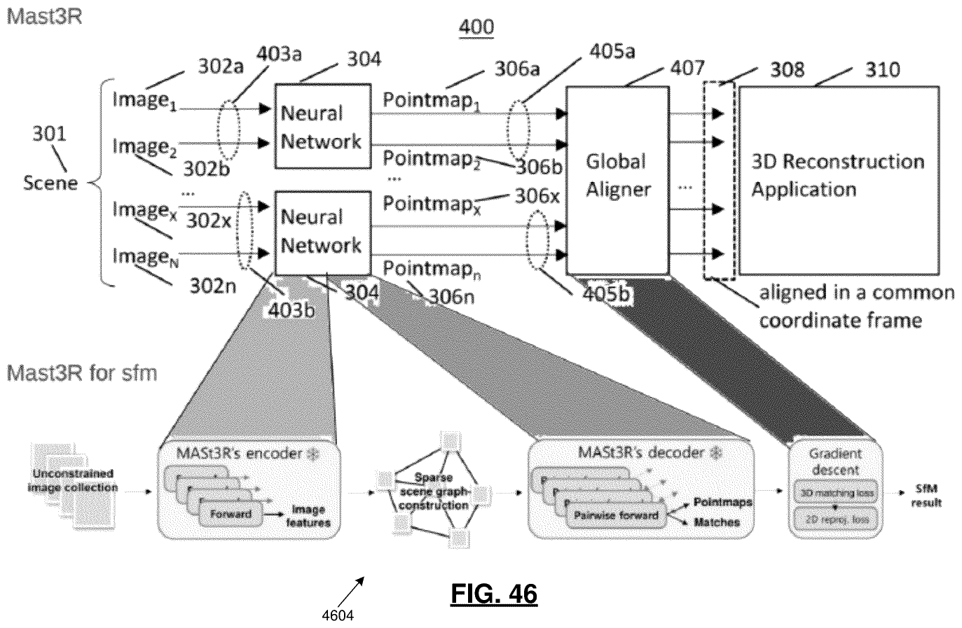

Results. As shown in the tables in FIGS. 43 and 44, SfM approaches tend to underperform on this task, mainly due to the poor visual support. This is because images may observe a small object, combined with the fact that many pairs have a wide baseline, sometimes up to 180°. In contrast, 3D grounded approaches like RayDiffusion, DUSt3R and MASt3R are the most competitive methods on this dataset, the latter leading in translation and mAA on both datasets. Notably, on RealEstate MASt3R's mAA score improves by at least 8.7 points over the best multi-view methods and 15.2 points over pairwise DUSt3R. This showcases the accuracy and robustness of this approach to few input view setups.

### Section C.4.4 Visual Localization

Datasets. MASt3R is evaluated for the task of absolute pose estimation on the Aachen Day-Night and InLoc (see Taira et al.) datasets. Aachen includes 4,328 reference images taken with hand-held cameras, as well as 824 daytime and 98 nighttime query images taken with mobile phones in the old inner city of Aachen, Germany. InLoc (see Taira et al.) is an indoor dataset with challenging appearance variation between the 9,972 RGB-D+6DOF pose database images and the 329 query images taken from an iPhone 7.

Metrics. The percentage of successfully localized images within three thresholds are reported: (0.25 m, 2°), (0.5 m, 5°) and (5 m, 10°) for Aachen and (0.25 m, 10°), (0.5 m, 10°), (1 m, 10°) for InLoc.

Results are reported in the table in FIG. 45, where the performance of MASt3R is studied with variable number of retrieved images. As expected, a greater number of retrieved images (top40) yields better performance, achieving competitive performance on Aachen and significantly outperforming others on InLoc.

Interestingly, MASt3R still performs well even with a single retrieved image (top1), showcasing the robustness of 3D grounded matching. Also included are direct regression results, which are poor, showing a striking impact of the dataset scale on the localization error, i.e., small scenes are much less affected (see results on Map-free in Section C.4.2). This confirms the importance of feature matching to estimate reliable poses.

### Section C.4.5 Multiview 3D Reconstruction

Multi-View Stereo (MVS) is performed by triangulating the obtained matches. Note that the matching is performed in full resolution without prior knowledge of cameras, and the latter are only used to triangulate matches to 3D in ground-truth reference frame. To remove spurious 3D points, geometric consistency post-processing (see F. Wang et al., “PatchmatchNet: Learned Multi-View Patchmatch Stereo”, in CVPR, 2021) is applied.

Datasets and metrics. Predictions on the DTU dataset are evaluated. Contrary to all competing learning methods, the MASt3R network is applied in a zero-shot setting, i.e., no training or finetuning is performed on the DTU training set and the MASt3R model is applied as is. In the tables in FIGS. 43 and 44 show the average accuracy, completeness and Chamfer distances error metrics are reported as provided by the authors of the benchmarks. The accuracy for a point of the reconstructed shape may be defined as the smallest Euclidean distance to the ground-truth, and the completeness of a point of the ground-truth as the smallest Euclidean distance to the reconstructed shape. The overall Chamfer distance is the average of both previous metrics.

Results. Data-driven approaches trained on this domain significantly outperform handcrafted approaches, cutting the Chamfer error by half. This is inventive for a zero shot setting. MASt3R outperforms and competes with others, all without leveraging camera calibration nor poses for matching, neither having seen the camera setup before.

### Section C.5 Conclusion

Grounding image matching in 3D with the MASt3R architecture raised the bar on camera pose and localization tasks on many public benchmarks, and improved the DUSt3R architecture with matching, advantageously achieving enhanced robustness, while attaining and even surpassing what could be done with pixel matching alone. In addition, a fast reciprocal matcher and a coarse to fine approach for efficient processing is disclosed, allowing users to balance between accuracy and speed. The MASt3R architecture is believed to greatly increase versatility of localization.

### Section C.6 Coarse Global Aligner for MASt3R

This Section discloses an alignment module 820 and procedure 855 therefor, with reference to FIG. 8C and FIG. 8D, respectively, for use with the MASt3R neural network 304b. A goal of this embodiment remains similar to other embodiments disclosed herein (i.e., given a collection of images 302 depicting the same scene under different viewpoints and illuminations, a 3D reconstruction 812 is performed of the scene along with the intrinsic and extrinsic parameters of cameras of the scene).

By way of overview, the method disclosed in this Section begins with a collection of N images [symbol] ={Iⁿ}_{1≤n≤N} of views of a given 3D scene, with N potentially large (e.g., on the order of thousands of images). Each image Iⁿ is acquired by a camera [symbol] ₙ=(Kₙ, Pₙ) where Kₙ∈R^{3×3} denotes the intrinsic parameters (i.e., the camera's calibration in terms of focal length and principal point) and Pₙ∈R^{4×4} the camera's pose (i.e., rotation and translation, from world coordinates to camera coordinates). Given the set of images {Iⁿ} as input, the method recovers all cameras parameters { [symbol] ₙ} as well as the underlying 3D scene geometry {Xⁿ}, with Xⁿ∈ [symbol] ^{W×H×3} a pointmap relating each pixel y=(i, j)∈ [symbol] ² to its corresponding 3D point X_{y}ⁿ in the scene in a common world coordinate frame. It is assumed for simplicity in this Section that all images have the same pixel resolution W×H, which may differ in practice. The method 850 of recovering camera parameters and 3D reconstruction shown in FIG. 8D is known as ‘bundle adjustment’, the steps of which are each described in detail below: (1) in Section C.6.1, constructing a co-visibility graph at 852 using co-visibility graph module 303; (2) in Section C.6.2, performing at 854 local 3D reconstruction and matching using the MASt3R neural network 304b; (3) in Section C.6.3, performing global alignment at 856; and (4) in Section C.6.4, refining alignment using 2D reprojection error at 858.

### Section C.6.1 Co-Visibility Graph

At 852 (in FIG. 8D), the set of image views [symbol] observing a scene to reconstruct may be expressed by co-visibility graph module 303 (in FIG. 8C) as a scene graph [symbol] =( [symbol] , ε), where each vertex of the graph I∈ [symbol] is an image, and each edge e=(n, m)∈ε is a (directed) pairwise connection between likely-related images Iⁿ and I^{m}. In this embodiment, the edges of the scene graph are directed because the pairwise relationship (i.e., the inference pass of MASt3R—see Section C.6.2 and Equation C19 below) is asymmetric. The task performed at 852 may be reformulated as: estimating the vertices properties (i.e., the camera parameters and view-dependent pointmaps) from the pairwise properties of the edges. Without prior information about the image views [symbol] , each image 302 could be related to any other image (i.e., the approach might consider a graph where all possible edges are present). However, doing so would make the rest of the approach not scalable for large image collections as the overall complexity of the next step at 854 is in 0(|ε|)=O(N²).

At 852, a scalable pairwise image matcher, h (Iⁿ, I^{m})→s, is used that is able to provide an approximate co-visibility score s∈ [symbol] between two images Iⁿ and I^{m}. In examples, image retrieval methods, efficient matching methods or averaged MASt3R's confidence predictions may be used to compute the score. By evaluating all possible pairs and thresholding the score with τₛ, irrelevant edges may be pruned from the scene graph [symbol] to retain only those where h(Iⁿ, I^{m})>τₛ is sufficiently high, always ensuring the scene graph [symbol] remains connected (i.e., there exists a path between any pair of vertices).

More generally, the co-visibility graph module 303 may be used to preprocess images 302 to generate a scene graph [symbol] for input to the DUSt3R network 304a (shown in FIG. 8A), the MASt3R network 304b (shown in FIG. 8B) and the C-GAR network 304c (shown in FIG. 10).

### Section C.6.2 Local 3D Reconstruction and Matching

At 854 (in FIG. 8D), local 3D reconstruction and dense matching is performed on small clusters of k related images using the MASt3R neural network 304b. For the purpose of explanation, the simplest case of k=2 is assumed (i.e., pairs of images), and all scene graph edges e=(n, m)∈ε are processed using MASt3R neural network 304b such that:

$$MASt 3 R ( {I}^{n} , {I}^{m} ) \to ( {X}^{n , n} , {X}^{m , n} , {C}^{n , n} , {C}^{m , n} , {F}^{n , n} , {F}^{m , n} , {Q}^{n , n} , {Q}^{m , n} ) \qquad C19$$

where:
   X^{m,n} ∈ [symbol] ^{W×H×3} denotes the pointmap 306 of image I^{m} in image Iⁿ's coordinate frame;
   C^{m,n} ∈ [symbol] ^{W×H} denotes the corresponding pointmap confidence score map 814 of image I^{m} w.r.t. image Iⁿ;
   F^{m,n}∈ [symbol] ^{W×H×d} denotes the d-dimensional feature map 818 of image I^{m} w.r.t image Iⁿ; and
   Q^{m,n}∈ [symbol] ^{W×H} denotes the corresponding feature confidence map 819 of image I^{m} w.r.t. image Iⁿ.
      This k-cluster formulation is maintained because it is possible to train an N-view network. For instance the C-GAR approach disclosed in Section D below considers up to four views, although a higher number of views with a ViT encoder-decoder architecture is not recommended for computational reasons.

Sparse correspondences. For each image pair, sparse correspondences (or matches) are recovered by application of MASt3R's fast reciprocal matching disclosed in Section C.3.3. More specifically, here a fast neural network (FastNN) searches for a subset of reciprocal correspondences from two feature maps F^{n,n} and F^{m,n} by initializing seeds on a regular pixel grid at intervals s∈ [symbol] and iteratively converging to mutual correspondences [symbol] ^{n,m}, as defined by:

$${FastNN}_{s} ( {F}^{n , n} , {F}^{m , n} ) \to {ℳ}^{n , m} ,$$

where [symbol] ^{n,m}= [symbol] is a set of pixel correspondences between Iⁿ and I^{m}. Grid density parameter s sets a trade-off between coverage density and computation cost. In one embodiment, s=8 pixels is used as a compromise between these two aspects. Since both MASt3R and FastNN are order-dependent functions in terms of their parameters, typically they are computed in both directions and all unique correspondences are gathered:

$${ℳ}^{n , m} = \frac{{FastNN}_{s} ( {F}^{n , n} , {F}^{m , n} )}{⋃ {FastNN}_{s} ( {F}^{m , m} , {F}^{n , m} )} \begin{matrix}⋃ \overline{{FastNN}_{s} ( {F}^{m , n} , {F}^{n , n} )} \\ ⋃ {FastNN}_{s} ( {F}^{n , m} , {F}^{m , n} )\end{matrix} , \qquad ( C20 )$$

where the upper line of a set [symbol] ={y_{c}^{m}↔y_{c}ⁿ} denotes the n↔m swap of the original set [symbol] ={y_{c}ⁿ↔y_{c}^{m}}.

### Section C.6.3 Coarse Global Alignment in 3D Space

At 856, coarse global alignment is performed in 3D space. Sections A.6 and B.3.4, with reference to global aligner 407, above discloses an alternate example of global alignment procedure that aims to express all pairwise pointmaps in a common world coordinate frame using regression based alignment. At 856, an alternate embodiment of global alignment is performed that takes advantage of explicit pixel correspondences. This alternate embodiment of global alignment that also aims to express all pairwise pointmaps in a common world coordinate frame advantageously reduces the overall number of parameters.

Averaging per-image pointmaps. At 856, a first step is performed to obtain a canonical pointmap for each image, expressed in its own camera coordinate system. For example, consider an image Iⁿ and εⁿ={e|e₀=n} is the set of all edges e=(e₀, e₁) starting from image Iⁿ. For each such edge e=(n, m)∈εⁿ, there is a different estimate of X^{n,n} and C^{n,n}, which is denoted herein as X^{n,e} and C^{n,e} with the convention that e=(n, m). One strategy to arrive at the canonical pointmap is to compute a per-pixel weighted average of all estimates using:

$${\tilde{X}}_{i , j}^{n} = \frac{{\sum }_{e ∈ {ε}^{n}} {C}_{i , j}^{n , e} {X}_{i , j}^{n , e}}{{\sum }_{e ∈ {ε}^{n}} {C}_{i , j}^{n , e}} ,$$

Because the initial estimates may not necessarily be well aligned in terms of scale and depth offset, an alternate strategy may be to compute a scale-aligned version of the canonical pointmap by minimizing the following robust energy function:

$${\tilde{X}}^{n} = arg {min}_{a , b , {\tilde{X}}^{n}} {\sum }_{e ∈ {ε}^{n}} {\sum }_{i , j} {C}_{i , j}^{n , e} ‖ {\tilde{X}}_{i , j}^{n} - {a}_{e}^{n} {X}_{i , j}^{n , e} - {[ 0 , 0 , {b}_{e}^{n} ]}^{T} ‖ ,$$

where aⁿ∈ [symbol] ^{E}^{ₙ} (aₑⁿ>0), bⁿ∈ [symbol] ^{E}^{ₙ} denotes the scales and z-offsets to align all Eₙ=|εⁿ| estimates with the canonical pointmap. Note that it is guaranteed that |εⁿ|≥1 since each image is at least connected to an edge, and each edge is processed in the two possible directions (i.e., inference and backpropagation) with the MASt3R neural network 304b.

Global alignment. A goal of the coarse global alignment is to find the scaled rigid transformation of all canonical pointmaps {\hat{X}ⁿ} such that any two matching 3D points are as close as possible in the world coordinate frame:

$${P}^{*} , {σ}^{*} = arg {min}_{P , {σ}^{′}} {\sum }_{( n , m ) ∈ ε} {\sum }_{c ∈ {ℳ}^{n , m}} {q}_{c} ‖ {σ}_{n} {P}_{n} {\tilde{X}}_{c}^{n} - {σ}_{m} {P}_{m} {\tilde{X}}_{c}^{m} ‖ , \qquad ( C21 )$$

where the rigid transformation for each image Iⁿ is expressed as a 6D pose Pₙ∈ [symbol] ^{4×4}, with a scaling factor σₙ>0. To avoid degenerate solutions,

$$\frac{1}{N \sum {σ}_{n}} = 1$$

is imposed, which may be achieved by setting σ=softmax (σ′), σ′∈ [symbol] ^{N}. In contrast to global alignment performed by global aligner 407 (shown in FIG. 4 and discussed in Sections A.6 and B.3.4), the loss only applies to known pixel correspondences [symbol] ₑ={y_{c}ⁿ↔y_{c}^{m}} (see Equation C20) and are weighted by the geometric average of their respective confidence q_{c}=\sqrt{Q_{c}^{n,e}Q_{c}^{m,e}} (here any matching pixels y_{c}ⁿ↔y_{c}^{m} are denoted as c with a slight abuse of notation for the sake of clarity). This objective is minimized using standard gradient descent for simplicity, but other strategies such as second-order optimization (e.g., with a Linear Optimization (LM) solver) could be faster.

### Section C.6.4 Final Refinement in Terms of 2D Reprojection Error

Coarse alignment is fast and simple with good convergence in practice, but unfortunately, it may not fix inaccuracies in the predictions of the canonical pointmaps. Yet, these are bound to happen as these pointmaps originate from an approximate regression process that (i) is subject to depth ambiguities (e.g., in regions seen by only one of the two cameras) and (ii) was never meant to be extremely accurate to begin with. To further refine the camera parameters using 2D reprojection error at 858 in FIG. 8D, canonical pointmaps (scene geometry) and camera parameters are jointly optimized using pixel correspondences. The 2D reprojection of 3D points are minimized in all cameras where their position is known, a process which is often denoted as bundle adjustment:

$$z , K , P , σ = arg {min}_{z , K , P , σ} {\sum }_{( n , m ) ∈ ε} {\sum }_{c ∈ {ℳ}^{n , m}} {q}_{c} [ ρ ( {y}_{c}^{n} - {π}_{n} ( {χ}_{c}^{m} ) ) + ρ ( {y}_{c}^{m} - {π}_{m} ( {χ}_{c}^{n} ) ) ] , \qquad ( C22 )$$

where πₙ (χ_{i,j}^{m}) denotes the 2D reprojection of a 3D point χ_{i,j}^{m} from image I^{m}'s optimizable pointmap χ^{m}∈ [symbol] ^{W×H×3} onto the camera screen of Iⁿ, and ρ: [symbol] ²→ [symbol] ⁺ is a robust error function to deal with the potential outliers among all extracted correspondences. It is typically of the form ρ(x)=∥x∥^{γ} with 0<γ≤1 (e.g., γ=0.5), but other choices are possible. For a standard pinhole camera model with intrinsics and extrinsics parameter matrices Kₙ and Pₙ, the reprojection function π is given as:

$${π}_{n} ( {χ}_{i , j}^{m} ) = {K}_{n} {P}_{n} {χ}_{i , j}^{m} .$$

To ensure geometry-compliant reconstructions, pointmaps {χⁿ} are themselves obtained using the inverse reprojection function π⁻¹. For a given 3D point at pixel coordinate (i, j)∈ [symbol] ² and depth z_{i,j}ⁿ>0, then:

$$\begin{matrix}{χ}_{i , j}^{n} = {π}_{n}^{- 1} ( i , j , {z}_{i , j}^{n} ) \\ = {K}_{n}^{- 1} {P}_{n}^{- 1} {{z}_{i , j}^{n} [ i , j , 1 ]}^{T}\end{matrix} .$$

Since this method is only interested in a few pixel locations of χⁿ (those with pixel correspondences c∈ [symbol] ^{n,m}), it is not necessary to store all depth values explicitly during optimization thereby reducing memory and computations and making the optimization fast and scalable. Note that this approach is compatible with different camera models (e.g., fisheye, omnidirectional, etc) as long as the corresponding definition of the camera reprojection function π is accordingly set and the pairwise inference network has been trained accordingly. Again, this objective is minimized using standard gradient descent for simplicity, but other strategies such as second-order optimization (e.g., with an LM solver) could potentially be faster.

Anchor points. Contrary to the 3D matching loss from (see Equation C21) where 3D points are rigidly bundled together (embedded within canonical pointmaps), optimizing the individual position of 3D points χ_{i,j}ⁿ without constraints can lead to inconsistent 3D reconstructions. To remedy this, the traditional solution is to create point tracks (i.e., to assign the same 3D point to a connected chain of several correspondences that spans several images). While this is relatively straightforward with keypoint-based methods, these correspondences do not necessarily overlap with each other. One solution is to glue 3D points together via anchor points that provide a regularization on the type of deformations that can be applied to the pointmaps.

For each image Iⁿ, a regular 2D grid of anchor points {\dot{y}_{u,v}ⁿ} is created, spaced by the same sampling parameter s∈ [symbol] ⁺ as used for FastNN matching:

$${\dot{y}}_{u , v}^{n} = ( us + \frac{s}{2} , vs + \frac{s}{2} ) .$$

Then each correspondence y_{c}ⁿ=(i, j) inIⁿ is tied with its closest anchor \dot{y}_{u,v}ⁿ at

$$( u , v ) = ( ⌊ \frac{i}{s} ⌋ , ⌊ \frac{j}{s} ⌋ ) .$$

The corresponding 3D point is then fully characterized by the depth of its anchor point ż_{u,v}ⁿ as:

$${χ}_{i , j}^{n} = {π}_{n}^{- 1} ( i , j , {σ}_{n} {\dot{z}}_{⌊ \frac{i}{s} ⌋ , ⌊ \frac{j}{s} ⌋}^{n} {o}_{i , j}^{n} ) ,$$

where σₙ is a global scale factor for image Iⁿ and the relative offset

$${o}_{i , j}^{n} = \frac{{\dot{\tilde{z}}}_{u , v}^{n}}{{\tilde{z}}_{i , j}^{n}}$$

is a constant obtained once for all from the canonical depthmap \tilde{z}_{i,j}ⁿ=\tilde{X}_{i,j,2}ⁿ and its subsampled version

$${\dot{\tilde{z}}}_{u , v}^{n} = {\tilde{z}}_{u s + \frac{s}{2} , vs + \frac{s}{2}}^{n} .$$

In other words, it is assumed that the canonical pointmaps are locally accurate in terms of relative depth values. On the whole, optimizing a pointmap χⁿ∈ [symbol] ^{W×H×3} only comes down to optimizing a small set of anchor depth values żⁿ∈

$${ℝ}^{\frac{W}{s} \times \frac{H}{s}} ,$$

a global scale factor σₙ>0 and camera parameters Kₙ and Pₙ.

Initialization. Since the energy function in Equation C21 may be non-convex and subject to falling into sub-optimal local minima, the coarse global alignment is leveraged as a good initialization, while setting Pᵢₙᵢₜ=P*, σᵢₙᵢₜ=σ* and approximating χᵢₙᵢₜ ≃\tilde{X}. Note that the canonical pointmap \tilde{X}ⁿ may not be fully consistent with a camera model, so the optimal focal length fₙ* is extracted from pointmap \tilde{X}ⁿ as described in Section B.3.3 to get intrinsic camera parameters Kᵢₙᵢₜ (with centered principal point), and anchor depth values are initialized as

$${\dot{z}}_{u , v}^{n} = {\tilde{X}}_{u s + \frac{s}{2} , vs + \frac{s}{2 , 2}}^{n} .$$

Low-rank representation of the pointmaps. The anchor-based 3D scene representation disclosed in this Section lowers the effective dimensionality of pointmaps from 3WH to WH/s². Yet, in the case where some regions of an image are completely unmatched by any other images, these regions will not receive any updates during the optimization (by definition of Equation C21). As a result, the pointmap for this image may gradually distort awkwardly, resulting in unsatisfying reconstructions. Intuitively, it seems more satisfying to have a quasi-rigid way of deforming pointmaps during optimization, akin to the coarse global alignment but with more leeway. One way of achieving this is to represent żⁿ with a low-rank approximation:

$${\dot{z}}^{n} ≃ {U}^{n} {\ddot{z}}^{n}$$

where for simplicity the dimensions of żⁿ∈ [symbol] ^{D} are flattened. Here, Uⁿ ∈ [symbol] ^{D×D′} is a constant orthogonal low-rank basis and \ddot{z}ⁿ∈ [symbol] ^{D′} is a small set of coefficients encoding żⁿ, with

$$D = \frac{W H}{{s}^{2}}$$

and D′<<D. A solution is to compute a content-adaptive frequency decomposition of the original depthmap żⁿ using spectral analysis. More specifically, first a graph is built where all anchor depth values ż_{u,v}ⁿ, ∈żⁿ constitutes nodes, and edge similarities are computed using a gaussian kernel on depth-invariant 3D distances as:

$${α}_{u , v , {u}^{′} , {v}^{′}} = exp [ - λ \frac{{‖ {\dot{X}}_{u , v}^{n} - {\dot{X}}_{{u}^{′} , {v}^{′}}^{n} ‖}^{2}}{{( {\dot{z}}_{u , v}^{n} + {\dot{z}}_{{u}^{′} , {v}^{′}}^{n} )}^{2}} ] ,$$

where \dot{X}_{u,v}ⁿ is defined w.r.t \tilde{X}_{u,v}ⁿ similarly to ż_{u,v}ⁿ. Then the normalized D×D Laplacian matrix

$$L = I - {Λ}^{- \frac{1}{2}} A {Λ}^{- \frac{1}{2}}$$

is computed where I is the identity matrix, A is the reshaped graph adjacency matrix with A_{(u,v),(u′,v′)}=α_{u,v,u′,v′}, and Λ is the diagonal degree matrix with Λ_{(u,v)(u,v)}=Σ_{u′,v′} A_{(u,v),(u′,v′)}. Computing the eigenvectors associated with the lowest D′ eigenvalues yields a good low-frequency and boundary-aware orthogonal basis Uⁿ. In one embodiment, only D′=64 basis vectors (i.e., coefficients) are retained to represent an anchored depthmap.

In another embodiment, an approximation is obtained by computing Uⁿ using a 2D Fourier transform on the

$${ℝ}^{\frac{W}{s} \times \frac{H}{s}}$$

domain, and only keeping (flattened) low-frequency 2D Fourier transform on the basis vectors. This has the advantage of being fast to compute and independent of the anchor depthmap content. Indeed the basis vector is not particularly fit to the depthmap at hand (i.e., it is generic (same for any image) and not tailored to the image-at-hand (not taking into account the depth boundaries for this particular image)), especially around depth boundaries where the reconstruction error is expected to be high since they can only be well represented with high frequencies.

### Section C.6.5 Advantages of Coarse Global Aligner

Compared with global alignment performed by global aligner 407 (shown in FIG. 4 and discussed in Sections A.6 and B.3.4), the alignment module 820 (shown in FIG. 8C) uses the MASt3R neural network 304b for computing pixel correspondence using fast sparse matching as set forth in this Section C.6 to perform pixel correspondence based alignment. The Section C.6 embodiment advantageously decreases the number of optimized parameters by leveraging both parameter sparsity and low-rank approximation. In addition, the Section C.6 embodiment introduces a final refinement step that leverages pixel correspondences in the form of a 2D reprojection error for the final refinement, producing improved pixel-accurate camera poses and 3D scenes. Further, the Section C.6 example enables a scalable and faster global alignment, that advantageously may be refined for improved accuracy compared to regression based global alignment performed using the global aligner 407.

### Section D. Camera-Geometry Agnostic 3D Reconstruction (C-GAR)

### Section D.1 Introduction

This Section presents a novel approach for Multiple View Stereopsis (MVS) from un-calibrated and un-posed cameras. A disclosed network is trained to predict a dense and accurate scene representation from a collection of image(s), without prior information regarding the scene nor the camera(s), not even the intrinsic parameters. This is in contrast to MVS where, given estimates of the camera intrinsic and extrinsic parameters, one needs to triangulate matching 2D points to recover the 3D information.

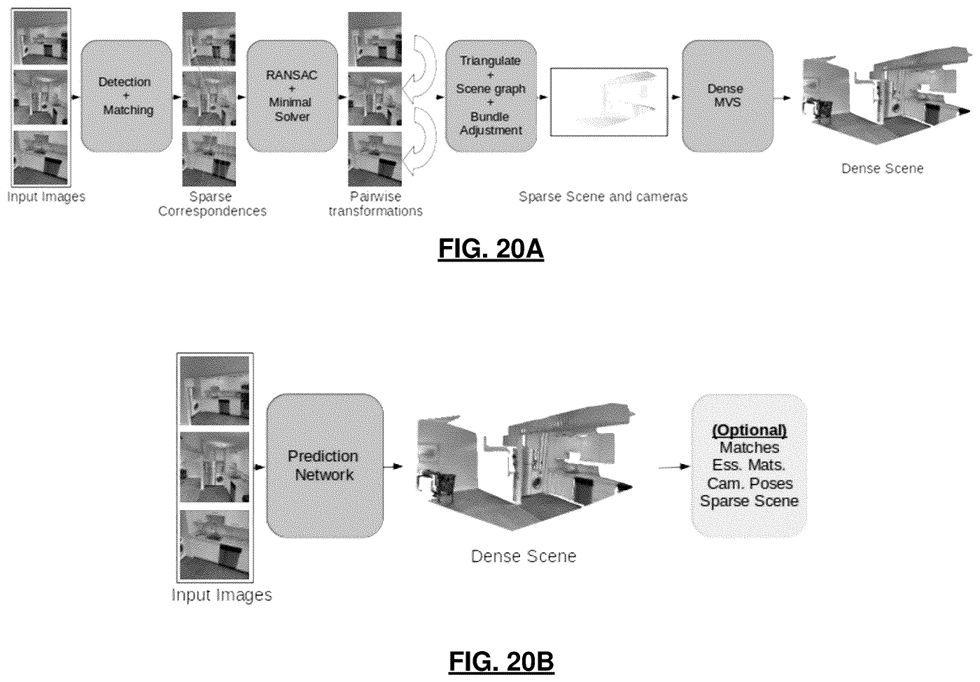

In real life, recovering accurate un-calibrated camera parameters from RGB images is still an open problem and is known to be extremely challenging, depending on the visual content and the acquisition scenario. Historically, tackling the problem as a whole has always been considered too hard of a task. This task may be split it into a hierarchy of simpler sub-problems, a.k.a., minimal problems, sequentially aggregated together, as shown in FIG. 20A, where each noisy estimation is aggregated to the next bigger sub-problem in a hierarchical manner in order to recover camera poses, that are finally used as input for the dense reconstruction. From a simplistic view, the pipeline for full MVS (e.g., recovering a dense scene representation from unknown cameras) amounts to: (i) detecting and matching keypoints; (ii) finding good pairwise essential matrix candidates (minimal-solver with RANSAC); (iii) performing bundle adjustment (build scene graph, triangulate points in 3D and optimize jointly for a sparse scene representation and the camera parameters); and (iv) building a dense scene representation. It is a viable solution for some settings, considering recent advances, yet it is found unsatisfactory: each sub-problem is not solved perfectly and adds noise to the next step, increasing the complexity and the engineering effort required for the pipeline to work as a whole. To name a few examples, missing detections and outliers in matching required the use of RANSAC with the minimal solvers. Again, camera parameters are noisy estimates and need refining along with the scene optimization. Lastly, there is rarely any communication between each sub-problem. It would be reasonable to assume that they should help each other (i.e., dense reconstruction should naturally benefit from the sparse scene that was built to recover camera poses, and vice-versa).

Proposed in this Section D is a shift in paradigm shown in FIG. 20B, which illustrates an approach that directly builds 3D representations from RGB observations without explicitly solving any sub-problem; using this approach it is possible to recover solutions of all sub-problems as a by-product of the prediction. A holistic approach is disclosed that tackles the maximal problem: considered are all possible matches between all images to directly build a 3D representation from the un-calibrated and un-posed images. Interestingly, it is possible to later extract from result the camera poses and other sub-problem solutions, as a by-product. Note that no reliance is made on hard camera models, RANSAC schemes, minimal solvers nor outliers filtering.

To this aim, a multi-modal and multi-view Vision Transformer (ViT) network (see Dosovitskiy et al.) is leveraged, that takes both the RGB images and a scene representations as input, similar to that of SACReg (see Revaud et al., “SACReg: Scene-agnostic coordinate regression for visual localization” in arXiv 2307.11702, 2023, which is hereinafter referred to as “SACReg”, which is incorporated herein in its entirety). In contrast however, it is embedded in a diffusion framework: starting from a random scene initialization, the disclosed network predicts scene updates, and iteratively converge towards a satisfactory reconstruction. As scene representation, view-wise pointmaps are leveraged, e.g., each pixel of each image stores the first 3D point that it observes. In terms of architecture, each image and pointmap are processed through a Siamese ViT encoder and are then mixed together in a single representation. A decoder module performs cross attention between views to allow for global scene reasoning. The outputs are the pointmap updates for all views of the scene. The disclosed model is trained in a fully-supervised manner, where the ground-truth annotations are synthetically generated, or ideally, captured using other modalities such as Time of Flight sensors, scanners. Experiments show that this approach is viable, the reconstructions are accurate and consistent between views in real-life scenarios with various unknown sensors. This disclosure demonstrates that the same architecture can handle real-life monocular 2102 and multi-view 2104 reconstruction scenarios seamlessly, even when the camera is not moving between frames, as seen in FIG. 21 which shows real data captured 2106 and reconstructed 2108 with a smartphone. To combat the computational complexity of higher number of images, an Image Retrieval (IR) tool may be used to sparsify the scene graph, e.g., views can only attend to the top-K most relevant views and not the whole database. This can also be used to perform MVS with more views than that seen during training, by leveraging an appropriate block-wise masking strategy.

Contributions are threefold: First, presented herein is a holistic end-to-end 3D reconstruction pipeline from uncalibrated and unposed images, that unifies monocular and multiview reconstruction. Second, introduced herein is the Pointmap representation for MVS applications, that enables the network to predict the 3D shape in a canonical frame, while preserving the implicit relationship between pixels and the scene. This effectively drop many constraints of the usual perspective camera formulation. Third, leveraged herein is the iterative nature of diffusion processes for MVS: Gaussian noise is gradually turned into a global and coherent scene representation. This is believed to be a milestone with a broader impact than simply performing 3D reconstructions, as elaborated in Section D.5 (below).

### Section D.2

Summarized in this Section are the main directions of MVS under the scope of geometric camera models.

MVS. Camera parameters may be considered to be explicit inputs to the reconstruction methods. MVS thus amounts to finding the surface along the defined rays, using the other views via triangulation. Be it the fully handcrafted, the more recent scene optimization based or learning based approaches, they all rely on perfect cameras obtained via complex calibration procedures, either during the data acquisition or using Structure-from-Motion approaches for in-the-wild reconstructions. Yet, in real-life scenarios, the inaccuracy of pre-estimated cameras can be detrimental for these algorithms to work properly. In various implementations, camera poses can be refined along with the dense reconstruction.

Refining the Cameras. Cameras may be refined by jointly optimizing for the scene and the cameras. The camera model may be a pinhole with known intrinsics, and the scene can be point clouds or implicit shape representations. These however are still limited and do not work well without either (i) strong assumptions about the camera motion and/or (ii) good initial camera intrinsics and poses. In fact, applying iterative optimization methods to camera parameters estimation may be prone to falling into sub-optimal local minima, and may only be effective when the current state is close to a good minimum. This is why SfM pipelines may use a hierarchy of sub-problems with RANSAC schemes in order to find valid solutions in the enormous search space, and only then try to optimize the scene and cameras jointly. Interestingly, explicit camera model formulations may be dropped, and more relaxed approaches may be used, purely driven by the data distribution, as explained in the following.

Implicit Camera Models. An idea regarding implicit camera models is to express shapes in a canonical space (e.g., not related to the input view points). Shapes can be stored as occupancy in regular grids, octree structures, collections of parametric surface elements, point clouds encoders, free-form deformation of template meshes or view-wise depthmaps. While they arguably perform classification and not actual 3D reconstruction, all-in-all, these approaches, may only work in very constrained setups, and have trouble generalizing to natural scenes with non object-centric views. The question of how to express a complex scene with several object instances in a single canonical frame had yet to be answered: in this Section D, the reconstruction is expressed in a canonical reference frame, but due to the disclosed scene representation (Pointmaps), a relationship between image pixels and the 3D space is preserved, and are able to reconstruct all the scene consistently.

Pointmaps. Using a collection of pointmaps as shape representation is counter-intuitive for MVS, but may be used for Visual Localization tasks, either in scene-dependent optimization approaches or scene-agnostic inference methods. Similarly, view-wise modeling may be used in monocular 3D reconstruction, the idea being to store the canonical 3D shape in multiple canonical views to work in image space. Explicit perspective camera geometry may be leveraged, via rendering of the canonical representation.

In this Section, the present disclosure involves leveraging pointmaps as a relaxation of the hard projective constraints of the usual camera models to directly predict 3D scenes from un-calibrated and un-posed cameras without ever enforcing projective rules. Predictions made herein are purely data-driven yet the outputs still respect the underlying camera geometry, even though no camera center nor ray behavior is explicitly specified.

### Section D.3 Method

### Section D.3.1 Scene Representation

One component that makes the disclosed systems and methods feasible is the scene representation S. A Pointmap representation is used herein, e.g., each pixel of each image stores the coordinates of the 3D point it observes. It is a one-to-one mapping between pixel coordinates and 3D points, assuming that occupancy is a binary information in 3D space, e.g., no transparency, nor double/triple points.

FIG. 22 illustrates how a pointmap can be seen simultaneously as a 3-channel image and a point cloud. More specifically, FIG. 22 depicts a scene representation 2202 where each image is associated with a pointmap 2204, that is a 2D grid with pixels containing respective 3D values, which may be visualized as RGB values, where each pixel is mapped to a 3D point, and where this 2D-3D mapping may also be visualized as a colored 3D point-cloud 2206. Hard camera model constraints may not be enforced during prediction, but it is possible to verify that the reconstruction respects perspective rules using Perspective-N-Points (PnP) algorithms, given that each 2D pixel is associated to a 3D point. Finally, the full scene S includes N≥1 views, each storing images and pointmaps S={Sⁱ}, i∈N that are all expressed in a common reference frame. Paradoxically, this representation allows for physically infeasible camera models with very few constraints regarding known camera geometry. In fact, this does not even assume that light rays travel in straight line as there is no notion of principal point. The philosophy behind is to allow the network to learn all relevant priors present in the training dataset, via a relaxed image formation model. All computations may happen in image space, thus the architecture includes ViT modules (e.g., for encoding), and no other complex architecture.

Leveraging priors. The disclosed systems and methods consider both the pointmaps and the images, thus are able to leverage 2D structure priors relevant to the scene, like the relationship between image RGB gradients and 3D shape properties. This gives the networks the ability to learn shape priors, like shape from texture, from defocus, from shading, or from contours. Importantly, it can also compare 3D values between views, that live in a common reference frame, which is of importance to leverage 3D priors of the scenes.

Fundamental Motivation Finally, the disclosed systems and methods may not rely on triangulation operations, which is in contrast to MVS. Triangulation may be noisy and inaccurate when rays are close to being colinear, i.e., when there is a very small camera translation between views. Even worse, it may collapse and be undefined when only a single view observes a region, or when rays are colinear (still camera, or pure rotation). Because triangulation involves parallax, triangluation may not be feasible when there is none or not enough. In contrast, the disclosed systems and methods can tackle pure rotations, still cameras and even the monocular case, in a common framework (see FIG. 21). Again, no camera model may be enforced rather they are purely data-driven in a soft manner: the output distribution will reflect the geometric constraints of the data, including hard projective geometry, complex distortion phenomena, rolling shutter effects, and can even handle scene motion, as long as the annotated ground-truth does.

### Section D.3.2 Reconstruction Via Diffusion

The camera pose estimation, and thus the reconstruction, may be performed in a 3D/4D world of arbitrary reference frame and scale. This means that infinitely many reconstructions may be valid explanations of the observed RGB data and one has to choose one at inference. In other words, a-priori the mapping between pixels and scene coordinates is not known. To tackle this problem, diffusion processes may be leveraged: an initial reference coordinate system is defined by sampling random pointmaps, in a normalized cube. At first all views will be inconsistent, but all coordinates live in the same 3D reference frame. The 3D diffusion process can then be seen as an update estimator, that iteratively optimizes the scene representation towards a valid solution. Image diversity may not sought but rather the present application is able to converge towards a sample in the infinite space of valid solutions. More formally, the disclosed diffusion model learn a series of state transitions, e.g., corrections, to map pure Gaussian noise S_{T} to S₀ that belongs to the target data distribution. A neural network is trained to reverse a Gaussian noising process that transforms S₀ to Sₜ s.t.:

$${S}_{t} = \sqrt{λ ( t )} {S}_{0} + \sqrt{1 - λ ( t )} ϵ \qquad ( D1 )$$

with ϵ˜N(0,I), and t˜U(0, T) a continuous variable. λ(t) is a function that monotonously decreases from 1 to 0, effectively blending the target S₀ with noise.

Training. Diffusion processes include predicting either the target S₀, the noise ϵ or the update S^{˜}₀ to apply at each step in v prediction convention (see Salimans et al, “Progressive distillation for fast sampling of diffusion models”, in ICLR, 2022). With no loss of generality, the present application may involve training a neural network f to predict S₀ from Sₜ, conditioned by the RGB observations c. This is possible as the update S_{t-Δ} may be derived from Sₜ and the predicted S^{˜}₀. The objective Lₛ_{₀}, minimized during training is a simple I₂ regression loss, in a fully supervised manner:

$${L}_{{x}_{o}} = {E}_{t ∼ U ( 0 , T ) , ϵ ∼ N ( 0 , 1 )} {‖ f ( {S}_{t} , c ) - {S}_{0} ‖}^{2} \qquad ( D2 )$$

In short, the network always tries to predict the target reconstruction.

Sampling. In order to generate samples from a learned model, a random sample S_{T} is drawn and a series of (reverse) state transitions S_{t-Δ} is iterated by applying the denoising function f(Sₜ, t, c) on each intermediate state Sₜ. Again, with no loss of generality, the updates can be performed using the transition rules described e.g., in DDPM (see Ho et al., “Denoising diffusion probabilistic models”, in NeurIPS, 2020), or DDIM (see Song et al., “Denoising diffusion implicit models”, in ICLR, 2021) for faster inference, which are incorporated herein in their entireties.

### Section D.3.3 Architecture

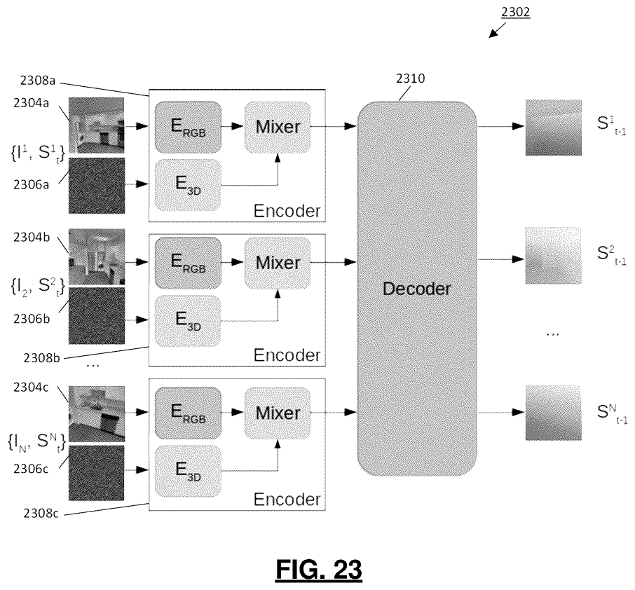

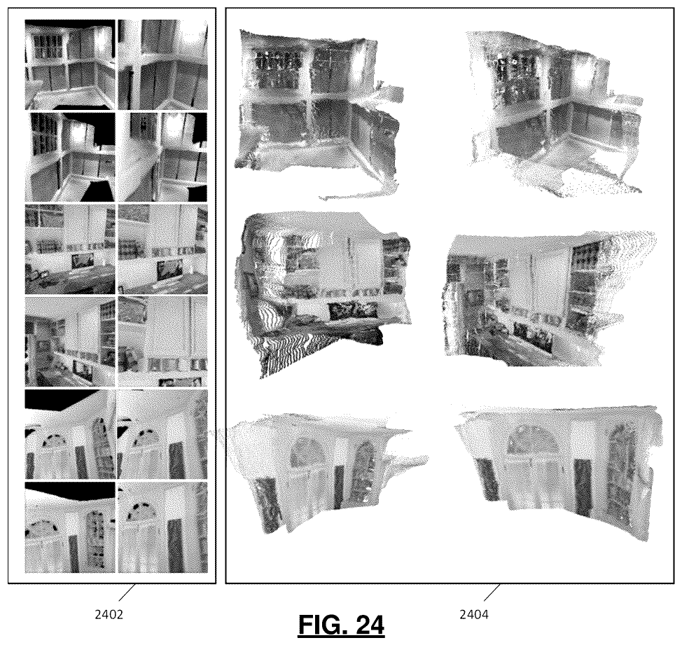

As depicted in FIG. 23, the disclosed network 2302 takes as input a collection of RGB images Iᵢ 2304 and pointmaps Sⁱ 2306, where at each step t of the diffusion process, the network 2302 looks at the current scene estimate {Iᵢ, Sₜⁱ}, i∈N (RGB+point maps); after the encoders 2308 jointly encode the appearance and the geometry of the scene in a Siamese manner, the decoder 2310 performs self-attention on each view and cross attention between each image and all the others to allow for local and global scene reasoning respectively; the output is an update of the current scene representation Sₜ₋₁ⁱ the decoder 2310 and E_{RGB} blocks of the encoders 2308 correspond to the architecture of CroCo while the Mixer and E_{3D} blocks of the encoders 2308 correspond to the SACReg mixer approach.

More specifically, the multiple view ViT architecture of CroCo is leveraged with a mixer block of the encoder 2308 to merge the different input modalities. Each image 2304 and each pointmap 2306 is encoded using a ViT encoder denoted E_{RGB} and E_{3D} respectively in the encoder 2308. For each view, both representations are mixed together using a Mixer module in the encoder 2308. This Mixer module also includes a ViT encoder equipped with cross attention: it updates the 3D representation of each view by cross-attending the RGB representation. All views are processed in a Siamese manner, meaning the weights of the encoders are shared for all views. From this encoder, N mixed representations are obtained. The network then reasons over all of them jointly in the decoder. Similar to CroCo, it is also a ViT, equipped with cross attention. It takes the representation of each view and sequentially performs self-attention (each token of a view attends to tokens of the same view) and cross-attention (each token of a view attends to all other tokens of other views). It was initially designed for pairwise tasks, but it can also cross-attend to more views by concatenating the tokens from other views. In a simplistic view, due to the global cross-attention, the network is able to reason over all possible matches between all views jointly, contrary to the classical approach that computes pairwise matches between sparse keypoints.

Positional Embedding. Similar to other known methods, Rotary Positional Embeddings (RoPE) (see Lu et al., “RoFormer: Enhanced transformer with rotary position embedding” arXiv pr2104.09864, 2021, which is incorporated herein in its entirety) may be leveraged. Each token could be associated to any other token in other view, meaning the relative displacement between views should not matter. In experiments herein, it can be seen that cross-attention may not benefit nor suffer from RoPE, and is optional for this layer.

Prediction Head. A dense prediction head is added on top of the decoder. The dense prediction head may be, for example, a linear projection head, i.e., a single layer after the decoder to transform the embeddings to 3D coordinates. It is possible to leverage DPT or other convolutional heads to this purpose, with no loss of generality.

### Section D.3.4 Training

The disclosed network is trained in a diffusion framework, in a fully supervised manner: the ground truth pointmaps associated to the RGB views is known. While it would be theoretically feasible to have a varying number of views for each batch during training, for simplicity, training is performed on N-tuples, where N may be between 1 and 4. Training for more views increases training complexity quickly and may become intractable. A more elegant solution for inference with more views is preferred as detailed in Section D.3.5. In case real data is used, it is not always possible to have dense annotations. To overcome this, the missing annotations may be set to a constant, and a mask on the input RGB values may be added (either a predefined RGB value or a binary mask as a 4th channel in the pointmap). The loss is masked on undefined 3D coordinates. The disclosed experiments show that, using this strategy, the network can handle undefined coordinates flawlessly. The weights of the encoders and decoders may be initialized with CroCo pretrained weights. Training for 560K steps with 4 views may be performed a single A100 GPU.

Data Augmentation. As usual, adding data augmentation may be performed to artificially increase the variability of the training data. As an example, the data augmentation may include applying a random 3D rotation to the pointmaps, in order to ensure a full coverage of the output distribution and achieve rotation equivariance. Additionally, RGB augmentations may be used such as color jitter, solarization, and style-transfer; simple geometric transformations that preserve chirality are also allowed, like scaling, cropping, rotations or perspective augmentations, as long as they are performed similarly onto the images and the pointmaps.

Win-Win. In the case of high resolution applications, training may be on N-tuples directly. However, it is possible to train the disclosed systems and methods for high resolution predictions using the Win-Win strategy (see Leroy et al., “Win-Win: Training high-resolution vision transformers from two windows”, ICLR 2023, which is incorporated herein in its entirety): at training time, each view only sees three square windows in a high resolution image, effectively decreasing the number of tokens for a more tractable training. The window selection ensures that a significant portion of the pixels observe similar 3D points, e.g., between 15 and 50%. At test time, temperatures of the softmax are quickly tuned for the expected output resolution.

### Section D.3.5 Inference

After training of the diffusion model, samples may be conditioned by the observations at test time. For simplicity, the resolution may be kept fixed (224×224 in the disclosed examples), but again, it is possible to leverage the windowed masking strategy of Win-Win strategy for inference in higher resolution with reduced training costs.

Simplest Inference. The training scenario may be: N-tuples are seen at test time. DDPM is leveraged for faster inference: a random initialization was drawn and 250 diffusion steps were performed (whereas 1000 steps were performed during training). In the case where less views are available at test time, the views to match the N-tuple size of training may be duplicated. For example, training may be performed with four views as seen in FIG. 21 at 2104. When a single image is available, it is input four times, resulting in four consistent predictions, as seen in FIG. 21 at 2102.

More Views. When more views are available at test time, all of them are input in the disclosed network and a block masking is applied in the cross attention, such that each view only attends the same number of views than seen during training. In practice, when trained with 4 views, the top-4 most similar views are computed using an Image Retrieval algorithm, and sparsify the complete attention matrix via block masking, such that the number of compared tokens in the cross attention remains the same as that of training.

Incremental Reconstruction. It is also possible to perform incremental reconstruction: a scene has already been reconstructed from N views, and a new view comes in. In this case, the existing reconstruction may not be updated, and only add the new view. At inference, thus the cross attention is modified such that only the new view queries the whole scene. This is in contrast to the scenario where the whole scene is cross-attending the whole scene. Still, starting occurs from a random scene initialization. At each time step, the new view with the network's prediction is updated, and all the other views are obtained via the Equation D1 of the diffusion process. This way, the prediction of the novel view is anchored on the existing scene model. When the existing model is a metric scene, it is first normalized in [α, 1−α] and the scaling factors are kept for un-normalization after prediction. α is a pre-determined constant that leaves “room” for the new view, in the case where it would increase the size of the bounding box of the scene.

MVS refinement. Note that scene refinement is also possible in a similar spirit. From a noisy or low resolution 3D scene, the scene may be converted to a pointmap representation and blend it with noise using the noising process (C1), taking t<T. It is now possible to refine the scene with a few diffusion iterations “resuming” the diffusion process from t and not from pure Gaussian noise. This will effectively anchor the reconstruction using the rough estimate.

Camera Localization. From any reconstruction, it is possible to recover the camera poses via PnP using a provided focal length f, as expected in a Visual Localization framework. This is possible since the pointmap representation associates pixel coordinates with 3D points. Also matches may be recovered between views by comparing the 3D coordinates of each pixels. Thus it is possible to extract Essential of Fundamental Matrices, and even a sparse scene by only keeping 3D points that are geometrically consistent. All sub-problems of the SfM pipeline from the direct prediction may thus be effectively solved.

### Section D.4 Experiments

For these experiments, training and testing occurred on a hard, synthetically generated, dataset. N multi-view images of thousands of scenes are rendered using a simulator, such as the Habitat Simulator. For each N-tuple, the camera relative positions and focal lengths are randomized during the data generation process. In more details, the Field Of View (FOV) varies between 18 and 100 degrees. The camera locations are adapted such that N-tuples reasonably overlap between each other, meaning that when focal lengths are drastically different, the relative displacement can be rather extreme compared to MVS (which most of time consists in small displacements with the same, or similar, sensors). Even though the dataset may be purely synthetic, it is extremely challenging, due to the focal length variation, with very ambiguous matching, lack of salient features, many planar and low-contrast regions. Training may be performed on 1 M N-tuples, and test on 1K samples, of scenes unseen during training. The encoders, mixer and decoder are all ViT-Base, and a linear prediction head was used for its simplicity.

A convolutional head may improve the results, but this is not the purpose of this disclosure.

### Section D.4.1 Quantitative Results

Because the reconstruction happens in a rotation- and scale-equivariant space, the prediction is re-aligned with the ground truth point cloud. Note that the latter is also expressed in the form of a pointmap, thus giving direct pixel-to-pixel correspondences. Performed may be a Procrustes alignment with scale, before measuring the reconstruction quality. Because it is a global alignment, any metric measured after alignment is a lower bound of the “true” metric over the whole reconstruction. Still, after visual inspection, the alignment is quite satisfactory so the metrics are still relevant for evaluation. The prediction in normalized space is aligned to the ground-truth in metric space, and in Table D-1 measures the average Euclidean distance over the whole reconstruction, as well as the average view-wise median, both after Procrustes Alignment (PA), where reconstruction error is in mm, under different scenarios: the monocular, binocular and multi-view setups.

TABLE D-1

| Setup | PA-L2 Mean | PA-L2 Median |
|---|---|---|
| 1-view | 35.2 | Not measured |
| 2-views | 25.6 | 21.2 |
| 4-views | 27.8 | 21.2 |

Note that these values are not directly comparable since they are not evaluated on the same number of views. These results prove that the approach is viable and that it is possible to directly reconstruct a scene from a collection of un-posed and un-calibrated cameras in a very challenging scenario.

### Section D.4.2 Qualitative Results

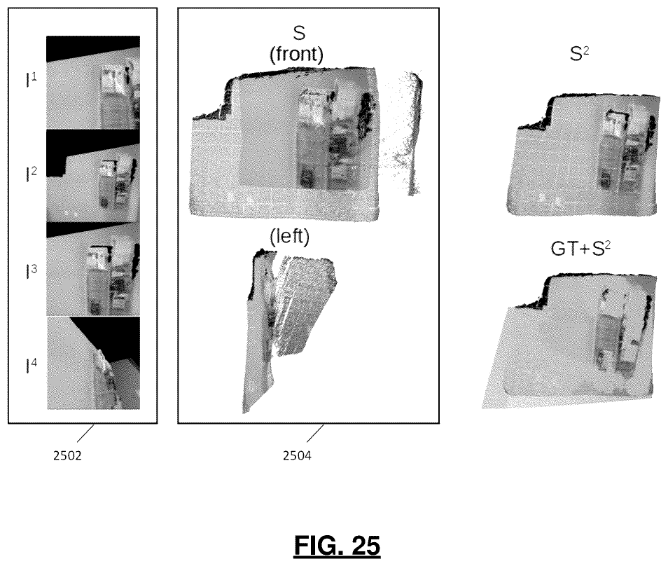

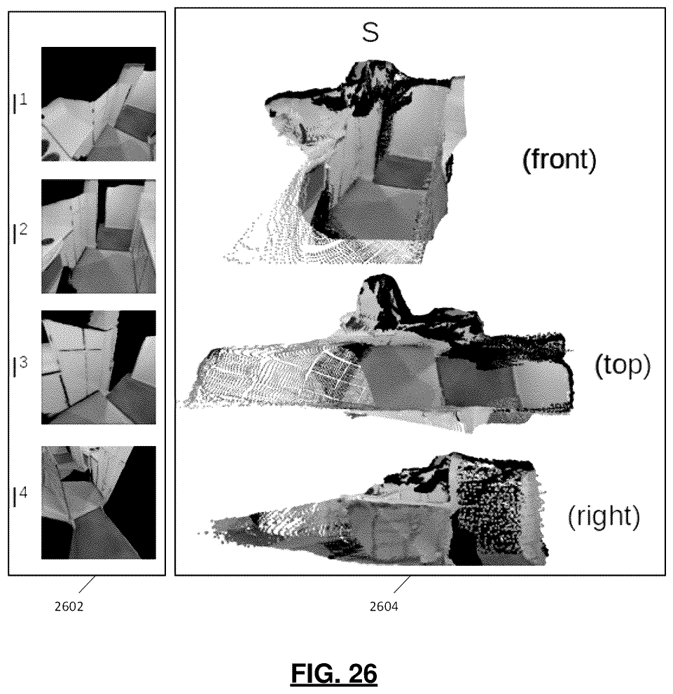

Qualitative results of the C-GAR network are shown in FIGS. 24, 25 and 26. FIG. 24 shows three sets of four input views 2402 reconstructed in a single consistent point cloud, viewed from two different angles 2404; the C-GAR approach is able to smoothly manage extreme view angle changes and displacements, with scarcely observed areas (e.g., the ceiling and the left wall of the 2nd row is only observed by a single camera). FIG. 25 shows four input views 2502 reconstructed in a single consistent point cloud 2504; the left and right walls are only observed by one view, yet they are very consistent: the left wall only seen by S² is extrapolated, and the plane overlays almost perfectly with the ground-truth; since there is very little content to guess the focal length properly, the perspective distortion is not perfectly recovered, yet the wall remains planar and consistent with the rest of the scene. FIG. 26 shows four input views 2602 reconstructed in a single consistent point cloud S 2604; black RGB values (masked in the training loss) are not perturbing the convergence, and the scene is faithfully reconstructed even from very few sparse views with large baselines, extreme orientation changes and varying focal lengths.

### Section D.4.3 Synthetic Data

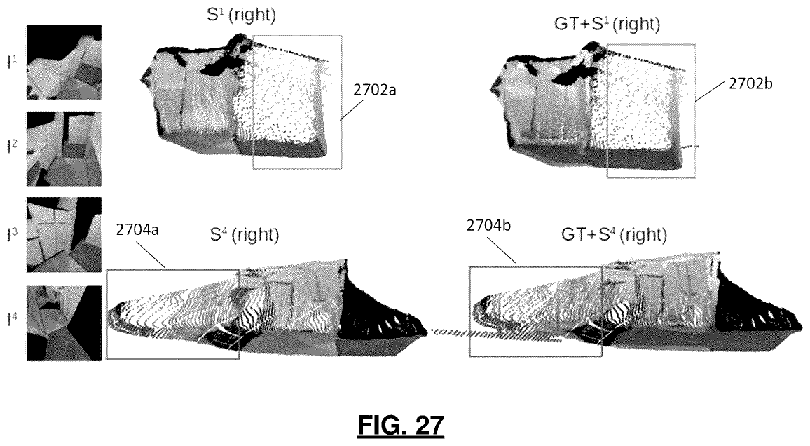

The predicted reconstructions obtained from the 4-view network on the test set, containing scenes and camera setups that were never observed during training, are reviewed. As depicted in FIG. 25, the reconstruction is consistent and faithful. Interestingly, the output point clouds roughly respect the camera geometry and the proportions of the objects in the scene. Angles between walls and floors is consistent with the ground-truth, as seen in FIG. 26. Importantly, the reconstruction aligns correctly between views, e.g., the planes of the walls and floors predicted by one view are consistently overlapping with the predictions from other views. The images contain masked (undefined) pixels, visualized in black. They do not interfere with the prediction as seen in FIG. 26, meaning that it is possible to train such method with sparse or incomplete annotations. Please note that the reconstruction is again particularly challenging, with very few images, large baselines, extreme viewpoint changes and varying focal lengths. For the latter, its impact is seen in FIG. 25 on the predicted pointmap for view 2, where the predicted perspective distortion does not exactly match that of the ground-truth: both bottom left corners do not end up exactly in the same 3D location. Yet, the predicted surface of the wall is consistent with other views and aligns almost perfectly with the ground truth. The C-GAR method seems to be especially robust to low-contrast regions and usually infers smooth planar regions when little image gradients are present, as depicted at 2702 in FIG. 27, where the pointmap reconstructed from one view I¹ correctly recovers the blank wall and the low-texture regions 2702, and in the case where only a single view observes an area 2704, it can still be reconstructed in a monocular fashion, relying only on shape and depth priors, but due to the ill-posedness of the task, the reconstruction suffers from depth ambiguity when there are few perspective cues or no “familiar” objects. This seems to be a reasonable behavior, that produces floors and walls at the correct depth and relative angles. Of course, when a single image observes a part of a scene and the scale and depth cannot be guessed from the data, the reconstruction is smooth but diverges from the expected output as shown at 2704 in FIG. 27.

### Section D.4.4 Real Data

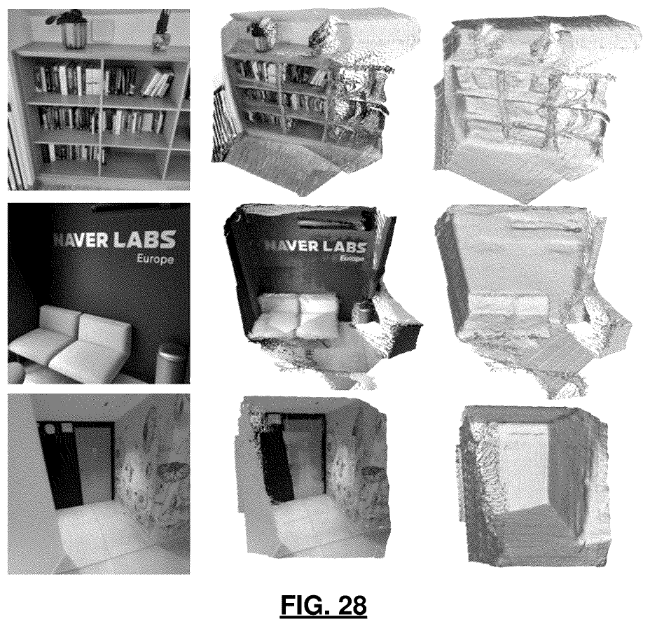

To further demonstrate the feasibility and effectiveness of the approach, the disclosed network (trained on synthetic 4-view data) is tested on real data. Several scenes of a room are reconstructed that were acquired with a handheld smartphone, downscaled and center-cropped at the network input resolution (224×224). This data is tested two scenarios: the monocular and multi-view setup. In the monocular case, instead of having a single image as input, the static camera case is simulated by replicating the image four times as input. The output is thus four pointmaps observed by the same camera. Interestingly, they are all very consistent and almost perfectly overlapping, as shown at 2108 in FIG. 21. The 4-view case 2104 is also quite convincing, the cafeteria sofas and the shelf are consistent with reality, with square angles and reasonable depths. As in previous observations, on the shelf scene, the left barrier, the floor and the slanted ceiling are barely observed, yet they are recovered nicely. Normals are visualized for clearer understanding of the geometry in FIG. 28. Specifically, in FIG. 28 images of real data are shown in the left column, approximate normals from the point cloud are shown in the right column are computed for clearer visualizations of the geometry of reconstructed scenes are shown in the middle. Finally, testing occurs with multiple unknown focal lengths in FIG. 29 using the C-GAR network: four input view points 2902 are taken from two viewpoints (columns) with both narrow and wide angle lenses (rows). Even with a model trained on 1M synthetic scenes, the reconstruction 2904 is consistent and the C-GAR network successfully manages to align the views regardless of the un-calibrated acquisition devices. The reconstructed scene 2904 respects the real world geometry even with drastic focal changes.

### Section D.5 Discussion

Stepping back. A scene representation may be expressed in a 3-dimensional (static scenes) or 4-dimensional (dynamic scenes) world. The former being a special case of the latter where the scene is constant through time. These can be point clouds, surface meshes, implicit forms, etc., but in all cases, a mapping between the 2D pixels and the 3D world is found in order to build these representation.

Coarsely put, geometric vision tasks include studying the mapping between 2D pixels and the world representation. For instance, static 3D reconstruction with depth maps aims at finding a one-to-one mapping between pixels and the observed surface points. In this case the surface is the interface of a binary indicator in 3D space whether matter is transparent (empty space) and opaque (matter to be found). This mapping idea extends to novel-view synthesis, where the mapping is now a one-to-many: each pixel is associated with a ray in 3D space, and it's appearance is the integration of scene colors weighted by the transparency, e.g., the relaxed equivalent of binary occupancy. Visual Localization, that includes recovering camera poses in a mapped environment, can also be expressed in the form of a one-to-many mapping to be found. While it may be cast as methods to recover relative poses (rotation and translation) with a known camera model (usually pinhole), it is possible to reformulate it as the task of finding, for the 2D pixels in the image, the set of 3D points seen by this pixel. Because light travels in straight lines at human scale, it amounts to finding the parameters of the rays that traverse the scene representation. Note that this may only be valid for static scenes however.

The disclosed philosophy. MVS may involve estimates of the camera parameters. Curiously, recovering approximate camera parameters in in MVX involves solving the reconstruction problem (SfM) to obtain the camera parameters, that are then used to solve the reconstruction problem. Also, because these camera models are theoretical formulations, they may never be perfectly accurate, even when including more elaborate distortion parameters. This means 3D reconstruction is a highly non-convex optimization problem solved using inexact camera model constraints. In this Section, it is shown that such constraints can be relaxed and that the maximal problem can be tackled as a whole. By not enforcing any camera model, the network learns robust priors about the image formation process (including complex distortions) while being able to leverage 2D priors due to the convolutional nature of the architecture, and 3D priors due to the global attention mechanisms. Again, the disclosed approach is robust to pure camera rotation and still/monocular scenes cameras, meaning that this Section effectively bridges monocular and multi-view reconstruction in a common framework.

Broader Impact. The present disclosure details significant steps toward a foundation model for geometric tasks: an input collection of images is used to build an explicit world representation. The fact that the output point clouds roughly respect the laws of projective geometry means that the network discovered a set of soft rules about the world, purely from the properties of the training data. Importantly for a foundation model, it is possible to extract from this output representation all the usual geometric measurements (i.e., downstream tasks). For instance, camera pose, depth, normals, 3D shape, and edges may be recovered. Adding RGB color to the pointmaps could even allow for view rendering via Gaussian Splatting approaches, if ever needed. In the context of autonomous navigation though, the explicit nature of this model may be explored: a well behaved navigating robot is expected to navigate properly in a complex environment, and the user might not care about the quality of it's pixel matching algorithm, or the geometric accuracy of its internal representation. For a capable agent, an explicit 3D model might not be the end result, but rather yet another intermediate step towards autonomous navigation. As for this Section, the intermediate representation might not need be explicit, and could instead be implicitly encoded in the network's representation. Yet, being able to output an explicit world model from the pretrained CroCo implicit representation is a clear indicator that the learned representation and matching mechanisms are relevant for geometric tasks. If another proof of CroCo's performance, the same approach with a random initialization struggles to converge and performs significantly worse.

Limitations. Predictions made herein live in a normalized 3D world, so there is no notion of scale. The disclosed systems and methods may have a quadratic dependency with respect to the number of views. This may become a complex for real-world navigation, e.g., in SLAM scenarios. Of course, Image Retrieval (IR) and/or keyframes can be relied on to sparsify the dense attention graph. A possible direction to overcome this problem would be to work with transformer networks that could access and update a fixed-size memory. With each incoming observation, the network would build or update an implicit world model, with fixed computational and memory complexity. The scene reconstruction would then be extracted from this representation, if ever needed. This approach would only have a linear complexity with respect to the number of frames, where the disclosed approach without retrieval has a quadratic dependency on the number of views.

### Section E. Unconstrained Structure-From-Motion

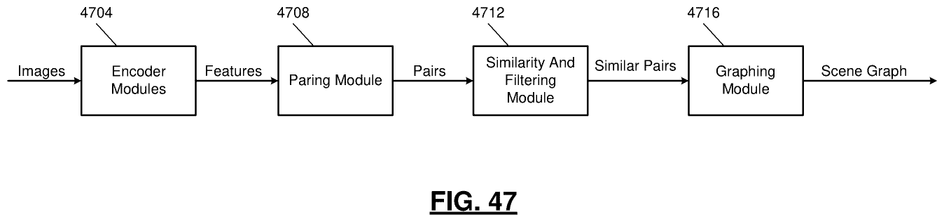

FIGS. 46 and 47 include functional block diagrams of an example implementation of the MASt3R architecture for SFM. FIG. 46 illustrates differences between this example and the example of FIG. 4. In FIG. 4, pairs of images are input to the neural networks 304. In the example of FIGS. 46 and 47, the unpaired images are input to the encoder module(s) 4704 of the neural network 304. The encoder module(s) 4704 may include ViT encoders or another suitable type of encoder. One encoder module may encode each of the input images to generate respective features, two or more encoder modules may encode ones of the input images to generate respective features, or one encoder module may be implemented per input image and encode its received image to generate the respective features of that image. The features may be vector representations of features in the images.

The number of possible unique pairs with a large number of input images, however, yields an even larger set of possible pairs of images. This makes the computational efficiency of SFM high.

According to the present application, a pairing module 4708 pairs sets of features for images and inputs the pairs to a similarity and filtering module 4712. The pairing module 4708 may determine and input each possible unique pair to the similarity and filtering module 4712.

The similarity and filtering module 4712 determines a similarity (e.g., value) between each pair received. The similarity may increase as closeness between the features of the respective input images increases and vice versa. The similarity and filtering module 4712 may determine the similarity, for example, using a cosine similarity (e.g., dot product) between the feature vectors of the pair or in another suitable manner.

For each input image (first image), the similarity and filtering module 4712 determines Y most similar input images to that first image based on the similarities for the pairs with the first image. Y is an integer greater than or equal to 1. For example, the similarity and filtering module 4712 may determine the Y most similar images to the first image based on those pairs having the Y highest similarity scores when paired with the first image. In various implementations, the similarity and filtering module 4712 may determine the Y most similar images, for example, using nearest neighbor searching as discussed herein. The similarity and filtering module 4712 discards the other pairs with the first input image and proceeds the same for each image as the first image. The similarity and filtering module 4712 provides the Y most similar images to each first image (and not the other pairs) to a graphing module 4716.

The graphing module 4716 generates a sparse scene graph from the similar pairs. An example sparse seen graph is illustrated by 4604 in FIG. 46. The decoder module(s) of the neural network 304 determine the pointmaps using the sparse scene graph, and the process continues as described above to determine the SFM result.

The present application involves a network that may be referred to as MASt3R-SfM, a fully-integrated SfM pipeline that can handle completely unconstrained input image collections, ranging from a single view to large-scale scenes, possibly without any information on camera motion. The network builds upon DUSt3R and more particularly on MASt3R that is able to perform local 3D reconstruction and matching in a single forward pass.

Since MASt3R processes each unique set of image pairs, it may computationally scale poorly to large image collections. The network of this patent application uses the frozen (indicated by a snow flake in FIG. 46) encoder(s) from MASt3R to perform fast image retrieval with negligible computational overhead, resulting in a scalable SfM method with quasi-linear complexity in the number of images. Thanks to the robustness of MASt3R to outliers, the proposed systems and methods can operate without the use RANSAC.

The SfM optimization is carried out by the network in two successive gradient descents based on frozen local reconstructions output by MASt3R: first, using a matching loss in 3D space; then with a 2D reprojection loss to refine the previous estimate. Interestingly, the systems and methods described herein go beyond SFM, as it works even when there is no motion (purely rotational case).

In summary, the examples of FIGS. 46-47 provide at least three improvements. First, the MASt3R-SfM network is a full-fledged SfM pipeline able to process unconstrained (in size) image collections. To achieve linear complexity in the number of images, the present application details how the encoder from MASt3R can be exploited for large-scale image retrieval. The SfM pipeline is training-free, provided an off-the-shelf functional SFM network.

As described above, SFM involves matching and Bundle Adjustment (BA). Matching involves the task of finding pixel correspondences across different images observing the same 3D points. Matching builds the basis to formulate a loss function to minimize during BA. BA aims at minimizing reprojection errors for the correspondences extracted during the matching phase by jointly optimizing the positions of 3D point and camera parameters. It may be expressed a non-linear least squares problem. By triangulating 3D points to provide an initial estimate for BA, incrementally built may be a scene, adding images one by one by formulating hypothesis and discarding the ones that are not verified by the current scene state. Due to the large number of outliers, and the fact that the structure of other pipelines propagate errors rather than fix them, robust estimators like RANSAC may be used for relative pose estimation, keypoint track construction and multi-view triangulation. The architecture of the present application, however, enables the non-use of RANSAC.

Since matching is used in other SfM options, it has a quadratic complexity which becomes prohibitive for large image collections. The present application, however, involves comparing the image features of pairs as described above. Image matching is cascaded in two steps: first, a coarse but fast comparison is carried out between all possible pairs (e.g., by computing the similarity between global image descriptors/features as discussed above), and for image pairs that are similar enough (e.g., similarity greater than a threshold), a second stage of keypoint matching is then carried out. This is much faster and scalable. The frozen MASt3R's encoder(s) are used to generate features, considering the (token) features as local features and directly performing efficient retrieval, such as with Aggregated Selective Match Kernels (ASMK), by Tolias, Avrithis, and Jégou, 2013, which is incorporated herein in its entirety.

MASt3R model which, given two input images Iⁿ, I^{m}∈ [symbol] ^{H×W×3}, performs joint local 3D reconstruction and pixel-wise matching as discussed above. As discussed above, it is assumed here for simplicity that all images have the same pixel resolution W×H, but the present application is also applicable to images of different resolutions.

MASt3R can be viewed as a function

$$f ( {I}^{n} , {I}^{m} ) ≡ D e c ( E nc ( {I}^{n} ) , Enc ( {I}^{m} ) ) ,$$

where Enc(I)→F denotes the Siamese ViT encoder that represents image I as a feature map (e.g., vector) of dimension d, width w and height h, F∈ [symbol] ^{h×w×d}, and Dec(Fⁿ, F^{m}) denotes twin ViT decoders that regress pixel-wise pointmaps X and local features D for each image, as well as their respective corresponding confidence maps. These outputs intrinsically include rich geometric information from the scene, to the extent that camera intrinsics and (metric) depthmaps can straightforwardly be recovered from the pointmap. Likewise, sparse correspondences (or matches) can be recovered by application of the fastNN algorithm described in Vincent Leroy, et al., Grounding Image Matching in 3D with Mast3r, ECCV, 2024, which is incorporated herein in its entirety, with the regressed local feature maps Dⁿ, D^{m}. More specifically, the fastNN searches for a subset of reciprocal correspondences from two feature maps Dⁿ and D^{m} by initializing seeds on a regular pixel grid and iteratively converging to mutual correspondences. These correspondences between Iⁿ and I^{m} are denoted as [symbol] ^{n,m}= [symbol] , where y_{c}ⁿ, y_{c}^{m}∈ [symbol] ² denotes a pair of matching pixels.

Given an unordered collection of N images [symbol] ={Iⁿ}_{1≤n≤N} of a static 3D scene, captured with respective cameras [symbol] ₙ=(Kₙ, Pₙ), where Kₙ∈R^{3×3} denotes the intrinsic parameters (calibration in term of focal length and principal point) and Pₙ∈R^{4×4} its world-to-camera pose, a goal is to recover all cameras parameters { [symbol] ₙ} as well as the underlying 3D scene geometry {Xⁿ}, with Xⁿ∈ [symbol] ^{W×H×3} a pointmap relating each pixel y=(i, j)∈ [symbol] ² from Iⁿ to its corresponding 3D point X_{i,j}ⁿ in the scene expressed in a world coordinate system.

The largescale 3D reconstruction approach is illustrated in FIG. 46 and includes four portions. First, the graphing module 4716 constructs a co-visibility scene graph using efficient and scalable image retrieval techniques as discussed above. Edges of this graph connect pairs of likely-overlapping (and therefore similar) images. Second, the decoder(s) perform pairwise local 3D reconstruction and matching for each edge of this graph. Third, the global aligner 407 coarsely aligns every local pointmap in the same world coordinate system using gradient descent with a matching loss in 3D space. This serves as initialization for the fourth step, where the global aligner 407 performs a second stage of global optimization, this time minimizing 2D pixel reprojection errors. Each step is detailed below.

### Scene Graph

The network first aims at spatially relating scene objects seen under different viewpoints. The present application feeds a small but sufficient subset of all possible pairs to the graphing module 4716 which forms a scene graph [symbol] . Formally, [symbol] =( [symbol] , ε) is a graph where each vertex I∈ [symbol] is an image, and each edge e=(n, m)∈ε is an undirected connection between two likely-overlapping images Iⁿ and I^{m}. Importantly, [symbol] has a single connected component, all images are (perhaps indirectly) linked together.

Image retrieval. To select the right subset of pairs, the similarity and filtering module 4712 uses a scalable pairwise image matcher h(Iⁿ, I^{m}) [symbol] s, able to predict the approximate co-visibility score s∈[0,1] between two images Iⁿ and I^{m}. This may be done using the encoder(s) Enc(⋅). The encoder module(s) 4704, the pairing module 4708, and the similarity and filtering module 4712 may be implemented within the encoder in various implementations. The encoder, due to its role of laying foundations for the decoder, is implicitly trained for image matching. To that aim, ASMK image retrieval method may be used considering the token features output by the encoder as local features. Generally speaking, the output F of the encoder can be considered as a bag of local features, and the encoder may apply feature whitening, quantize them according to a codebook previously obtained by k-means clustering, then aggregate and binarize the residuals for each codebook element, thus yielding high-dimensional sparse binary representations. The ASMK similarity between two image representations can be computed by summing an (e.g., small) kernel function on binary representations over the common codebook elements. Note that this method is training-free, only involving the determination of the whitening matrix and the codebook once from a representative set of features. In various implementations, a projector may be included in the encoder on top of the encoder features following the HOW approach described in Giorgos Tolias, et al., Learning and Aggregating Deep Local Descriptors For Instance-Level Recognition, ECCV, 2020, which is incorporated herein in its entirety.

The output from the retrieval step may be a similarity matrix S∈[0,1]^{N×N}.

Graph construction. To get a small number of pairs while still ensuring a single connected component, the graphing module 4716 may build the graph [symbol] as follows. The graphing module 4716 may first select a fixed number N_{α} of key images (or keyframes), such as using farthest point sampling (FPS) based on S. FPS is described in Yuval Eldar, et al., The Farthest Point Strategy for Progressive Image Sampling, ICPR, 1994, which is incorporated herein in its entirety.

These keyframes provide a core set of nodes and are densely connected together. All remaining images are then connected by the graphing module 4716 to their closest keyframe as well as their k nearest neighbors according to S. The graph includes 0(N_{α}²+(k+1)N)=O(N)<<O(N²) edges, which is linear in the number of images N. In various implementations, N_{α}=20 and k=10, although the present application is also applicable to other suitable values. While the retrieval step has quadratic complexity in theory, it is extremely fast and scalable in practice.

### Local Reconstruction

The inference of decoder of MASt3R is executed for every pair e=(n, m)∈ε, yielding raw pointmaps and sparse pixel matches [symbol] ^{n,m}. Since MASt3R may be order-dependent in terms of its input, [symbol] ^{n,m} may be the union of correspondences obtained by running both f(Iⁿ, I^{m}) and f(I^{m}, Iⁿ). Doing so, also obtains pointmaps X^{n,n}, X^{n,m}, X^{n,m}, X^{m,n} and X^{m,m}, where X^{n,m}∈ [symbol] ^{H×W×3} denotes a 2D-to-3D mapping from pixels of image Iⁿ to 3D points in the coordinate system of image I^{m}. Since the encoder features {Fⁿ}_{n=1 . . . N} have already been extracted and cached during scene graph construction, a ViT decoder Dec( ) only is executed, which substantially saves time and increases computational efficiency.

Canonical pointmaps. The network estimates an initial depthmap Zⁿ and camera intrinsics Kₙ for each image Iⁿ. These can be recovered from a raw pointmap X^{n,n}, such as described in S. Wang et al., Dust3r; Geometric 3D Vision made Easy, CVPR, 2024, which is incorporated herein in its entirety. However, each pair (n, ⋅) or (⋅, n)∈ε may yield its own estimate of X^{n,n}. To average out regression imprecision, the decoder may aggregate these pointmaps into a canonical pointmap \tilde{X}ⁿ. Let εⁿ={e|e∈ε∧n∈e} be the set of all edges connected to image Iⁿ. For each edge e∈εⁿ, there is a different estimate of X^{n,n} and its respective confidence maps C^{n,n}, which will be denoted as X^{n,e} and C^{n,e} in the following. The decoder may determine the canonical pointmap as a per-pixel weighted average of all estimates:

$${\tilde{X}}_{i , j}^{n} = \frac{{\sum }_{e ∈ {ℰ}^{n}} {C}_{i , j}^{n , e} {X}_{i , j}^{n , e}}{{\sum }_{e ∈ {ℰ}^{n}} {C}_{i , j}^{n , e}} .$$

From it, the decoder can recover the canonical depthmap \tilde{Z}ⁿ=\tilde{X}_{:,:,3}ⁿ and the focal length, such as using Weiszfeld algorithm as described in S. Wang et al., Dust3r; Geometric 3D Vision made Easy, CVPR, 2024, which is incorporated herein in its entirety, such as using:

$${f}^{*} = arg {min}_{f} {\sum }_{i , j} ‖ ( i - \frac{W}{2} , j - \frac{H}{2} ) - f ( \frac{{\tilde{X}}_{i , j , 1}^{n}}{{\tilde{X}}_{i , j , 3}^{n}} , \frac{{\tilde{X}}_{i , j , 2}^{n}}{{\tilde{X}}_{i , j , 3}^{n}} ) ‖ ,$$

which, assuming centered principal point and square pixels, yields the canonical intrinsics \tilde{K}ⁿ. A pinhole camera model may be assumed without lens distortion, the present application is also applicable to other camera types.

Constrained pointmaps. Camera intrinsics K, extrinsics P and depthmaps Z will serve as basic ingredients (or rather, optimization variables) for the global reconstruction phase performed by the 3D reconstruction module 310. Let πₙ: [symbol] denote the reprojection function onto the camera screen of Iⁿ, πₙ(x)=Kₙ Pₙ σₙx for a 3D point x∈ [symbol] ³ (σ_n>0) is a per-camera scale factor. In various implementations, scaled rigid transformations may be used. To ensure that pointmaps satisfy the pinhole projective model (they may be over-parameterized), a constrained pointmap may be defined χⁿ∈ [symbol] ^{H×W×3} explicitly as a function of Kₙ, Pₙ, σₙ and Zⁿ. Formally, the 3D point χ_{i,j}ⁿ seen at pixel (i, j) of image Iⁿ is defined using inverse reprojection as

$${χ}_{i , j}^{n} = {π}_{n}^{- 1} ( {σ}_{n} , {K}_{n} , {P}_{n} , {Z}_{i , j}^{n} ) = 1 / {σ}_{n} {P}_{m}^{- 1} {{Z}_{i , j}^{n} [ i , j , 1 ]}^{⊤} .$$

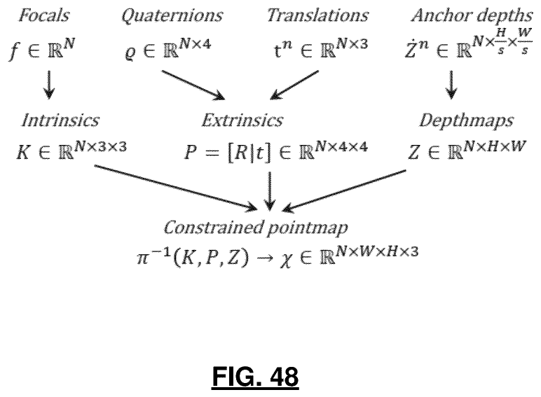

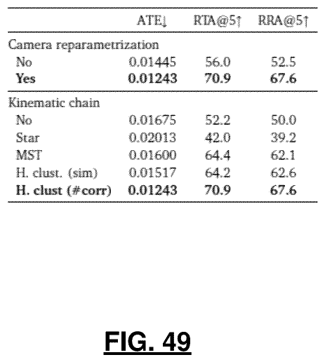

FIG. 48 includes an example illustration of constructing the constrained pointmap. Free variables on the top row serve to construct (are the basis for the generation of) the constrained pointmap χ, which follows the pinhole camera model by design and onto which the loss functions are defined.

DUSt3R introduced a global alignment procedure aiming to rigidly move dense pointmaps in a world coordinate system based on pairwise relationships between them. In this application, this procedure is simplified and made computationally more efficient by taking advantage of pixel correspondences, thereby reducing the overall number of parameters and its memory and computational footprint.

Specifically, the global aligner 407 determines the scaled rigid transformations σ*, P* of every canonical pointmaps χ=π⁻¹(σ, \tilde{K}, P, \tilde{Z}) (fixing intrinsics K=K and depth Z=\tilde{Z} to their canonical values) such that any pair of matching 3D points gets as close as possible:

$${σ}^{*} , {P}^{*} = arg {min}_{σ , P} {{\sum }_{c ∈ {ℳ}^{n , m}}}_{( n , m ) ∈ ε} {q}_{c} {‖ {χ}_{c}^{n} - {χ}_{c}^{m} ‖}^{{λ}_{1}} ,$$

where c denotes the matching pixels in each respective image by a slight abuse of notation. In contrast to the global alignment procedure in DUSt3R, this minimization only applies to sparse pixel correspondences y_{c}ⁿ↔y_{c}^{m} weighted by their respective confidence q_{c}. To avoid solutions, the global aligner module 407 enforce

$${min}_{n} {σ}_{n} = 1$$

by reparameterizing

$${σ}_{n} = \frac{{σ}_{n}^{′}}{{min}_{n} {σ}_{n}^{′}} .$$

The global aligner module 407 may minimize this objective using the Adam optimizer for a fixed number v₁ of iterations.

Coarse alignment converges well and fast in practice, but may be restricted to rigid motion of canonical pointmaps. Unfortunately, pointmaps may be noisy due to depth ambiguities during local reconstruction. To further refine cameras and scene geometry, the global aligner 407 may perform a second global optimization, similar to bundle adjustment, with gradient descent for v₂ iterations and starting from the coarse solution σ*, P* obtained above. In other words, the global aligner module 407 may minimize the 2D reprojection error of 3D points in all cameras:

$${Z}^{*} , {K}^{*} , {P}^{*} , {σ}^{*} = arg {min}_{Z , K , P , σ} {ℒ}_{2} , with$$

$${ℒ}_{2} = {{\sum }_{c ∈ {ℳ}^{n , m}}}_{( n , m ) ∈ ε} {q}_{c} [ ρ ( {y}_{c}^{n} - {π}_{n} ( {χ}_{c}^{m} ) ) + ρ ( {y}_{c}^{m} - {π}_{m} ( {χ}_{c}^{n} ) ) ] ,$$

with ρ: [symbol] a robust error function able to deal with potential outliers among all extracted correspondences. In various implementations, ρ(x)=|x|^{λ}^{₂} with 0<λ₂≤1 (λ₂=0.5). Other suitable parameters may be used however.

Optimizing may have a little effect, possibly because sparse pixel correspondences [symbol] ^{m,n} are rarely exactly overlapping across several pairs. As an illustration, two correspondences y_{.,.}^{m}↔y_{i,j}ⁿ and y_{i+1,j}ⁿ≃y_{.,.}^{l} from image pairs (m, n) and (n, l) would independently optimize the two 3D points χ_{i,j}ⁿ and χ_{i+1,j}ⁿ, possibly moving them very far apart despite this being very unlikely as (i, j)≃(i+1, j). SfM may resort to forming point tracks, which is relatively straightforward with keypoint-based matching. In the present application, the global aligner module 407 forms pseudo-tracks by creating anchor points and rigidly tying together every pixel with their closest anchor point. This way, correspondences that do not overlap exactly are still both tied to the same anchor point with a high probability. Formally, anchor points with a regular pixel grid \dot{y}∈

$${ℝ}^{\frac{W}{s} \times \frac{H}{s} \times 2}$$

spaced by δ pixels are defined as:

$${\dot{y}}_{u , v} = ( u δ + \frac{δ}{2} , v δ + \frac{δ}{2} ) .$$

The global aligner module 407 may then tie each pixel (i, j) in Iⁿ with its closest anchor \dot{y}_{u,v} at coordinate

$$( u , v ) = ( ⌊ \frac{i}{δ} ⌋ , ⌊ \frac{j}{δ} ⌋ ) .$$

Concretely, the global aligner module 407 may index the depth value at pixel (i, j) to the depth value Ż_{u,v} of its anchor point, and defined may be Z_{i,j}=o_{i,j}Ż_{u,v} where

$${o}_{i , j} = \frac{{\tilde{z}}_{i , j}}{{\tilde{z}}_{u , v}}$$

is a constant relative depth offset calculated at initialization from the canonical depthmap \tilde{Z}. Here, assumed may be that canonical depthmaps are locally accurate. All in all, optimizing a depthmap Zⁿ∈ [symbol] ^{W×H} thus may come down to optimizing a reduced set of anchor depth values Żⁿ∈

$${ℝ}^{\frac{W}{δ} \times \frac{H}{δ}}$$

(reduced by a factor of 64 if δ=8).

When building the sparse scene graph, in various implementations N_{α}=20 anchor images and k=10 non-anchor nearest neighbors may be used. In various implementations, a grid spacing of δ=8 pixels for extracting sparse correspondences with FastNN and defining anchor points may be used. For the two gradient descents, in various implementations the Adam optimizer may be used with a learning rate of 0.07 (resp. 0.014) for v₁=300 iterations and λ₁=1.5 (resp. v₂=300 and λ₂=0.5) for the coarse (respectively refinement) optimization, each time with a cosine learning rate schedule and without weight decay. While examples are provided, the present application is also applicable to other examples. Shared intrinsics and optimizing a shared per-scene focal parameter may be assumed for all cameras may be used.

Other methods may crash when dealing with large sets of input images due to insufficient memory despite using 80 GB GPUs. Regardless, even choosing sets of input images that do not cause crashing, the present application performs better than other methods.

As described above, the graphing module may generate the scene graph based on the similarity matrix. Generating the scene graph includes building a small but complete graph of keyframes, and then connecting each image with the closest keyframe and with k nearest non-keyframes. In various implementations, k=13 to compensate for the missing edges. In various implementations, the scene graph can be generated using only the keyframes (k=0). Generating the scene graph to include short-range (k-NN) and long-range (keyframes k=0) connections provides high performance.

Above discusses the use of ASMK on the token features output from the MASt3R encoder, after applying whitening. In various implementations, a global descriptor representation per image may be used with a cosine similarity between image representations as also discussed above. As discussed above, in various implementations, a projector is learned on top of the frozen MASt3R encoder feature with ASMK, following an approach similar to HOW for training.

In various implementations, the whitening may include PCA-whitening. In various implementations, the training module may train the examples of FIGS. 46-47 with a global representation obtained by a weighted sum of local features. For the training, the training module may determine the overlap in terms of 3D points between these image pairs, and consider as positive pairs any pair with more than 10% overlap, and as negatives pairs coming from two different sequences or datasets.

In various implementations, the optimization of anchor depth values (fixing depth to the canonical depthmaps) may be disabled. This may improve performance.

Regarding generating the scene graphs, increasing the number of key images (N_{α}) or nearest neighbors (k) may improve performance. The improvements however may saturate above N_{α}≥20 or k≥10.

A good parameterization of cameras can accelerate convergence. Above is described a camera [symbol] ₙ=(Kₙ, Pₙ) classically as intrinsic and extrinsic parameters, where:

$$\begin{matrix}{K}_{n} = [ \begin{matrix}{f}_{n} & 0 & {c}_{x} \\ 0 & {f}_{n} & {c}_{y} \\ 0 & 0 & 1\end{matrix} ] ∈ {ℝ}^{3 \times 3} , \\ {P}_{n} = [ \begin{matrix}{R}_{n} & {t}_{n} \\ 0 & 1\end{matrix} ] ∈ {ℝ}^{4 \times 4} .\end{matrix}$$

Here, fₙ>0 denotes the camera focal,

$$( {c}_{x} , {c}_{y} ) = ( \frac{w}{2} , \frac{H}{2} )$$

is the optical center, Rₙ∈ [symbol] ^{3×3} is a rotation matrix typically represented as a quaternion qₙ∈ [symbol] ⁴ internally, and tₙ∈ [symbol] ³ is a translation.

Camera parameterization. During optimization, 3D points are constructed by the global aligner module 407 using the inverse reprojection function π⁻¹(⋅) as a function of the camera intrinsics Kₙ, extrinsics Pₙ, pixel coordinates and depthmaps Zⁿ. Small changes in the extrinsics however can induce larger changes in the reconstructed 3D points. For example, small noise on the rotation Rₙ can result in a potentially large absolute motion of 3D points, motion whose amplitude would be proportional to the points' distance to camera (their depth).

The present application may therefore reparameterize cameras so as to better balance the variations between camera parameters and 3D points. To do so, the global aligner module 407 may switch (or change) the camera rotation center from the optical center to a point ‘in the middle’ of the 3D point-cloud generated by this camera, such as, at the intersection of the \vec{z} vector from the camera center and the median depth plane or within a predetermined distance of the median depth plane. In more details, the global aligner module 407 may determine the extrinsics Pₙ using a fixed post-translation Tₙ∈ [symbol] ⁴ on the z-axis as

$${P}_{n} {=}^{def {T}_{n} {P}_{n}^{′}} ,$$

with

$${\tilde{T}}_{n} = [ \begin{matrix}1 & 0 & 0 & 0 \\ 0 & 1 & 0 & 0 \\ 0 & 0 & 1 & {\tilde{m}}_{n}^{z} \\ 0 & 0 & 0 & 1\end{matrix} ] ,$$

where

$${\tilde{m}}_{n}^{z} = \frac{median ( {\tilde{Z}}^{n} ) {f}_{n}}{{\tilde{f}}_{n}}$$

is the median canonical depth for image Iⁿ modulated by the ratio of the current focal length the canonical focal \tilde{f}ₙ, and P′ₙ is again parameterized as a quaternion and a translation. This way, rotation and translation noise in Rₙ are naturally compensated and have a lot less impact on the positions of the reconstructed 3D points. FIG. 49 includes an example table illustrating the effectiveness of the reparameterization of the camera.

Kinematic chain. A second source of potentially undesirable correlations between camera parameters stems from the intricate relationship between overlapping viewpoints. If two views overlap, then modifying the position or rotation of one camera will most likely also result in a similar modification of the second camera, since the modification will impact the 3D points shared by both cameras. Thus, instead of representing all cameras independently, the present application involves expressing the cameras relative to each other using a kinematic chain. This naturally conveys the idea than modifying one camera will impact the other cameras by design. In practice, the global aligner module 407 defines a kinematic tree [symbol] over all cameras [symbol] , [symbol] consists of a single root node r∈ [symbol] and a set of directed edges (n→m)∈ [symbol] , with | [symbol] |=N−1 since [symbol] is a tree. The pose of all cameras is then computed in sequence, starting from the root as

$$∀ ( n \to m ) ∈ 𝒟 , {P}_{m} = {P}_{n \to m} {P}_{n} .$$

Different strategies may be used to build the kinematic tree [symbol] as shown in FIG. 49. ‘Star’ refers to a baseline where N−1 cameras are connected to the root camera, which performs even worse than a classical parameterization; ‘MST’ denotes a kinematic tree defined as maximum spanning tree over the similarity matrix S; and ‘H. clust.’ refers to a tree formed by hierarchical clustering using either raw similarities from image retrieval or actual number of correspondences after the pairwise forward with MASt3R. FIG. 49 illustrates the importance of a balanced graph with approximately log₂ (N) levels (in comparison, a star-tree has just 1 level, while a MST tree can potentially have a maximum of N/2 levels). Note that the sparse scene graph [symbol] and the kinematic tree [symbol] may share no relation other than being defined over the same set of nodes.

The above regarding FIGS. 46-49 essentially enable the generation of structure (e.g., 3D reconstruction of the scene) without motion.

### Section F. General

The components described herein functionally may be referred to as modules. For example, an encoder may be referred to as an encoder module, a decoder may be referred to as a decoder module, etc.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A computer-implemented method for reconstructing a scene in three dimensions from a plurality of images of one or more viewpoints of the scene acquired using an imaging device, comprising:
receiving the plurality of images without receiving extrinsic or intrinsic properties of the imaging device; and
processing the plurality of images using a neural network to produce a plurality of pointmaps of the scene that correspond to the plurality of images and that are aligned in a common coordinate frame,
wherein each pointmap is a one-to-one mapping between pixels of one of the plurality of images and three-dimensional points of the scene.

2. The computer-implemented method according to claim 1, wherein the processing the plurality of images using the neural network further includes:
processing the plurality of images using the neural network to produce a plurality of local feature maps that correspond to each of the plurality of images.

3. The computer-implemented method according to claim 2, further comprising performing one of the following applications using the plurality of pointmaps of the scene:
(i) rendering a pointcloud of the scene for a given camera pose;
(ii) recovering camera parameters of the scene;
(iii) recovering depth maps of the scene for a given camera pose; and
(iv) recovering three dimensional meshes of the scene.

4. The computer-implemented method according to claim 3, further comprising performing visual localization in the scene using the recovered camera parameters.

5. The computer-implemented method according to claim 1, wherein the processing the plurality of images using the neural network further includes:
processing a plurality of image subsets of the plurality of images using the neural network, wherein each image subset of the plurality of image subsets includes different ones of the plurality of images; and
aligning pointmaps from the plurality of image subsets into the plurality of pointmaps that are aligned in the common coordinate frame using a global aligner that performs regression based alignment.

6. The computer-implemented method according to claim 2, wherein the processing the plurality of images using the neural network further includes:
processing a plurality of image subsets of the plurality of images using the neural network, wherein each image subset of the plurality of image subsets includes different ones of the plurality of images; and
aligning pointmaps from the plurality of image subsets into the plurality of pointmaps that are aligned in the common coordinate frame using an alignment module that performs pixel correspondence based alignment using the plurality of local feature maps.

7. The computer-implemented method according to claim 1, wherein the processing the plurality of images using the neural network further includes:
(a) for each of the plurality of images: (i) generating patches with a pre-encoder; (ii) encoding the generated patches with a transformer encoder to define token encodings that represent the generated patches; and (iii) decoding the token encodings with a transformer decoder to generate token decodings;
(b1) for one of the token decodings, generating a pointmap corresponding to one of the plurality of images with a first regression head that produces pointmaps in a coordinate frame of the one of the plurality of images; and
(c1) for each of other of the token decodings, generating a pointmap corresponding to each of the other of the plurality of images with a second regression head that produces pointmaps in the coordinate frame of the one of the plurality of images.

8. The computer-implemented method according to claim 7, wherein the processing the plurality of images using the neural network further includes:
(b2) for the one of the token decodings, generating with a first descriptor head a local feature map of the one of the plurality of images; and
(c2) for each of the other of the token decodings, generating with a second descriptor head local feature maps of the other of the plurality of images, respectively;
wherein the first and second descriptor heads match features between image pixels of the plurality of images.

9. The computer-implemented method according to claim 1, wherein the processing the plurality of images using the neural network further includes:
(a) initializing the plurality of pointmaps;
(b) for each of the plurality of images: (i) generating image patches with a pre-encoder; and (ii) encoding the generated image patches with a transformer encoder to define image token encodings that represent the generated image patches;
(c) for each of the plurality of pointmaps: (i) generating pointmap patches with a pre-encoder; and (ii) encoding the generated pointmap patches with a transformer encoder to define pointmap token encodings that represent the pointmap generated patches;
(d) for each of the plurality of image token encodings and corresponding of the plurality of pointmap token encodings, aggregating each pair with a mixer to generate mixed token encodings;
(e) for each of the generated mixed token encodings, decoding the mixed token encodings with a transformer decoder to generate mixed token decodings;
(f) for each of the mixed token decodings, replacing the plurality of pointmaps corresponding to the plurality of images with pointmaps generated by a regression head that produces pointmaps in a coordinate frame that is common to the plurality of images; and
(g) repeating (c)-(f) for a predetermined number of iterations.

10. The computer-implemented method according to claim 1, wherein each pointmap represents a two-dimensional field of three-dimensional points of the scene, and
wherein the processing the plurality of images using the neural network further includes generating a confidence score map for each pointmap.

11. The computer-implemented method according to claim 1, wherein processing the plurality of images further includes expressing the plurality of images using a co-visibility graph and processing the co-visibility graph using the neural network to produce the plurality of pointmaps of the scene that correspond to the plurality of images and that are aligned in the common coordinate frame.

12. The computer-implemented method according to claim 1, further comprising, based on the plurality of pointmaps of the scene, determining extrinsic or intrinsic parameters of the imaging device.

13. The computer-implemented method according to claim 12, wherein at least one of:
the extrinsic parameters of the imaging device include rotation and translation of the imaging device; and
the intrinsic parameters of the imaging device include skew and focal length.

14. The computer-implemented method according to claim 1, wherein the neural network performs cross attention between views of the scene.

15. The computer program product comprising code instructions which, when the program is executed by a computer, cause the computer to carry out the method according to claim 1.

16. The computer-implemented method of claim 1 wherein the processing includes:
encoding the images into features corresponding to the images, respectively;
determining similarities between pairs of the images based on the features, the similarity of each pair being determined based on the features of the images of that pair;
generating a graph of the scene based on ones of the pairs; and
determining the pointmaps of the scene that correspond to ones of the images of ones of the pairs and that are aligned in a common coordinate frame.

17. The computer-implemented method of claim 16 wherein the processing includes:
filtering out some ones of the pairs of the images based on the similarities,
wherein the ones of the pairs include the ones of the pairs not filtered out.

18. The computer-implemented method of claim 16, wherein the encoding the images includes:
generating token features based on the images, respectively;
applying whitening to the token features;
quantizing the whitened token features according to a codebook; and
aggregating and binarizing the residuals for each codebook element.

19. The computer-implemented method of claim 18 wherein the codebook is obtained by k-means clustering.

20. A computer-implemented method for reconstructing a scene in three dimensions from a plurality of images of one or more viewpoints of the scene acquired using one or more imaging devices, the method comprising:
receiving the plurality of images without receiving extrinsic or intrinsic properties of the one or more imaging devices;
encoding the images into features corresponding to the images, respectively;
determining similarities between pairs of the images based on the features, the similarity of each pair being determined based on the features of the images of that pair;
filtering out ones of the pairs of the images based on the similarities;
generating a graph of the scene based on the pairs not filtered out; and
determining pointmaps of the scene that correspond to ones of the images of the pairs not filtered out and that are aligned in a common coordinate frame,
wherein each of the pointmaps is a one-to-one mapping between pixels of one of the plurality of images and three-dimensional points of the scene.

21. The method of claim 20 wherein vertexes of the graph correspond to one of the images of the pairs not filtered out.

22. The method of claim 21 wherein an edge between each vertex corresponds to an undirected connection between two likely overlapping images.

23. The method of claim 20 wherein the features are tokens output from the encoding with whitening applied.

24. The method of claim 20 wherein the encoding the images includes;
generating token features based on the images, respectively;
applying whitening to the token features;
quantizing the whitened token features according to a codebook; and
aggregating and binarizing the residuals for each codebook element.

25. The method of claim 20 wherein the codebook is obtained by k-means clustering.

26. The method of claim 20 wherein the determining the similarities includes determining the similarities based on summing a kernel function on binary representations over the common codebook elements.

27. The method of claim 20 further includes filtering out ones of the pairs includes selecting a predetermined number of key ones of the images.

28. The method of claim 26 wherein the selecting a predetermined number of key ones of the images includes selecting the key ones of the images using farthest point sampling (FPS) based on the similarities.

29. The method of claim 26 wherein the generating the graph includes using the key ones of the images as connected nodes and connecting all other not filtered out images to their respective closest keyframe and their k nearest neighbors according to the similarities, where k is an integer greater than or equal to zero.

30. The method of claim 29 wherein k is an integer greater than zero and less than 15.

31. The method of claim 27 wherein the predetermined number of key ones of the images includes less than 25 images.

32. The method of claim 20 further comprising aggregating the pointmaps into a canonical pointmap.

33. The method of claim 32 further comprising determining a canonical depthmap based on the canonical pointmap.

34. The method of claim 20 further comprising aligning the pointmaps in the common coordinate frame.

35. The method of claim 34 wherein the aligning the pointmaps includes aligning pixels of the pointmaps having matching three dimensional points in the scene.

36. The method of claim 35 wherein the aligning the pointmaps further includes aligning the pointmaps using gradient descent based on minimizing a two dimensional reprojection error of three dimensional points of the imaging devices.

37. The method of claim 34 wherein the aligning the pointmaps in the common coordinate frame includes aligning the pointmaps using a kinematic chain relating orientations of the imaging devices.

38. The method of claim 37 wherein the kinematic chain includes a root node corresponding to one of the imaging devices and a set of directed edges relating the one of the images corresponding to the root node to the other ones of the imaging devices.

39. The method of claim 20 further comprising rendering a three dimensional construction of the scene using the three dimensional points of the pointmaps.

40. The method of claim 39 wherein the rendering the three dimensional construction of the scene includes constructing the three dimensional points using an inverse reprojection function as a function of the camera intrinsics, camera extrinsics, pixel coordinates, and depthmaps.

41. The method of claim 40 further comprising reparameterizing the camera extrinsics based on changing a rotation center of an imaging device from an optical center to a point at intersection of (a) a z vector from the imaging device center and (b) a median depth plane of the three dimensional points.

42. The method of claim 40 further comprising reparameterizing the camera extrinsics based on changing a rotation center of an imaging device from an optical center to a point at intersection of (a) a z vector from the imaging device center and (b) a point within a predetermined distance of a median depth plane of the three dimensional points.

43. The method of claim 20 further comprising controlling one or more propulsion devices of an mobile robot based on the pointmaps and navigating the scene.

44. The method of claim 20 further comprising controlling one or more actuators of a robot based on the pointmaps and interacting with one or more objects in the scene.

45. The method of claim 20 wherein the plurality of images includes at least 500 images.

46. The method of claim 20 further comprising using the pointmaps for one or more of camera calibration, depth estimation, pixel correspondences, camera pose estimation and dense 3D reconstruction.

47. A system comprising:
one or more processors; and
memory including code that, when executed by the one or more processors, perform to:
receive the plurality of images without receiving extrinsic or intrinsic properties of the one or more imaging devices;
encode the images into features corresponding to the images, respectively;
determine similarities between pairs of the images based on the features, the similarity of each pair being determined based on the features of the images of that pair;
filter out ones of the pairs of the images based on the similarities;
generate a graph of the scene based on the pairs not filtered out; and
determine pointmaps of the scene for that correspond to ones of the images of the pairs not filtered out and that are aligned in a common coordinate frame,
wherein each of the pointmaps is a one-to-one mapping between pixels of one of the plurality of images and three-dimensional points of the scene.

48. A system for reconstructing a scene in three dimensions from a plurality of images of one or more viewpoints of the scene acquired using an imaging device, comprising:
one or more processors; and
memory including code that, when executed by the one or more processors, perform to:
receive the plurality of images without receiving extrinsic or intrinsic properties of the imaging device; and
process the plurality of images using a neural network to produce a plurality of pointmaps of the scene that correspond to the plurality of images and that are aligned in a common coordinate frame,
wherein each pointmap is a one-to-one mapping between pixels of one of the plurality of images and three-dimensional points of the scene.

49. The system according to claim 48, wherein the code that, when executed by the one or more processors, further perform to:
process the plurality of images using the neural network to produce a plurality of local feature maps that correspond to each of the plurality of images.

50. The system according to claim 49, wherein the code that, when executed by the one or more processors, further perform one of the following applications using the plurality of pointmaps of the scene to:
(i) render a pointcloud of the scene for a given camera pose;
(ii) recover camera parameters of the scene;
(iii) recover depth maps of the scene for a given camera pose; and
(iv) recover three dimensional meshes of the scene.
